SEQUENCE LISTING (336 sequences)

SEQ ID NO: 1 - DNA, 39 bp, Artificial Sequence
  Description of Artificial Sequence Synthetic primer
ggaaacagctatgaccatggtaattgtactgtgagtggc

SEQ ID NO: 2 - DNA, 23 bp, Artificial Sequence
  Description of Artificial Sequence Synthetic primer
catgtcgttttacaacgtcgtgc

SEQ ID NO: 3 - DNA, 19 bp, Artificial Sequence
  Description of Artificial Sequence Synthetic primer
ggaaacagctatgaccatg

SEQ ID NO: 4 - DNA, 19 bp, Artificial Sequence
  Description of Artificial Sequence Synthetic primer
cacgacgttgtaaaacgac

SEQ ID NO: 5 - DNA, 22 bp, Artificial Sequence
  Description of Artificial Sequence Synthetic primer
tcaaagaattatatggctaagg

SEQ ID NO: 6 - DNA, 25 bp, Artificial Sequence
  Description of Artificial Sequence Synthetic primer
gagctgctgcaccatattcctgaac

SEQ ID NO: 7 - DNA, 25 bp, Artificial Sequence
  Description of Artificial Sequence Synthetic primer
gctctgaaggcggtgtatgacatgg

SEQ ID NO: 8 - DNA, 25 bp, Artificial Sequence
  Description of Artificial Sequence Synthetic primer
gagctgctgcaccatattcctgaac

SEQ ID NO: 9 - DNA, 25 bp, Artificial Sequence
  Description of Artificial Sequence Synthetic primer
ccatgtcatacaccgccttcagagc

SEQ ID NO: 10 - DNA, 45 bp, Artificial Sequence
  Description of Artificial Sequence Synthetic primer
gagctgctgcaccatattcctgaactctcaaactccagagtggcc

SEQ ID NO: 11 - DNA, 47 bp, Artificial Sequence
  Description of Artificial Sequence Synthetic primer
gagctgctgcaccatattcctgaacagcagtgcttcacacactttag

SEQ ID NO: 12 - DNA, 46 bp, Artificial Sequence
  Description of Artificial Sequence Synthetic primer
gagctgctgcaccatattcctgaacgtcctgatttctcctccagag

SEQ ID NO: 13 - DNA, 48 bp, Artificial Sequence
  Description of Artificial Sequence Synthetic primer
gagctgctgcaccatattcctgaacccctcttgcataaaatgttgcag

SEQ ID NO: 14 - DNA, 53 bp, Artificial Sequence
  Description of Artificial Sequence Synthetic primer
gagctgctgcaccatattcctgaaccatgaagagaaatagttctgaggtttcc

SEQ ID NO: 15 - DNA, 51 bp, Artificial Sequence
  Description of Artificial Sequence Synthetic primer
gagctgctgcaccatattcctgaacctgatagtaattgtactgtgagtggc

SEQ ID NO: 16 - DNA, 62 bp, Artificial Sequence
  Description of Artificial Sequence Synthetic primer
gagctgctgcaccatattcctgaacctaaaaacttataattttaatagagggtgcattgaag

SEQ ID NO: 17 - DNA, 45 bp, Artificial Sequence
  Description of Artificial Sequence Synthetic primer
gagctgctgcaccatattcctgaacacgtaagcacacatccccag

SEQ ID NO: 18 - DNA, 52 bp, Artificial Sequence
  Description of Artificial Sequence Synthetic primer
gagctgctgcaccatattcctgaacgatttctatcctcaaaaagcttatggg

SEQ ID NO: 19 - DNA, 56 bp, Artificial Sequence
  Description of Artificial Sequence Synthetic primer
gagctgctgcaccatattcctgaacgatgaatcatcttactctttagtatggttgc

SEQ ID NO: 20 - DNA, 46 bp, Artificial Sequence
  Description of Artificial Sequence Synthetic primer
gagctgctgcaccatattcctgaaccctgccctttagacaggaatc

SEQ ID NO: 21 - DNA, 46 bp, Artificial Sequence
  Description of Artificial Sequence Synthetic primer
gagctgctgcaccatattcctgaaccatctgccttgatctcccttc

SEQ ID NO: 22 - DNA, 46 bp, Artificial Sequence
  Description of Artificial Sequence Synthetic primer
gagctgctgcaccatattcctgaacccttcatgctcttcttcctgc

SEQ ID NO: 23 - DNA, 78 bp, Artificial Sequence
  Description of Artificial Sequence Synthetic primer
gagctgctgcaccatattcctgaacgctatttttataatatttattattttaaataattcaaaatacaaaagtaacac

SEQ ID NO: 24 - DNA, 51 bp, Artificial Sequence
  Description of Artificial Sequence Synthetic primer
gagctgctgcaccatattcctgaacctagacattgggaatacataggagtg

SEQ ID NO: 25 - DNA, 46 bp, Artificial Sequence
  Description of Artificial Sequence Synthetic primer
gagctgctgcaccatattcctgaacaacttgtacccagatgcagtc

SEQ ID NO: 26 - DNA, 47 bp, Artificial Sequence
  Description of Artificial Sequence Synthetic primer
gagctgctgcaccatattcctgaaccttctaaggcttcagggatgac

SEQ ID NO: 27 - DNA, 45 bp, Artificial Sequence
  Description of Artificial Sequence Synthetic primer
gagctgctgcaccatattcctgaacgtacttgaaaagaagcccgg

SEQ ID NO: 28 - DNA, 47 bp, Artificial Sequence
  Description of Artificial Sequence Synthetic primer
gagctgctgcaccatattcctgaacgatctctctaccaccatcaggg

SEQ ID NO: 29 - DNA, 48 bp, Artificial Sequence
  Description of Artificial Sequence Synthetic primer
gagctgctgcaccatattcctgaacaggagtcactacattcagggatg

SEQ ID NO: 30 - DNA, 47 bp, Artificial Sequence
  Description of Artificial Sequence Synthetic primer
gagctgctgcaccatattcctgaacgtgtctcaggtgaaagtgactc

SEQ ID NO: 31 - DNA, 49 bp, Artificial Sequence
  Description of Artificial Sequence Synthetic primer
gagctgctgcaccatattcctgaaccttcaggattatactggcagttgc

SEQ ID NO: 32 - DNA, 48 bp, Artificial Sequence
  Description of Artificial Sequence Synthetic primer
gagctgctgcaccatattcctgaacgctttgaatggtatcaccctcac

SEQ ID NO: 33 - DNA, 45 bp, Artificial Sequence
  Description of Artificial Sequence Synthetic primer
gagctgctgcaccatattcctgaacaaacgcagtcatcactctcc

SEQ ID NO: 34 - DNA, 46 bp, Artificial Sequence
  Description of Artificial Sequence Synthetic primer
gagctgctgcaccatattcctgaacgggagcgggaatcttaaatcc

SEQ ID NO: 35 - DNA, 46 bp, Artificial Sequence
  Description of Artificial Sequence Synthetic primer
gagctgctgcaccatattcctgaacgcaacaggattcgactaaggc

SEQ ID NO: 36 - DNA, 54 bp, Artificial Sequence
  Description of Artificial Sequence Synthetic primer
gagctgctgcaccatattcctgaaccatgtatatagtttggctagcagtgaaag

SEQ ID NO: 37 - DNA, 50 bp, Artificial Sequence
  Description of Artificial Sequence Synthetic primer
gagctgctgcaccatattcctgaacgaatcctactcctaaggtgatgttg

SEQ ID NO: 38 - DNA, 49 bp, Artificial Sequence
  Description of Artificial Sequence Synthetic primer
gagctgctgcaccatattcctgaaccttcatcagcaagcaactacattg

SEQ ID NO: 39 - DNA, 46 bp, Artificial Sequence
  Description of Artificial Sequence Synthetic primer
gagctgctgcaccatattcctgaacgggtccaaaactgctcatgtc

SEQ ID NO: 40 - DNA, 45 bp, Artificial Sequence
  Description of Artificial Sequence Synthetic primer
gagctgctgcaccatattcctgaactttttccatggcttttgggc

SEQ ID NO: 41 - DNA, 48 bp, Artificial Sequence
  Description of Artificial Sequence Synthetic primer
gagctgctgcaccatattcctgaactgtacaggcaggtcttagagatg

SEQ ID NO: 42 - DNA, 47 bp, Artificial Sequence
  Description of Artificial Sequence Synthetic primer
gagctgctgcaccatattcctgaacgtagccaattccttcagtgcag

SEQ ID NO: 43 - DNA, 45 bp, Artificial Sequence
  Description of Artificial Sequence Synthetic primer
gagctgctgcaccatattcctgaacagggcttgtttcagcttgag

SEQ ID NO: 44 - DNA, 50 bp, Artificial Sequence
  Description of Artificial Sequence Synthetic primer
gagctgctgcaccatattcctgaaccaaaagttttgtttaggtgccttcc

SEQ ID NO: 45 - DNA, 50 bp, Artificial Sequence
  Description of Artificial Sequence Synthetic primer
ggggagtgtaggttctggtacccaggctctgaaggcggtgtatgacatgg

SEQ ID NO: 46 - DNA, 76 bp, Artificial Sequence
  Description of Artificial Sequence Synthetic primer
catcacctatatcattatttactaaattattttttcttcaaactgacttaggctctgaaggcggtgtatgacatgg

SEQ ID NO: 47 - DNA, 56 bp, Artificial Sequence
  Description of Artificial Sequence Synthetic primer
cccttttttcctaaaagcccccaaacttttggctctgaaggcggtgtatgacatgg

SEQ ID NO: 48 - DNA, 53 bp, Artificial Sequence
  Description of Artificial Sequence Synthetic primer
cttttgtgagctggcttttgctcatctcgctctgaaggcggtgtatgacatgg

SEQ ID NO: 49 - DNA, 59 bp, Artificial Sequence
  Description of Artificial Sequence Synthetic primer
cctatttgagttttgcttttttgttttggtctcggctctgaaggcggtgtatgacatgg

SEQ ID NO: 50 - DNA, 56 bp, Artificial Sequence
  Description of Artificial Sequence Synthetic primer
gatttagacagagtcttactctgtcaccagggctctgaaggcggtgtatgacatgg

SEQ ID NO: 51 - DNA, 58 bp, Artificial Sequence
  Description of Artificial Sequence Synthetic primer
ctatactcttgctcgtggagttaatctcagagggctctgaaggcggtgtatgacatgg

SEQ ID NO: 52 - DNA, 49 bp, Artificial Sequence
  Description of Artificial Sequence Synthetic primer
ctcagaagtgtggaacagctgcccgctctgaaggcggtgtatgacatgg

SEQ ID NO: 53 - DNA, 58 bp, Artificial Sequence
  Description of Artificial Sequence Synthetic primer
cttgggacttcaggtagacttagtttgaacatcgctctgaaggcggtgtatgacatgg

SEQ ID NO: 54 - DNA, 52 bp, Artificial Sequence
  Description of Artificial Sequence Synthetic primer
ccatctacattagcttaccagggctgcgctctgaaggcggtgtatgacatgg

SEQ ID NO: 55 - DNA, 53 bp, Artificial Sequence
  Description of Artificial Sequence Synthetic primer
ctctctaatgttccagagaaaccccagggctctgaaggcggtgtatgacatgg

SEQ ID NO: 56 - DNA, 52 bp, Artificial Sequence
  Description of Artificial Sequence Synthetic primer
cgttttcttatgtgtctggcctcatccgctctgaaggcggtgtatgacatgg

SEQ ID NO: 57 - DNA, 49 bp, Artificial Sequence
  Description of Artificial Sequence Synthetic primer
ggagcgctccatgaaacacaacaggctctgaaggcggtgtatgacatgg

SEQ ID NO: 58 - DNA, 54 bp, Artificial Sequence
  Description of Artificial Sequence Synthetic primer
gttgacagttgattttgtaatgcctccacgctctgaaggcggtgtatgacatgg

SEQ ID NO: 59 - DNA, 54 bp, Artificial Sequence
  Description of Artificial Sequence Synthetic primer
cgatgtgatcctgtgtcaaataatgacgggctctgaaggcggtgtatgacatgg

SEQ ID NO: 60 - DNA, 58 bp, Artificial Sequence
  Description of Artificial Sequence Synthetic primer
ctgaagggaatggctggtttttaatttgtagtggctctgaaggcggtgtatgacatgg

SEQ ID NO: 61 - DNA, 52 bp, Artificial Sequence
  Description of Artificial Sequence Synthetic primer
gaaggtgggattacgcctaactttagggctctgaaggcggtgtatgacatgg

SEQ ID NO: 62 - DNA, 45 bp, Artificial Sequence
  Description of Artificial Sequence Synthetic primer
gacttcatggctggcagaaagctctgaaggcggtgtatgacatgg

SEQ ID NO: 63 - DNA, 51 bp, Artificial Sequence
  Description of Artificial Sequence Synthetic primer
ctgcatttctactggtaacatgcgccgctctgaaggcggtgtatgacatgg

SEQ ID NO: 64 - DNA, 67 bp, Artificial Sequence
  Description of Artificial Sequence Synthetic primer
ctattcaggtgtcacttttattatgattatctaaggtcagtggctctgaaggcggtgtatgacatgg

SEQ ID NO: 65 - DNA, 54 bp, Artificial Sequence
  Description of Artificial Sequence Synthetic primer
caggtccagttcttgagtttcatcctttcgctctgaaggcggtgtatgacatgg

SEQ ID NO: 66 - DNA, 59 bp, Artificial Sequence
  Description of Artificial Sequence Synthetic primer
cctctctgttttgttgagaaatccactcttggtcgctctgaaggcggtgtatgacatgg

SEQ ID NO: 67 - DNA, 56 bp, Artificial Sequence
  Description of Artificial Sequence Synthetic primer
gcaaaatgggtatggtttagccagaaacatggctctgaaggcggtgtatgacatgg

SEQ ID NO: 68 - DNA, 45 bp, Artificial Sequence
  Description of Artificial Sequence Synthetic primer
ggtgatggacccactgcctggctctgaaggcggtgtatgacatgg

SEQ ID NO: 69 - DNA, 47 bp, Artificial Sequence
  Description of Artificial Sequence Synthetic primer
gtgacctgacactggtgggatggctctgaaggcggtgtatgacatgg

SEQ ID NO: 70 - DNA, 54 bp, Artificial Sequence
  Description of Artificial Sequence Synthetic primer
gctttgtgtgcaaatcacctattttcctggctctgaaggcggtgtatgacatgg

SEQ ID NO: 71 - DNA, 56 bp, Artificial Sequence
  Description of Artificial Sequence Synthetic primer
ggtgagagaatatgaaagcaaaacagcaaccgctctgaaggcggtgtatgacatgg

SEQ ID NO: 72 - DNA, 53 bp, Artificial Sequence
  Description of Artificial Sequence Synthetic primer
gggctatgtagacacttcaaaggtgttcgctctgaaggcggtgtatgacatgg

SEQ ID NO: 73 - DNA, 53 bp, Artificial Sequence
  Description of Artificial Sequence Synthetic primer
gtttgctctagctcaatggcctcttaaggctctgaaggcggtgtatgacatgg

SEQ ID NO: 74 - DNA, 52 bp, Artificial Sequence
  Description of Artificial Sequence Synthetic primer
ccaacacagtcatctgatcccatctccgctctgaaggcggtgtatgacatgg

SEQ ID NO: 75 - DNA, 53 bp, Artificial Sequence
  Description of Artificial Sequence Synthetic primer
gtaggcaaggctgttcttttttgtgttggctctgaaggcggtgtatgacatgg

SEQ ID NO: 76 - DNA, 53 bp, Artificial Sequence
  Description of Artificial Sequence Synthetic primer
ccatatgcagtttttgttttcccagtgcgctctgaaggcggtgtatgacatgg

SEQ ID NO: 77 - DNA, 67 bp, Artificial Sequence
  Description of Artificial Sequence Synthetic primer
caccataatagtttatctgcttctactaaaattattattggcgctctgaaggcggtgtatgacatgg

SEQ ID NO: 78 - DNA, 62 bp, Artificial Sequence
  Description of Artificial Sequence Synthetic primer
cctcagaatgaaatcatgcttttctgctaatttgtaggctctgaaggcggtgtatgacatgg

SEQ ID NO: 79 - DNA, 54 bp, Artificial Sequence
  Description of Artificial Sequence Synthetic primer
ccttcagacataccttgggaaaatgtcaggctctgaaggcggtgtatgacatgg

SEQ ID NO: 80 - DNA, 15 bp, Artificial Sequence
  Description of Artificial Sequence Synthetic primer
ccttcttcatccccc

SEQ ID NO: 81 - DNA, 15 bp, Artificial Sequence
  Description of Artificial Sequence Synthetic primer
gcccataagccaaca

SEQ ID NO: 82 - DNA, 15 bp, Artificial Sequence
  Description of Artificial Sequence Synthetic primer
gtcccaagggagagc

SEQ ID NO: 83 - DNA, 16 bp, Artificial Sequence
  Description of Artificial Sequence Synthetic primer
ggtaaagcccctcgaa

SEQ ID NO: 84 - DNA, 17 bp, Artificial Sequence
  Description of Artificial Sequence Synthetic primer
ctccccacctgaccctg

SEQ ID NO: 85 - DNA, 17 bp, Artificial Sequence
  Description of Artificial Sequence Synthetic primer
ttatggtgtctttcccc

SEQ ID NO: 86 - DNA, 17 bp, Artificial Sequence
  Description of Artificial Sequence Synthetic primer
caaagcaggtgcacgaa

SEQ ID NO: 87 - DNA, 18 bp, Artificial Sequence
  Description of Artificial Sequence Synthetic primer
acttcctcccttcttact

SEQ ID NO: 88 - DNA, 18 bp, Artificial Sequence
  Description of Artificial Sequence Synthetic primer
cccttttggcttcctggg

SEQ ID NO: 89 - DNA, 19 bp, Artificial Sequence
  Description of Artificial Sequence Synthetic primer
cccattttgcgccatttat

SEQ ID NO: 90 - DNA, 19 bp, Artificial Sequence
  Description of Artificial Sequence Synthetic primer
ggatcacatcgtgttagac

SEQ ID NO: 91 - DNA, 19 bp, Artificial Sequence
  Description of Artificial Sequence Synthetic primer
ggaagacgcttatcatggt

SEQ ID NO: 92 - DNA, 20 bp, Artificial Sequence
  Description of Artificial Sequence Synthetic primer
cccttgcatgcatgcgcaca

SEQ ID NO: 93 - DNA, 20 bp, Artificial Sequence
  Description of Artificial Sequence Synthetic primer
aggcaatagagggagtatca

SEQ ID NO: 94 - DNA, 21 bp, Artificial Sequence
  Description of Artificial Sequence Synthetic primer
aaacttctccctcagcctacc

SEQ ID NO: 95 - DNA, 21 bp, Artificial Sequence
  Description of Artificial Sequence Synthetic primer
cagaaatacatttgccactat

SEQ ID NO: 96 - DNA, 21 bp, Artificial Sequence
  Description of Artificial Sequence Synthetic primer
gcgctgtatcctcagagagta

SEQ ID NO: 97 - DNA, 22 bp, Artificial Sequence
  Description of Artificial Sequence Synthetic primer
gggagaatgcatttctttttcc

SEQ ID NO: 98 - DNA, 22 bp, Artificial Sequence
  Description of Artificial Sequence Synthetic primer
ggatacttcaagaatagtagag

SEQ ID NO: 99 - DNA, 23 bp, Artificial Sequence
  Description of Artificial Sequence Synthetic primer
cccactctattcccacgtcagcc

SEQ ID NO: 100 - DNA, 23 bp, Artificial Sequence
  Description of Artificial Sequence Synthetic primer
tttatttttccatcacacgtatg

SEQ ID NO: 101 - DNA, 24 bp, Artificial Sequence
  Description of Artificial Sequence Synthetic primer
tttctaaatccccacccggcgcag

SEQ ID NO: 102 - DNA, 24 bp, Artificial Sequence
  Description of Artificial Sequence Synthetic primer
gctctcaccattaactatacagca

SEQ ID NO: 103 - DNA, 24 bp, Artificial Sequence
  Description of Artificial Sequence Synthetic primer
gttgacagttctccaagtccagat

SEQ ID NO: 104 - DNA, 24 bp, Artificial Sequence
  Description of Artificial Sequence Synthetic primer
ggattacagatgccttcttgggta

SEQ ID NO: 105 - DNA, 25 bp, Artificial Sequence
  Description of Artificial Sequence Synthetic primer
caatcaaagaattatatggctaagg

SEQ ID NO: 106 - DNA, 26 bp, Artificial Sequence
  Description of Artificial Sequence Synthetic primer
ccctttaacacctatatgggtttttg

SEQ ID NO: 107 - DNA, 26 bp, Artificial Sequence
  Description of Artificial Sequence Synthetic primer
gcagcacagccttgcctacaatgaca

SEQ ID NO: 108 - DNA, 26 bp, Artificial Sequence
  Description of Artificial Sequence Synthetic primer
gggcattctgaggaaaataatgtatg

SEQ ID NO: 109 - DNA, 26 bp, Artificial Sequence
  Description of Artificial Sequence Synthetic primer
ggacgagaggtctgagagtttctgat

SEQ ID NO: 110 - DNA, 27 bp, Artificial Sequence
  Description of Artificial Sequence Synthetic primer
acataactctcagataattaaagttgt

SEQ ID NO: 111 - DNA, 27 bp, Artificial Sequence
  Description of Artificial Sequence Synthetic primer
atgttaacagaaagcacaataaaaaca

SEQ ID NO: 112 - DNA, 27 bp, Artificial Sequence
  Description of Artificial Sequence Synthetic primer
gggaggagaggaaccataagatattag

SEQ ID NO: 113 - DNA, 28 bp, Artificial Sequence
  Description of Artificial Sequence Synthetic primer
cctggttttgtcttccctatttactgat

SEQ ID NO: 114 - DNA, 28 bp, Artificial Sequence
  Description of Artificial Sequence Synthetic primer
ggacaaaagttctgaattatttggtttg

SEQ ID NO: 115 - DNA, 30 bp, Artificial Sequence
  Description of Artificial Sequence Synthetic primer
acgttggatgaaaggctgatccaggtcatc

SEQ ID NO: 116 - DNA, 29 bp, Artificial Sequence
  Description of Artificial Sequence Synthetic primer
acgttggatgttgagacacggcacagcgg

SEQ ID NO: 117 - DNA, 30 bp, Artificial Sequence
  Description of Artificial Sequence Synthetic primer
acgttggatgaaggtaggcctttaggagag

SEQ ID NO: 118 - DNA, 30 bp, Artificial Sequence
  Description of Artificial Sequence Synthetic primer
acgttggatgatgcacaatcgtcctactcc

SEQ ID NO: 119 - DNA, 30 bp, Artificial Sequence
  Description of Artificial Sequence Synthetic primer
acgttggatgtgagccagggatatcctaac

SEQ ID NO: 120 - DNA, 30 bp, Artificial Sequence
  Description of Artificial Sequence Synthetic primer
acgttggatgtaatagagggtgcattgaag

SEQ ID NO: 121 - DNA, 29 bp, Artificial Sequence
  Description of Artificial Sequence Synthetic primer
acgttggatgaaagagagagagatccctg

SEQ ID NO: 122 - DNA, 30 bp, Artificial Sequence
  Description of Artificial Sequence Synthetic primer
acgttggatgcactaataaaggcagcctgt

SEQ ID NO: 123 - DNA, 31 bp, Artificial Sequence
  Description of Artificial Sequence Synthetic primer
acgttggatgggctctgatccctttttttag

SEQ ID NO: 124 - DNA, 31 bp, Artificial Sequence
  Description of Artificial Sequence Synthetic primer
acgttggatggcttttcctcttctttggtag

SEQ ID NO: 125 - DNA, 30 bp, Artificial Sequence
  Description of Artificial Sequence Synthetic primer
acgttggatgtctcagttccaactcatgcc

SEQ ID NO: 126 - DNA, 29 bp, Artificial Sequence
  Description of Artificial Sequence Synthetic primer
acgttggatgagaatgtgccaaagagcag

SEQ ID NO: 127 - DNA, 31 bp, Artificial Sequence
  Description of Artificial Sequence Synthetic primer
acgttggatgccttattggattctatgtccc

SEQ ID NO: 128 - DNA, 30 bp, Artificial Sequence
  Description of Artificial Sequence Synthetic primer
acgttggatgacttggcgagtccccatttc

SEQ ID NO: 129 - DNA, 30 bp, Artificial Sequence
  Description of Artificial Sequence Synthetic primer
acgttggatgtcttgtctcttacctctcag

SEQ ID NO: 130 - DNA, 30 bp, Artificial Sequence
  Description of Artificial Sequence Synthetic primer
acgttggatgtgaggattaaaggatctggg

SEQ ID NO: 131 - DNA, 30 bp, Artificial Sequence
  Description of Artificial Sequence Synthetic primer
acgttggatggaggctcctctacacaaaag

SEQ ID NO: 132 - DNA, 30 bp, Artificial Sequence
  Description of Artificial Sequence Synthetic primer
acgttggatgttgctctaaggtggatgctg

SEQ ID NO: 133 - DNA, 30 bp, Artificial Sequence
  Description of Artificial Sequence Synthetic primer
acgttggatggtttacaacctgtggcagac

SEQ ID NO: 134 - DNA, 30 bp, Artificial Sequence
  Description of Artificial Sequence Synthetic primer
acgttggatggaaagtgacccatcaagcag

SEQ ID NO: 135 - DNA, 31 bp, Artificial Sequence
  Description of Artificial Sequence Synthetic primer
acgttggatgctatggggaactgaataagtg

SEQ ID NO: 136 - DNA, 31 bp, Artificial Sequence
  Description of Artificial Sequence Synthetic primer
acgttggatgcaaactattgactggtcatgg

SEQ ID NO: 137 - DNA, 30 bp, Artificial Sequence
  Description of Artificial Sequence Synthetic primer
acgttggatggcagaggtttgagaaaagag

SEQ ID NO: 138 - DNA, 30 bp, Artificial Sequence
  Description of Artificial Sequence Synthetic primer
acgttggatggtatatgcctgtatgtggtc

SEQ ID NO: 139 - DNA, 30 bp, Artificial Sequence
  Description of Artificial Sequence Synthetic primer
acgttggatggagggaaagacctgcttcta

SEQ ID NO: 140 - DNA, 31 bp, Artificial Sequence
  Description of Artificial Sequence Synthetic primer
acgttggatggagaaggctttccagaatttg

SEQ ID NO: 141 - DNA, 30 bp, Artificial Sequence
  Description of Artificial Sequence Synthetic primer
acgttggatgcaaaagccagctcacaaaag

SEQ ID NO: 142 - DNA, 30 bp, Artificial Sequence
  Description of Artificial Sequence Synthetic primer
acgttggatgttttgggcccctccatattc

SEQ ID NO: 143 - DNA, 30 bp, Artificial Sequence
  Description of Artificial Sequence Synthetic primer
acgttggatgtggatatgctgaatttgagg

SEQ ID NO: 144 - DNA, 30 bp, Artificial Sequence
  Description of Artificial Sequence Synthetic primer
acgttggatgcttttgtccatgtttggcag

SEQ ID NO: 145 - DNA, 30 bp, Artificial Sequence
  Description of Artificial Sequence Synthetic primer
acgttggatgaggacagttgtcgtgagatg

SEQ ID NO: 146 - DNA, 30 bp, Artificial Sequence
  Description of Artificial Sequence Synthetic primer
acgttggatgctgaggctgggtaacttatc

SEQ ID NO: 147 - DNA, 30 bp, Artificial Sequence
  Description of Artificial Sequence Synthetic primer
acgttggatggcccttggcacatagtactg

SEQ ID NO: 148 - DNA, 30 bp, Artificial Sequence
  Description of Artificial Sequence Synthetic primer
acgttggatgttggttatagagcgtccctg

SEQ ID NO: 149 - DNA, 30 bp, Artificial Sequence
  Description of Artificial Sequence Synthetic primer
acgttggatgaccccttactccaataagtc

SEQ ID NO: 150 - DNA, 30 bp, Artificial Sequence
  Description of Artificial Sequence Synthetic primer
acgttggatgttctcttcaaacctcccatc

SEQ ID NO: 151 - DNA, 30 bp, Artificial Sequence
  Description of Artificial Sequence Synthetic primer
acgttggatgttttcctcttcctacccctc

SEQ ID NO: 152 - DNA, 30 bp, Artificial Sequence
  Description of Artificial Sequence Synthetic primer
acgttggatgtggcaacacacgactgtact

SEQ ID NO: 153 - DNA, 30 bp, Artificial Sequence
  Description of Artificial Sequence Synthetic primer
acgttggatgtgcttcccaggtcactattg

SEQ ID NO: 154 - DNA, 30 bp, Artificial Sequence
  Description of Artificial Sequence Synthetic primer
acgttggatgtccatgagtgcaggactacg

SEQ ID NO: 155 - DNA, 30 bp, Artificial Sequence
  Description of Artificial Sequence Synthetic primer
acgttggatgctccacgagcaagagtatag

SEQ ID NO: 156 - DNA, 30 bp, Artificial Sequence
  Description of Artificial Sequence Synthetic primer
acgttggatgatcccatacggccaagaaga

SEQ ID NO: 157 - DNA, 30 bp, Artificial Sequence
  Description of Artificial Sequence Synthetic primer
acgttggatgatgagtaacgcttggtgctg

SEQ ID NO: 158 - DNA, 30 bp, Artificial Sequence
  Description of Artificial Sequence Synthetic primer
acgttggatgtggtagcctcaagaatgctc

SEQ ID NO: 159 - DNA, 30 bp, Artificial Sequence
  Description of Artificial Sequence Synthetic primer
acgttggatggaatgtgtaaaacaaaccag

SEQ ID NO: 160 - DNA, 30 bp, Artificial Sequence
  Description of Artificial Sequence Synthetic primer
acgttggatgtgagccatgtagagactcag

SEQ ID NO: 161 - DNA, 30 bp, Artificial Sequence
  Description of Artificial Sequence Synthetic primer
acgttggatgtctgcatcccttaggttcac

SEQ ID NO: 162 - DNA, 29 bp, Artificial Sequence
  Description of Artificial Sequence Synthetic primer
acgttggatgaccaagcactgtacttttc

SEQ ID NO: 163 - DNA, 30 bp, Artificial Sequence
  Description of Artificial Sequence Synthetic primer
acgttggatgttaatatagtccccagccac

SEQ ID NO: 164 - DNA, 30 bp, Artificial Sequence
  Description of Artificial Sequence Synthetic primer
acgttggatgctgtgctgactgagtagatg

SEQ ID NO: 165 - DNA, 30 bp, Artificial Sequence
  Description of Artificial Sequence Synthetic primer
acgttggatgatctttgaaggctcctctgg

SEQ ID NO: 166 - DNA, 30 bp, Artificial Sequence
  Description of Artificial Sequence Synthetic primer
acgttggatggcatgtccctatgagatcag

SEQ ID NO: 167 - DNA, 30 bp, Artificial Sequence
  Description of Artificial Sequence Synthetic primer
acgttggatgttaggcaccccaagtttcag

SEQ ID NO: 168 - DNA, 30 bp, Artificial Sequence
  Description of Artificial Sequence Synthetic primer
acgttggatgtgtagcatgtcagccatcag

SEQ ID NO: 169 - DNA, 30 bp, Artificial Sequence
  Description of Artificial Sequence Synthetic primer
acgttggatggtagttgcttgtggttaccg

SEQ ID NO: 170 - DNA, 29 bp, Artificial Sequence
  Description of Artificial Sequence Synthetic primer
acgttggatggagcaattcatttgtctcc

SEQ ID NO: 171 - DNA, 30 bp, Artificial Sequence
  Description of Artificial Sequence Synthetic primer
acgttggatgttttgttgtttgggcattgg

SEQ ID NO: 172 - DNA, 30 bp, Artificial Sequence
  Description of Artificial Sequence Synthetic primer
acgttggatggttcccatccagtaatggag

SEQ ID NO: 173 - DNA, 31 bp, Artificial Sequence
  Description of Artificial Sequence Synthetic primer
acgttggatgccaacagtttttctttaaggg

SEQ ID NO: 174 - DNA, 30 bp, Artificial Sequence
  Description of Artificial Sequence Synthetic primer
acgttggatgagaagctccgagaaaaggtg

SEQ ID NO: 175 - DNA, 30 bp, Artificial Sequence
  Description of Artificial Sequence Synthetic primer
acgttggatgtatagccattactgggcttg

SEQ ID NO: 176 - DNA, 31 bp, Artificial Sequence
  Description of Artificial Sequence Synthetic primer
acgttggatgccctcttgcataaaatgttgc

SEQ ID NO: 177 - DNA, 29 bp, Artificial Sequence
  Description of Artificial Sequence Synthetic primer
acgttggatgctccatgcaaggctgtggc

SEQ ID NO: 178 - DNA, 30 bp, Artificial Sequence
  Description of Artificial Sequence Synthetic primer
acgttggatgcgttatcaaggactttgtgc

SEQ ID NO: 179 - DNA, 31 bp, Artificial Sequence
  Description of Artificial Sequence Synthetic primer
acgttggatggaggttatcttattgtaacgc

SEQ ID NO: 180 - DNA, 30 bp, Artificial Sequence
  Description of Artificial Sequence Synthetic primer
acgttggatgagactgtcctttcccaggat

SEQ ID NO: 181 - DNA, 30 bp, Artificial Sequence
  Description of Artificial Sequence Synthetic primer
acgttggatgtcatcagaagcagatgctgg

SEQ ID NO: 182 - DNA, 30 bp, Artificial Sequence
  Description of Artificial Sequence Synthetic primer
acgttggatgccatacgttcaaggattggg

SEQ ID NO: 183 - DNA, 30 bp, Artificial Sequence
  Description of Artificial Sequence Synthetic primer
acgttggatgaggtgtgcaagtgtcagaag

SEQ ID NO: 184 - DNA, 30 bp, Artificial Sequence
  Description of Artificial Sequence Synthetic primer
acgttggatggtatatcatgtccagtgaag

SEQ ID NO: 185 - DNA, 32 bp, Artificial Sequence
  Description of Artificial Sequence Synthetic primer
ccaccgcctccncctcccatctccaccctcta

SEQ ID NO: 186 - DNA, 32 bp, Artificial Sequence
  Description of Artificial Sequence Synthetic primer
ccaccgcctacncctcccatctccaccctctg

SEQ ID NO: 187 - DNA, 32 bp, Artificial Sequence
  Description of Artificial Sequence Synthetic primer
ccacagcctacncttcctacccctccagccgc

SEQ ID NO: 188 - DNA, 32 bp, Artificial Sequence
  Description of Artificial Sequence Synthetic primer
ccacagcatacncttcctacccctccagccgt

SEQ ID NO: 189 - DNA, 32 bp, Artificial Sequence
  Description of Artificial Sequence Synthetic primer
caacagcacaanttgctatccccacaattacc

SEQ ID NO: 190 - DNA, 32 bp, Artificial Sequence
  Description of Artificial Sequence Synthetic primer
caacagaacaanttgctatccccacaattact

SEQ ID NO: 191 - DNA, 32 bp, Artificial Sequence
  Description of Artificial Sequence Synthetic primer
caaaagaacaantgaaactgcagactcttccc

SEQ ID NO: 192 - DNA, 32 bp, Artificial Sequence
  Description of Artificial Sequence Synthetic primer
caaaagaaaaantgaaactgcagactcttcct

SEQ ID NO: 193 - DNA, 32 bp, Artificial Sequence
  Description of Artificial Sequence Synthetic primer
aataagaagaancgtctgattggctttagttc

SEQ ID NO: 194 - DNA, 32 bp, Artificial Sequence
  Description of Artificial Sequence Synthetic primer
gataagaagaancgtctgattggctttagttt

SEQ ID NO: 195 - DNA, 32 bp, Artificial Sequence
  Description of Artificial Sequence Synthetic primer
aatagcgagaangctgtatcctcagagagtac

SEQ ID NO: 196 - DNA, 32 bp, Artificial Sequence
  Description of Artificial Sequence Synthetic primer
aatagcgagagngctgtatcctcagagagtat

SEQ ID NO: 197 - DNA, 34 bp, Artificial Sequence
  Description of Artificial Sequence Synthetic primer
ccacccccgcccnttctcccacagtaaacttcca

SEQ ID NO: 198 - DNA, 34 bp, Artificial Sequence
  Description of Artificial Sequence Synthetic primer
ccaccaccgcccnttctcccacagtaaacttccg

SEQ ID NO: 199 - DNA, 34 bp, Artificial Sequence
  Description of Artificial Sequence Synthetic primer
ccaccgcactacnctcttctgcttcatatttcac

SEQ ID NO: 200 - DNA, 34 bp, Artificial Sequence
  Description of Artificial Sequence Synthetic primer
ccacagcactacnctcttctgcttcatatttcag

SEQ ID NO: 201 - DNA, 34 bp, Artificial Sequence
  Description of Artificial Sequence Synthetic primer
caacagcaccacnttcattatttcactcaagcga

SEQ ID NO: 202 - DNA, 34 bp, Artificial Sequence
  Description of Artificial Sequence Synthetic primer
caacagcaacacnttcattatttcactcaagcgg

SEQ ID NO: 203 - DNA, 34 bp, Artificial Sequence
  Description of Artificial Sequence Synthetic primer
caacagctacaanaaacaaaccagaaagtcacta

SEQ ID NO: 204 - DNA, 34 bp, Artificial Sequence
  Description of Artificial Sequence Synthetic primer
caacagatacaanaaacaaaccagaaagtcactg

SEQ ID NO: 205 - DNA, 34 bp, Artificial Sequence
  Description of Artificial Sequence Synthetic primer
caaaagatacaanatgtagagactcagtctcttc

SEQ ID NO: 206 - DNA, 34 bp, Artificial Sequence
  Description of Artificial Sequence Synthetic primer
caaaagatagaanatgtagagactcagtctcttg

SEQ ID NO: 207 - DNA, 34 bp, Artificial Sequence
  Description of Artificial Sequence Synthetic primer
caaaagagagaantgcaaattagatttgtcaggc

SEQ ID NO: 208 - DNA, 34 bp, Artificial Sequence
  Description of Artificial Sequence Synthetic primer
cagaagagagaantgcaaattagatttgtcaggt

SEQ ID NO: 209 - DNA, 35 bp, Artificial Sequence
  Description of Artificial Sequence Synthetic primer
cagaagagagagntatgtcttattcttcttcacca

SEQ ID NO: 210 - DNA, 35 bp, Artificial Sequence
  Description of Artificial Sequence Synthetic primer
caggagagagagntatgtcttattcttcttcaccg

SEQ ID NO: 211 - DNA, 36 bp, Artificial Sequence
  Description of Artificial Sequence Synthetic primer
ccacccaccgcccntagtccccagccactataaaac

SEQ ID NO: 212 - DNA, 36 bp, Artificial Sequence
  Description of Artificial Sequence Synthetic primer
ccacccgccgcccntagtccccagccactataaaag

SEQ ID NO: 213 - DNA, 36 bp, Artificial Sequence
  Description of Artificial Sequence Synthetic primer
ccacccgccgctcnttcccaaagttgagggacttac

SEQ ID NO: 214 - DNA, 36 bp, Artificial Sequence
  Description of Artificial Sequence Synthetic primer
ccactcgccgctcnttcccaaagttgagggacttat

SEQ ID NO: 215 - DNA, 36 bp, Artificial Sequence
  Description of Artificial Sequence Synthetic primer
ccacgcgccctacnaaggctcctctggggcacaagc

SEQ ID NO: 216 - DNA, 36 bp, Artificial Sequence
  Description of Artificial Sequence Synthetic primer
caacgcgcactacnaaggctcctctggggcacaagt

SEQ ID NO: 217 - DNA, 36 bp, Artificial Sequence
  Description of Artificial Sequence Synthetic primer
caacaagcactacngggttttgttgtgccagtagaa

SEQ ID NO: 218 - DNA, 36 bp, Artificial Sequence
  Description of Artificial Sequence Synthetic primer
caacaagcaatacngggttttgttgtgccagtagag

SEQ ID NO: 219 - DNA, 37 bp, Artificial Sequence
  Description of Artificial Sequence Synthetic primer
caagaagaaataanctgccaattaatcatcaactctc

SEQ ID NO: 220 - DNA, 37 bp, Artificial Sequence
  Description of Artificial Sequence Synthetic primer
aaagaagaaataanctgccaattaatcatcaactctt

SEQ ID NO: 221 - DNA, 37 bp, Artificial Sequence
  Description of Artificial Sequence Synthetic primer
gaagaagacataanatgtcagccatcagcctctcaca

SEQ ID NO: 222 - DNA, 37 bp, Artificial Sequence
  Description of Artificial Sequence Synthetic primer
gaagaagacatagnatgtcagccatcagcctctcacg

SEQ ID NO: 223 - DNA, 37 bp, Artificial Sequence
  Description of Artificial Sequence Synthetic primer
gaagaggacgtagngctcttatatctcatatgaacac

SEQ ID NO: 224 - DNA, 37 bp, Artificial Sequence
  Description of Artificial Sequence Synthetic primer
gaggaggacgtagngctcttatatctcatatgaacag

SEQ ID NO: 225 - DNA, 38 bp, Artificial Sequence
  Description of Artificial Sequence Synthetic primer
ccacgctcctctacnacttttcatggttattctcagtc

SEQ ID NO: 226 - DNA, 38 bp, Artificial Sequence
  Description of Artificial Sequence Synthetic primer
ccgcgctcctctacnacttttcatggttattctcagtt

SEQ ID NO: 227 - DNA, 38 bp, Artificial Sequence
  Description of Artificial Sequence Synthetic primer
ccacgcgcaccaacntgttttgtttgttttgttttttc

SEQ ID NO: 228 - DNA, 38 bp, Artificial Sequence
  Description of Artificial Sequence Synthetic primer
ccacgcgcgccaacntgttttgtttgttttgttttttt

SEQ ID NO: 229 - DNA, 38 bp, Artificial Sequence
  Description of Artificial Sequence Synthetic primer
ccacgcgagtcaacnccatccagtaatggagtacagtc

SEQ ID NO: 230 - DNA, 38 bp, Artificial Sequence
  Description of Artificial Sequence Synthetic primer
ccacgagagtcaacnccatccagtaatggagtacagtg

SEQ ID NO: 231 - DNA, 38 bp, Artificial Sequence
  Description of Artificial Sequence Synthetic primer
ccacgagagtcaacnagtttttctttaaggggagtaga

SEQ ID NO: 232 - DNA, 38 bp, Artificial Sequence
  Description of Artificial Sequence Synthetic primer
caacgagagtaaacnagtttttctttaaggggagtagg

SEQ ID NO: 233 - DNA, 38 bp, Artificial Sequence
  Description of Artificial Sequence Synthetic primer
caaagagaataaacnggacaaagatgagtgcgtatatc

SEQ ID NO: 234 - DNA, 38 bp, Artificial Sequence
  Description of Artificial Sequence Synthetic primer
caaagagaataaaanggacaaagatgagtgcgtatatt

SEQ ID NO: 235 - DNA, 39 bp, Artificial Sequence
  Description of Artificial Sequence Synthetic primer
caaagagaatagaanggcttggggtccccattaaagcga

SEQ ID NO: 236 - DNA, 39 bp, Artificial Sequence
  Description of Artificial Sequence Synthetic primer
cagagagaatagaanggcttggggtccccattaaagcgg

SEQ ID NO: 237 - DNA, 38 bp, Artificial Sequence
  Description of Artificial Sequence Synthetic primer
aagagcgagagagantactaaagacgcttatcatggtc

SEQ ID NO: 238 - DNA, 38 bp, Artificial Sequence
  Description of Artificial Sequence Synthetic primer
aggagcgagagagantactaaagacgcttatcatggtt

SEQ ID NO: 239 - DNA, 39 bp, Artificial Sequence
  Description of Artificial Sequence Synthetic primer
cggagagagaggagntgcaaggctgtggctggacaagac

SEQ ID NO: 240 - DNA, 39 bp, Artificial Sequence
  Description of Artificial Sequence Synthetic primer
cggagagggaggagntgcaaggctgtggctggacaagat

SEQ ID NO: 241 - DNA, 41 bp, Artificial Sequence
  Description of Artificial Sequence Synthetic primer
cccgctccgccagtcnattctatattagaacaactctcttc

SEQ ID NO: 242 - DNA, 41 bp, Artificial Sequence
  Description of Artificial Sequence Synthetic primer
ccacgcgcgccagtcnattctatattagaacaactctcttt

SEQ ID NO: 243 - DNA, 41 bp, Artificial Sequence
  Description of Artificial Sequence Synthetic primer
ccacgcgcgacagacntaacgcatatgcacatgcacacatc

SEQ ID NO: 244 - DNA, 41 bp, Artificial Sequence
  Description of Artificial Sequence Synthetic primer
ccacgcgagacagacntaacgcatatgcacatgcacacatt

SEQ ID NO: 245 - DNA, 41 bp, Artificial Sequence
  Description of Artificial Sequence Synthetic primer
caacgcgagacagacntgtcctttcccaggatgctcaaagc

SEQ ID NO: 246 - DNA, 41 bp, Artificial Sequence
  Description of Artificial Sequence Synthetic primer
caacgcgagacagaantgtcctttcccaggatgctcaaagt

SEQ ID NO: 247 - DNA, 41 bp, Artificial Sequence
  Description of Artificial Sequence Synthetic primer
caacgagagacagtanagcagatgctggccccatgcttcag

SEQ ID NO: 248 - DNA, 41 bp, Artificial Sequence
  Description of Artificial Sequence Synthetic primer
caacgagagaaagtanagcagatgctggccccatgcttcat

SEQ ID NO: 249 - DNA, 41 bp, Artificial Sequence
  Description of Artificial Sequence Synthetic primer
caaggagagaaagaantaatagtacaacagctatcaattac

SEQ ID NO: 250 - DNA, 41 bp, Artificial Sequence
  Description of Artificial Sequence Synthetic primer
caaggagagagagaantaatagtacaacagctatcaattat

SEQ ID NO: 251 - DNA, 41 bp, Artificial Sequence
  Description of Artificial Sequence Synthetic primer
caaggagagagagagntgtgcaagtgtcagaagatgaacaa

SEQ ID NO: 252 - DNA, 41 bp, Artificial Sequence
  Description of Artificial Sequence Synthetic primer
cgaggagagagagagntgtgcaagtgtcagaagatgaacag

SEQ ID NO: 253 - DNA, 42 bp, Artificial Sequence
  Description of Artificial Sequence Synthetic primer
ccacctaccaccagtcngaagaaataagaaacattgagacac

SEQ ID NO: 254 - DNA, 42 bp, Artificial Sequence
  Description of Artificial Sequence Synthetic primer
ccacataccaccagtcngaagaaataagaaacattgagacat

SEQ ID NO: 255 - DNA, 13 bp, Artificial Sequence
  Description of Artificial Sequence Synthetic oligonucleotide
ccaccgcctccnc

SEQ ID NO: 256 - DNA, 13 bp, Artificial Sequence
  Description of Artificial Sequence Synthetic oligonucleotide
ccaccgcctacnc

SEQ ID NO: 257 - DNA, 13 bp, Artificial Sequence
  Description of Artificial Sequence Synthetic oligonucleotide
ccacagcctacnc

SEQ ID NO: 258 - DNA, 13 bp, Artificial Sequence
  Description of Artificial Sequence Synthetic oligonucleotide
ccacagcatacnc

SEQ ID NO: 259 - DNA, 13 bp, Artificial Sequence
  Description of Artificial Sequence Synthetic oligonucleotide
caacagcacaant

SEQ ID NO: 260 - DNA, 13 bp, Artificial Sequence
  Description of Artificial Sequence Synthetic oligonucleotide
caacagaacaant

SEQ ID NO: 261 - DNA, 13 bp, Artificial Sequence
  Description of Artificial Sequence Synthetic oligonucleotide
caaaagaacaant

SEQ ID NO: 262 - DNA, 13 bp, Artificial Sequence
  Description of Artificial Sequence Synthetic oligonucleotide
caaaagaaaaant

SEQ ID NO: 263 - DNA, 13 bp, Artificial Sequence
  Description of Artificial Sequence Synthetic oligonucleotide
aataagaagaanc

SEQ ID NO: 264 - DNA, 13 bp, Artificial Sequence
  Description of Artificial Sequence Synthetic oligonucleotide
gataagaagaanc

SEQ ID NO: 265 - DNA, 13 bp, Artificial Sequence
  Description of Artificial Sequence Synthetic oligonucleotide
aatagcgagaang

SEQ ID NO: 266 - DNA, 13 bp, Artificial Sequence
  Description of Artificial Sequence Synthetic oligonucleotide
aatagcgagagng

SEQ ID NO: 267 - DNA, 14 bp, Artificial Sequence
  Description of Artificial Sequence Synthetic oligonucleotide
ccacccccgcccnt

SEQ ID NO: 268 - DNA, 14 bp, Artificial Sequence
  Description of Artificial Sequence Synthetic oligonucleotide
ccaccaccgcccnt

SEQ ID NO: 269 - DNA, 14 bp, Artificial Sequence
  Description of Artificial Sequence Synthetic oligonucleotide
ccaccgcactacnc

SEQ ID NO: 270 - DNA, 14 bp, Artificial Sequence
  Description of Artificial Sequence Synthetic oligonucleotide
ccacagcactacnc

SEQ ID NO: 271 - DNA, 14 bp, Artificial Sequence
  Description of Artificial Sequence Synthetic oligonucleotide
caacagcaccacnt

SEQ ID NO: 272 - DNA, 14 bp, Artificial Sequence
  Description of Artificial Sequence Synthetic oligonucleotide
caacagcaacacnt

SEQ ID NO: 273 - DNA, 14 bp, Artificial Sequence
  Description of Artificial Sequence Synthetic oligonucleotide
caacagctacaana

SEQ ID NO: 274 - DNA, 14 bp, Artificial Sequence
  Description of Artificial Sequence Synthetic oligonucleotide
caacagatacaana

SEQ ID NO: 275 - DNA, 14 bp, Artificial Sequence
  Description of Artificial Sequence Synthetic oligonucleotide
caaaagatacaana

SEQ ID NO: 276 - DNA, 14 bp, Artificial Sequence
  Description of Artificial Sequence Synthetic oligonucleotide
caaaagatagaana

SEQ ID NO: 277 - DNA, 14 bp, Artificial Sequence
  Description of Artificial Sequence Synthetic oligonucleotide
caaaagagagaant

SEQ ID NO: 278 - DNA, 14 bp, Artificial Sequence
  Description of Artificial Sequence Synthetic oligonucleotide
cagaagagagaant

SEQ ID NO: 279 - DNA, 14 bp, Artificial Sequence
  Description of Artificial Sequence Synthetic oligonucleotide
cagaagagagagnt

SEQ ID NO: 280 - DNA, 14 bp, Artificial Sequence
  Description of Artificial Sequence Synthetic oligonucleotide
caggagagagagnt

SEQ ID NO: 281 - DNA, 15 bp, Artificial Sequence
  Description of Artificial Sequence Synthetic oligonucleotide
ccacccaccgcccnt

SEQ ID NO: 282 - DNA, 15 bp, Artificial Sequence
  Description of Artificial Sequence Synthetic oligonucleotide
ccacccgccgcccnt

SEQ ID NO: 283 - DNA, 15 bp, Artificial Sequence
  Description of Artificial Sequence Synthetic oligonucleotide
ccacccgccgctcnt

SEQ ID NO: 284 - DNA, 15 bp, Artificial Sequence
  Description of Artificial Sequence Synthetic oligonucleotide
ccactcgccgctcnt

SEQ ID NO: 285 - DNA, 15 bp, Artificial Sequence
  Description of Artificial Sequence Synthetic oligonucleotide
ccacgcgccctacna

SEQ ID NO: 286 - DNA, 15 bp, Artificial Sequence
  Description of Artificial Sequence Synthetic oligonucleotide
caacgcgcactacna

SEQ ID NO: 287 - DNA, 15 bp, Artificial Sequence
  Description of Artificial Sequence Synthetic oligonucleotide
caacaagcactacng

SEQ ID NO: 288 - DNA, 15 bp, Artificial Sequence
  Description of Artificial Sequence Synthetic oligonucleotide
caacaagcaatacng

SEQ ID NO: 289 - DNA, 15 bp, Artificial Sequence
  Description of Artificial Sequence Synthetic oligonucleotide
caagaagaaataanc

SEQ ID NO: 290 - DNA, 15 bp, Artificial Sequence
  Description of Artificial Sequence Synthetic oligonucleotide
aaagaagaaataanc

SEQ ID NO: 291 - DNA, 15 bp, Artificial Sequence
  Description of Artificial Sequence Synthetic oligonucleotide
gaagaagacataana

SEQ ID NO: 292 - DNA, 15 bp, Artificial Sequence
  Description of Artificial Sequence Synthetic oligonucleotide
gaagaagacatagna

SEQ ID NO: 293 - DNA, 15 bp, Artificial Sequence
  Description of Artificial Sequence Synthetic oligonucleotide
gaagaggacgtagng

SEQ ID NO: 294 - DNA, 15 bp, Artificial Sequence
  Description of Artificial Sequence Synthetic oligonucleotide
gaggaggacgtagng

SEQ ID NO: 295 - DNA, 16 bp, Artificial Sequence
  Description of Artificial Sequence Synthetic oligonucleotide
ccacgctcctctacna

SEQ ID NO: 296 - DNA, 16 bp, Artificial Sequence
  Description of Artificial Sequence Synthetic oligonucleotide
ccgcgctcctctacna

SEQ ID NO: 297 - DNA, 16 bp, Artificial Sequence
  Description of Artificial Sequence Synthetic oligonucleotide
ccacgcgcaccaacnt

SEQ ID NO: 298 - DNA, 16 bp, Artificial Sequence
  Description of Artificial Sequence Synthetic oligonucleotide
ccacgcgcgccaacnt

SEQ ID NO: 299 - DNA, 16 bp, Artificial Sequence
  Description of Artificial Sequence Synthetic oligonucleotide
ccacgcgagtcaacnc

SEQ ID NO: 300 - DNA, 16 bp, Artificial Sequence
  Description of Artificial Sequence Synthetic oligonucleotide
ccacgagagtcaacnc

SEQ ID NO: 301 - DNA, 16 bp, Artificial Sequence
  Description of Artificial Sequence Synthetic oligonucleotide
ccacgagagtcaacna

SEQ ID NO: 302 - DNA, 16 bp, Artificial Sequence
  Description of Artificial Sequence Synthetic oligonucleotide
caacgagagtaaacna

SEQ ID NO: 303 - DNA, 16 bp, Artificial Sequence
  Description of Artificial Sequence Synthetic oligonucleotide
caaagagaataaacng

SEQ ID NO: 304 - DNA, 16 bp, Artificial Sequence
  Description of Artificial Sequence Synthetic oligonucleotide
caaagagaataaaang

SEQ ID NO: 305 - DNA, 16 bp, Artificial Sequence
  Description of Artificial Sequence Synthetic oligonucleotide
caaagagaatagaang

SEQ ID NO: 306 - DNA, 16 bp, Artificial Sequence
  Description of Artificial Sequence Synthetic oligonucleotide
cagagagaatagaang

SEQ ID NO: 307 - DNA, 16 bp, Artificial Sequence
  Description of Artificial Sequence Synthetic oligonucleotide
aagagcgagagagant

SEQ ID NO: 308 - DNA, 16 bp, Artificial Sequence
  Description of Artificial Sequence Synthetic oligonucleotide
aggagcgagagagant

SEQ ID NO: 309 - DNA, 16 bp, Artificial Sequence
  Description of Artificial Sequence Synthetic oligonucleotide
cggagagagaggagnt

SEQ ID NO: 310 - DNA, 16 bp, Artificial Sequence
  Description of Artificial Sequence Synthetic oligonucleotide
cggagagggaggagnt

SEQ ID NO: 311 - DNA, 17 bp, Artificial Sequence
  Description of Artificial Sequence Synthetic oligonucleotide
cccgctccgccagtcna

SEQ ID NO: 312 - DNA, 17 bp, Artificial Sequence
  Description of Artificial Sequence Synthetic oligonucleotide
ccacgcgcgccagtcna

SEQ ID NO: 313 - DNA, 17 bp, Artificial Sequence
  Description of Artificial Sequence Synthetic oligonucleotide
ccacgcgcgacagacnt

SEQ ID NO: 314 - DNA, 17 bp, Artificial Sequence
  Description of Artificial Sequence Synthetic oligonucleotide
ccacgcgagacagacnt

SEQ ID NO: 315 - DNA, 17 bp, Artificial Sequence
  Description of Artificial Sequence Synthetic oligonucleotide
caacgcgagacagacnt

SEQ ID NO: 316 - DNA, 17 bp, Artificial Sequence
  Description of Artificial Sequence Synthetic oligonucleotide
caacgcgagacagaant

SEQ ID NO: 317 - DNA, 17 bp, Artificial Sequence
  Description of Artificial Sequence Synthetic oligonucleotide
caacgagagacagtana

SEQ ID NO: 318 - DNA, 17 bp, Artificial Sequence
  Description of Artificial Sequence Synthetic oligonucleotide
caacgagagaaagtana

SEQ ID NO: 319 - DNA, 17 bp, Artificial Sequence
  Description of Artificial Sequence Synthetic oligonucleotide
caaggagagaaagaant

SEQ ID NO: 320 - DNA, 17 bp, Artificial Sequence
  Description of Artificial Sequence Synthetic oligonucleotide
caaggagagagagaant

SEQ ID NO: 321 - DNA, 17 bp, Artificial Sequence
  Description of Artificial Sequence Synthetic oligonucleotide
caaggagagagagagnt

SEQ ID NO: 322 - DNA, 17 bp, Artificial Sequence
  Description of Artificial Sequence Synthetic oligonucleotide
cgaggagagagagagnt

SEQ ID NO: 323 - DNA, 18 bp, Artificial Sequence
  Description of Artificial Sequence Synthetic oligonucleotide
ccacctaccaccagtcng

SEQ ID NO: 324 - DNA, 18 bp, Artificial Sequence
  Description of Artificial Sequence Synthetic oligonucleotide
ccacataccaccagtcng

SEQ ID NO: 325 - DNA, 30 bp, Artificial Sequence
  Description of Artificial Sequence Synthetic primer
acgttggatgtaccagaacctacactcccc

SEQ ID NO: 326 - DNA, 30 bp, Artificial Sequence
  Description of Artificial Sequence Synthetic primer
acgttggatgacgtaagcacacatccccag

SEQ ID NO: 327 - DNA, 30 bp, Artificial Sequence
  Description of Artificial Sequence Synthetic primer
acgttggatgtctcaaactccagagtggcc

SEQ ID NO: 328 - DNA, 30 bp, Artificial Sequence
  Description of Artificial Sequence Synthetic primer
acgttggatgagctgttccacacttctgag

SEQ ID NO: 329 - DNA, 21 bp, Artificial Sequence
  Description of Artificial Sequence Synthetic primer
tttctccccacctgaccctgc

SEQ ID NO: 330 - DNA, 22 bp, Artificial Sequence
  Description of Artificial Sequence Synthetic primer
ttttctccccacctgaccctgt

SEQ ID NO: 331 - DNA, 28 bp, Artificial Sequence
  Description of Artificial Sequence Synthetic primer
ttattcccaggugcatgcatgcgcacac

SEQ ID NO: 332 - DNA, 29 bp, Artificial Sequence
  Description of Artificial Sequence Synthetic primer
ttatttcccaggugcatgcatgcgcacag

SEQ ID NO: 333 - DNA, 9 bp, Artificial Sequence
  Description of Artificial Sequence Synthetic oligonucleotide
tttctcccc

SEQ ID NO: 334 - DNA, 10 bp, Artificial Sequence
  Description of Artificial Sequence Synthetic oligonucleotide
ttttctcccc

SEQ ID NO: 335 - DNA, 12 bp, Artificial Sequence
  Description of Artificial Sequence Synthetic oligonucleotide
ttattcccaggu

SEQ ID NO: 336 - DNA, 13 bp, Artificial Sequence
  Description of Artificial Sequence Synthetic oligonucleotide
ttatttcccaggu

(19) United States
(12) Patent Application Publication
(10) Pub. No.: US 2012/0046178 A1
(43) Pub. Date: Feb. 23, 2012

(54) PRODUCTS AND PROCESSES FOR MULTIPLEX NUCLEIC ACID IDENTIFICATION

(75) Inventors: Dirk Johannes Van Den Boom, La Jolla, CA (US); Christiane Honisch, La Jolla, CA (US); Andrew Timms, Seattle, WA (US); Smita Chitnis, San Diego, CA (US)

(73) Assignee: SEQUENOM, INC., San Diego, CA (US)

(21) Appl. No.: 13/126,684

(22) PCT Filed: Oct. 27, 2009
(86) PCT No.: PCT/US09/62239

§ 371 Date: Oct. 12, 2011

(30) Foreign Application Priority Data
Oct. 30, 2008 (US) 61/109885

(51) Int. Cl. C40B 20/04

(52) U.S. Cl. 506/4

(57) ABSTRACT

Provided herein are products and processes for detecting the presence or absence of multiple target nucleic acids. Certain methods include amplifying the target nucleic acids, or portion thereof; extending oligonucleotides that specifically hybridize to the amplicons, where the oligonucleotides include distinguishable labels and a capture agent; capturing the extended oligonucleotides to a solid phase via the capture agent; releasing and detecting the distinguishable label, and thereby determining the presence or absence of each target nucleic acid by the presence or absence of the distinguishable label.

### RELATED PATENT APPLICATIONS

This patent application is a national stage of international patent application number PCT/US2009/062239, filed on Oct. 27, 2009, entitled PRODUCTS AND PROCESSES FOR MULTIPLEX NUCLEIC ACID IDENTIFICATION, naming Dirk Johannes Van Den Boom, Christiane Honisch, Andrew Timms and Smita Chitnis as applicants and inventors, and designated by attorney docket no. SEQ-6020-PC, which claims the benefit of U.S. Provisional Patent Application No. 61/109,885 filed on Oct. 30, 2008, entitled PRODUCTS AND PROCESSES FOR MULTIPLEX NUCLEIC ACID IDENTIFICATION, naming Dirk Johannes Van den Boom, Christiane Honisch, Andrew Timms and Smita Chitnis as inventors, and designated by Attorney Docket No. SEQ-6020-PV. The entire content of the foregoing patent applications hereby is incorporated by reference, including all text, tables and drawings.

### SEQUENCE LISTING

The instant application contains a Sequence Listing which has been submitted in ASCII format via EFS-Web and is hereby incorporated by reference in its entirety. Said ASCII copy, created on Jun. 6, 2011, is named SEQ6020US.txt and is 88,089 bytes in size.

1. Field

The technology relates in part to nucleic acid identification procedures in which multiple target nucleic acids can be detected in one procedure. The technology also in part relates to identification of nucleic acid modifications.

2. Background

The detection of specific nucleic acids is an important tool for diagnostic medicine and molecular biology research. Nucleic acid assays currently play roles in identifying infectious organisms such as bacteria and viruses, in probing the expression of normal genes and identifying mutant genes such as oncogenes, in typing tissue for compatibility preceding tissue transplantation, in matching tissue or blood samples for forensic medicine, and for exploring homology among genes from different species, for example.

### SUMMARY

A challenge associated with nucleic acid identification procedures lies in the ability to determine the presence or absence of multiple target nucleic acids in a composition, which is referred to as “multiplexing.” Certain multiplexing technologies do not allow for the detection of a significant number of target nucleic acids in a composition.

Methods described herein answer this challenge in part by combining extension and solid phase capture approaches with an identification readout specific for each target nucleic acid. These processes are highly accurate and are very rapid as a significant number of target nucleic acids can be detected in one assay or procedure.

Accordingly, provided herein is a method for determining the presence or absence of a plurality of target nucleic acids in a composition, which comprises: (a) preparing amplicons of the target nucleic acids by amplifying the target nucleic acids, or portions thereof, under amplification conditions; (b) contacting the amplicons in solution with a set of oligonucleotides under hybridization conditions, where: (i) each oligonucleotide in the set comprises a hybridization sequence capable of specifically hybridizing to one amplicon under the hybridization conditions when the amplicon is present in the solution, (ii) each oligonucleotide in the set comprises a distinguishable tag located 5′ of the hybridization sequence, (iii) a feature of the distinguishable tag of one oligonucleotide detectably differs from the features of distinguishable tags of the other oligonucleotides in the set; and (iv) each distinguishable tag specifically corresponds to a specific amplicon (e.g., an allele) and thereby specifically corresponds to a specific target nucleic acid; (c) generating extended oligonucleotides that comprise a capture agent by extending oligonucleotides hybridized to the amplicons by one or more nucleotides, where one of the one of more nucleotides is a terminating nucleotide and one or more of the nucleotides added to the oligonucleotides comprises the capture agent; (d) contacting the extended oligonucleotides with a solid phase under conditions in which the capture agent interacts with the solid phase; (e) releasing the distinguishable tags from the extended oligonucleotides that have interacted with the solid phase; and (f) detecting the distinguishable tags released in (e); whereby the presence or absence of each target nucleic acid is determined by the presence or absence of the corresponding distinguishable tag.

In certain embodiments, the extension in (c) is performed once yielding one extended oligonucleotide. In some embodiments, the extension in (c) is performed multiple times (e.g., under amplification conditions) yielding multiple copies of the extended oligonucleotide.

In certain embodiments, a solution containing amplicons (e.g., amplicons produced in (a)) is treated with an agent that removes terminal phosphates from any nucleotides not incorporated into the amplicons. The terminal phosphate sometimes is removed by contacting the amplicons with a phosphatase, and in certain embodiments the phosphatase is alkaline phosphatase (e.g., shrimp alkaline phosphatase).

In some embodiments, the hybridization sequence in each oligonucleotide is about 5 to about 50 nucleotides in length. In certain embodiments, terminal nucleotides in the extended oligonucleotides comprise the capture agent, and sometimes one or more non-terminal nucleotides in the extended oligonucleotides comprise the capture agent. In some embodiments, the capture agent comprises biotin, or alternatively avidin or streptavidin, in which case the solid phase comprises avidin or streptavidin, or biotin, respectively. The solid phase is paramagnetic, is a flat surface, a silicon chip, a bead and/or a sphere in some embodiments.

The distinguishable tag is distinguished in part by mass in certain embodiments (i.e., a mass distinguishable tag where a distinguishing feature is mass). The distinguishable tag in some embodiments consists of nucleotides, and sometimes the tag is about 5 nucleotides to about 50 nucleotides in length. The distinguishable tag in certain embodiments is a nucleotide compomer, which sometimes is about 5 nucleotides to about 35 nucleotides in length. In some embodiments, the distinguishable tag is a peptide, which sometimes is about 5 amino acids to about 100 amino acids in length. The distinguishable tag in certain embodiments is a concatemer of organic molecule units. In some embodiments, the tag is a trityl molecule concatemer. The distinguishable tag in certain embodiments is released by treatment with an endonuclease (e.g., endonuclease V), and in some embodiments, the distinguishable tag is linked to the oligonucleotide by a photocleavable linkage and is released by treatment with light. In certain embodiments, the distinguishable tag is linked by a ribonucleotide and released by treatment with a ribonuclease, and in certain embodiments, the distinguishable tag is linked to the oligonucleotide by inosine and is released by an agent that cleaves the inosine. A distinguishable tag sometimes is linked to the oligonucleotide by a linkage selected from the group consisting of methylphosphonate, phosphorothioate and phosphoroamidate, and is released by an agent that cleaves the methylphosphonate, phosphorothioate or phosphoroamidate. In embodiments where the distinguishable label is distinguished by mass, the mass of the distinguishable label sometimes is determined by mass spectrometry, including, without limitation, matrix-assisted laser desorption ionization (MALDI) mass spectrometry and electrospray (ES) mass spectrometry.

In certain embodiments, the presence or absence of about 50 or more target nucleic acids is detected by a method described herein. In some embodiments, about 100 or more, 150 or more, 200 or more, 250 or more, 300 or more, 325 or more, 350 or more, 375 or more, 400, or more, 425 or more, 450 or more, 475 or more or 500 or more target nucleic acids is detected. The target nucleic acids in certain embodiments are genomic DNA (e.g., human, microbial, viral, fungal or plant genomic DNA; any eukaryotic or prokaryotic nucleic acid (RNA and DNA)). In some embodiments, the oligonucleotides are RNA or DNA.

Also provided herein is a method for amplifying a plurality of target nucleic acids. In certain embodiments, provided is a method that comprises: (a) contacting the target nucleic acids with a set of first polynucleotides, where each first polynucleotide comprises (1) a first complementary sequence that hybridizes to the target nucleic acid and (2) a first tag located 5′ of the complementary sequence; (b) preparing extended first polynucleotides by extending the first polynucleotide; (c) joining a second polynucleotide to the 3′ end of the extended first polynucleotides, where the second polynucleotide comprises a second tag; (d) contacting the product of (c) with a primer and extending the primer, where the primer hybridizes to the first tag or second tag; and (e) amplifying the product of (c) with a set of primers under amplification conditions, where one primer in the set hybridizes to one of the tags and another primer in the set hybridizes to the complement of the other tag. In certain embodiments linear amplification is performed with one set of primers. In some embodiments, the second polynucleotide comprises a nucleotide sequence that hybridizes to the target nucleic acid. The nucleotide sequence of the first tag and the nucleotide sequence of the second tag are different in some embodiments, and are identical, or are complementary to one another, in other embodiments. In certain embodiments, the first tag and the second tag are included in each of the amplification products produced in (e).

The amplification procedures described in the previous paragraph can be utilized in multiplex detection assays of the present technology. Accordingly, the process described in the previous paragraph can further comprise (f) contacting the amplicons in solution with a set of oligonucleotides under hybridization conditions, where: (1) each oligonucleotide in the set comprises a hybridization sequence capable of specifically hybridizing to one amplicon under the hybridization conditions when the amplicon is present in the solution, (2) each oligonucleotide in the set comprises a distinguishable tag located 5′ of the hybridization sequence, (3) a feature of the distinguishable tag of one oligonucleotide detectably differs from the features of distinguishable tags of other oligonucleotides in the set; and (4) each distinguishable tag specifically corresponds to a specific amplicon and thereby specifically corresponds to a specific target nucleic acid; (g) generating extended oligonucleotides that comprise a capture agent by extending oligonucleotides hybridized to the amplicons by one or more nucleotides, where one of the one of more nucleotides is a terminating nucleotide and one or more of the nucleotides added to the oligonucleotides comprises the capture agent; (h) contacting the extended oligonucleotides with a solid phase under conditions in which the capture agent interacts with the solid phase; (i) releasing the distinguishable tags from the extended oligonucleotides that have interacted with the solid phase; and (j) detecting the distinguishable tags released in (i); whereby the presence or absence of each target nucleic acid is determined by the presence or absence of the corresponding distinguishable tag. In certain embodiments, the extension in (g) is performed once yielding one extended oligonucleotide. In some embodiments, the extension in (g) is performed multiple times (e.g., under amplification conditions) yielding multiple copies of the extended oligonucleotide.

Also provided herein is a method for determining the presence or absence of a plurality of target nucleic acids in a composition, which comprises (a) contacting target nucleic acids in solution with a set of oligonucleotides under hybridization conditions, wherein (i) each oligonucleotide in the set comprises a hybridization sequence capable of specifically hybridizing to one target nucleic acid species under the hybridization conditions when the target nucleic acid species is present in the solution, (ii) each oligonucleotide in the set comprises a mass distinguishable tag located 5′ of the hybridization sequence, (iii) the mass of the mass distinguishable tag of one oligonucleotide detectably differs from the masses of mass distinguishable tags of the other oligonucleotides in the set; and (iv) each mass distinguishable tag specifically corresponds to an amplicon and thereby specifically corresponds to a specific target nucleic acid; (b) generating extended oligonucleotides that comprise a capture agent by extending oligonucleotides hybridized to the amplicons by one or more nucleotides under amplification conditions, wherein one of the one of more nucleotides is a terminating nucleotide and one or more of the nucleotides added to the oligonucleotides comprises the capture agent; (c) contacting the extended oligonucleotides with a solid phase under conditions in which the capture agent interacts with the solid phase; (d) releasing the mass distinguishable tags from the extended oligonucleotides that have interacted with the solid phase; and (e) detecting the mass distinguishable tags released in (e) by mass spectrometry; whereby the presence or absence of each target nucleic acid is determined by the presence or absence of the corresponding mass distinguishable tag.

Certain embodiments are described further in the following description, claims and drawings.

### BRIEF DESCRIPTION OF THE DRAWINGS

The drawings illustrate certain non-limiting embodiments of the technology and not necessarily drawn to scale.

FIG. 1 shows amplification of a gene of interest using extension of a gene specific primer with a universal PCR tag and a subsequent single strand ligation to a second universal tag followed by exonuclease clean-up and amplification utilizing tag 1 and 2 (Approach 1).

FIG. 2 shows amplification of a gene of interest using a gene specific biotinylated primer with a universal tag 3 that is extended on a template then ligated downstream to a gene specific phosphorylated oligonucleotide tag 4 on the same strand. This product is subsequently amplified utilizing tag 3 and 4 (Concept 2).

FIG. 3 shows the universal PCR products from both Approach 1 and 2 procedures from FIGS. 1 and 2, which can be identified using a post-PCR reaction (goldPLEX, Sequenom).

FIG. 4 shows MALDI-TOF MS spectra for genotyping of a single nucleotide polymorphism (dbSNP# rs10063237) using a Approach 1 protocol.

FIG. 5A shows MALDI-TOF MS spectra for genotyping of rs1015731 using a Approach 2 protocol.

FIG. 5B shows MALDI-TOF MS spectra for genotyping 12 targets (e.g., a 12plex reaction) using a Approach 2 protocol.

FIG. 5C shows MALDI-TOF MS spectra for genotyping a 19plex reaction using a Approach 2 protocol.

FIG. 5D shows MALDI-TOF MS spectra for genotyping a 35plex reaction using a Approach 2 protocol.

FIG. 5E shows the genotypes acquired from MALDI-TOF MS spectra from FIG. 5C (19plex) and FIG. 5D (35plex).

FIG. 6 shows PCR amplification and post-PCR primer extension with allele-specific extension primers containing allele-specific mass tags.

FIG. 7 shows MALDI-TOF MS spectra for 35plex genotyping using post-PCR primer extension with allele-specific extension primers containing allele-specific mass tags as a readout.

FIG. 8 shows MALDI-TOF MS spectra for genotyping of rs1000586 and rs10131894.

FIG. 9 shows oligonucleotides mass tags corresponding to a 70plex assay. All oligos were diluted to a final total concentration of 10 pmol and spotted on a 384 well chip. Values for area, peak height and signal-to-noise ratio were collected from Typer 3.4 (Sequenom).

FIG. 10 shows peak areas for oligonucleotides mass tags corresponding to 70plex assay sorted by nucleotide composition. All oligos were diluted to a final total concentration of 10 pmol and spotted on a 384 well chip. Area values were collected from Typer 3.4 (Sequenom).

FIG. 11A shows a MALDI-TOF MS spectrum (zoomed views) of oligonucleotide tags corresponding to a 100plex assay. FIG. 11B shows signal to noise ratios of oligonucleotide tags corresponding to a 100plex assay. All oligos were diluted to a final total concentration of 10, 5, 2.5 or 1 pmol, with 8 replicates spotted on a 384 well chip. Values for signal-to-noise ratio were collected from Typer 3.4 (Sequenom). FIG. 11C shows a MALDI-TOF MS spectrum (zoomed views) of a 100plex assay after PCR amplification and post-PCR primer extension with allele-specific extension primers containing allele-specific mass tags.

FIG. 12 shows extension rates for a 5plex reaction. Comparing extension oligonucleotides with or without a deoxyinosine, and either standard ddNTPs or nucleotides containing a biotin moiety. Extension rates were calculated by dividing the area of extended product by the total area of the peak (extended product and unextended oligonucleotide) in Typer 3.4 (Sequenom). All experiments compare six DNAs.

FIG. 13 shows extension rates for 7plex and 5plex reactions over two DNAs. Results compare extension by a single biotinylated ddNTP or a biotinylated dNTP and terminated by an unmodified ddNTP, and final amounts of biotinylated dNTP or ddNTP of 210 or 420 pmol added to the reaction. Extension rates were calculated by dividing the area of extended product by the total area (extended product and unextended oligonucleotide) in Typer 3.4. All experiments include two replicates of two Centre de'Etude du Polymorphisme Humain (CEPH) DNAs, NA07019 and NA11036.

FIG. 14 shows a comparison of goldPLEX enzyme concentrations in an extension reaction using a 70plex assay. All assays followed the same protocol except for the amount of goldPLEX enzyme used. All experiments include four replicates of the two CEPH DNAs NA06991 and NA07019. The results compare the signal-to-noise ratios of the extension products from Typer 3.4 (Sequenom).

FIG. 15 shows a comparison of goldPLEX buffer concentration in extension reactions using a 70plex assay. All assays followed the same protocol except for the amount of goldPLEX buffer used. All experiments include four replicates of the two CEPH DNAs NA06991 and NA07019. The results compare the signal-to-noise ratios of the extension products from Typer 3.4 (Sequenom).

FIGS. 16, 17, 18 and 19 show a comparison of extension oligonucleotide concentration in extension reactions using a 70plex assay. All assays followed the same protocol except for the amount of extension oligonucleotide used. All experiments include four replicates of the two CEPH DNAs NA06991 and NA07019. The results compare the signal-to-noise ratios of the extension products from Typer 3.4 (Sequenom).

FIGS. 20 and 21 show a comparison of biotinylated ddNTP concentration in extension reactions using a 70plex assay. All assays followed the same protocol except for the amount of biotinylated ddNTP used (value indicates final amount of each biotinylated nucleotide). All experiments include four replicates of the two CEPH DNAs NA06991 and NA07019. The results compare the signal-to-noise ratios of the extension products from Typer 3.4 (Sequenom).

FIG. 22 shows a comparison of Solulink and Dynabeads MyOne C1 magnetic streptavidin beads for capturing the extend products. A total amount of 10 pmol of each oligonucleotide corresponding to the two possible alleles for assay rs1000586 were bound to the magnetic streptavidin beads, in the presence of either water or varying quantities of biotinylated dNTPs (total 10, 100 or 500 pmol). The mass tags were then cleaved from the bound oligonucleotide with 10 U of endonuclease V. The results compare the area of the mass tag peaks from Typer 3.4 (Sequenom) and are listed in comparison with 10 pmol of an oligonucleotide which has a similar mass.

FIG. 23 shows analysis of the ability of endonuclease V to cleave an extension product containing a deoxyinosine nucleotide in different locations. The oligonucleotides were identical aside from the deoxyinosine being 10, 15, 20 or 25 bases from the 3′ end of the oligonucleotide. After binding the oligonucleotide to the magnetic streptavidin beads, the supernatant was collected, cleaned by a nucleotide removal kit (Qiagen) and then cleaved by treatment with endonuclease V (termed unbound oligo). The beads were washed, and cleaved with endonuclease V, as outlined in protocol section (termed captured/cleaved). The results compare the area of the peaks from Typer 3.4 (Sequenom), and are listed as a percentage of oligonucleotide cleaved by endonuclease V without being bound to magnetic streptavidin beads.

FIG. 24 shows a comparison of magnetic streptavidin beads and endonuclease V concentration using a 70plex assay. All assays were conducted using the same conditions except for the amount of magnetic streptavidin beads and endonuclease V. All experiments include four replicates of the CEPH DNA NA11036. The results compare the signal-to-noise ratio from Typer 3.4.

FIGS. 25 and 26 show a comparison of magnetic streptavidin beads and endonuclease V concentration using a 70plex assay. All assays followed the same protocol except for the amount of magnetic streptavidin beads and endonuclease V. All experiments include four replicates of the two CEPH DNAs NA06991 and NA07019. The results compare the signal-to-noise ratio from Typer 3.4.

### DETAILED DESCRIPTION

Methods for determining the presence or absence of a plurality of target nucleic acids in a composition described herein find multiple uses by the person of ordinary skill in the art (hereafter referred to herein as the “person of ordinary skill”). Such methods can be utilized, for example, to: (a) rapidly determine whether a particular target sequence is present in a sample; (b) perform mixture analysis, e.g., identify a mixture and/or its composition or determine the frequency of a target sequence in a mixture (e.g., mixed communities, quasispecies); (c) detect sequence variations (e.g., mutations, single nucleotide polymorphisms) in a sample; (d) perform haplotyping determinations; (e) perform microorganism (e.g., pathogen) typing; (f) detect the presence or absence of a microorganism target sequence in a sample; (g) identify disease markers; (h) detect microsatellites; (i) identify short tandem repeats; (j) identify an organism or organisms; (k) detect allelic variations; (l) determine allelic frequency; (m) determine methylation patterns; (n) perform epigenetic determinations; (o) re-sequence a region of a biomolecule; (p) perform analyses in human clinical research and medicine (e.g. cancer marker detection, sequence variation detection; detection of sequence signatures favorable or unfavorable for a particular drug administration), (q) perform HLA typing; (r) perform forensics analyses; (s) perform vaccine quality control analyses; (t) monitor treatments; (u) perform vector identity analyses; (v) perform vaccine or production strain quality control and (w) test strain identity (x) plants. Such methods also may be utilized, for example, in a variety of fields, including, without limitation, in commercial, education, medical, agriculture, environmental, disease monitoring, military defense, and forensics fields.

### Target Nucleic Acids

As used herein, the term “nucleic acid” refers to an oligonucleotide or polynucleotide, including, without limitation, natural nucleic acids (e.g., deoxyribonucleic acid (DNA), ribonucleic acid (RNA)), synthetic nucleic acids, non-natural nucleic acids (e.g., peptide nucleic acid (PNA)), unmodified nucleic acids, modified nucleic acids (e.g., methylated DNA or RNA, labeled DNA or RNA, DNA or RNA having one or more modified nucleotides). Reference to a nucleic acid as a “polynucleotide” refers to two or more nucleotides or nucleotide analogs linked by a covalent bond. Nucleic acids may be any type of nucleic acid suitable for use with processes described herein. A nucleic acid in certain embodiments can be DNA (e.g., complementary DNA (cDNA), genomic DNA (gDNA), plasmids and vector DNA and the like), RNA (e.g., viral RNA, message RNA (mRNA), short inhibitory RNA (siRNA), ribosomal RNA (rRNA), tRNA and the like), and/or DNA or RNA analogs (e.g., containing base analogs, sugar analogs and/or a non-native backbone and the like). A nucleic acid can be in any form useful for conducting processes herein (e.g., linear, circular, supercoiled, single-stranded, double-stranded and the like). A nucleic acid may be, or may be from, a plasmid, phage, autonomously replicating sequence (ARS), centromere, artificial chromosome, chromosome, a cell, a cell nucleus or cytoplasm of a cell in certain embodiments. A nucleic acid in some embodiments is from a single chromosome (e.g., a nucleic acid sample may be from one chromosome of a sample obtained from a diploid organism). In the case of fetal nucleic acid, the nucleic acid may be from the paternal allele, the maternal allele or the maternal and paternal allele.

The term “species,” as used herein with reference to a target nucleic acid, amplicon, primer, sequence tag, polynucleotide or oligonucleotide, refers to one nucleic acid having a nucleotide sequence that differs by one or more nucleotides from the nucleotide sequence of another nucleic acid when the nucleotide sequences are aligned. Thus, a first nucleic acid species differs from a second nucleic acid species when the sequences of the two species, when aligned, differ by one or more nucleotides (e.g., about 1, 2, 3, 4, 5, 10, 15, 20, 25, 30, 35, 40, 45, 50, 55, 60, 65, 70, 75, 80, 85, 90, 95, 100 or more than 100 nucleotide differences). In certain embodiments, the number of nucleic acid species, such as target nucleic acid species, amplicon species or extended oligonucleotide species, includes, but is not limited to about 2 to about 10000 nucleic acid species, about 2 to about 1000 nucleic acid species, about 2 to about 500 nucleic acid species, or sometimes about 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 80, 85, 90, 95, 100, 125, 150, 175, 200, 225, 250, 275, 300, 325, 350, 375, 400, 425, 450, 475, 500, 600, 700, 800, 900,1000, 2000, 3000, 4000, 5000, 6000, 7000, 8000, 9000 or 10000 nucleic acid species.

As used herein, the term “nucleotides” refers to natural and non-natural nucleotides. Nucleotides include, but are not limited to, naturally occurring nucleoside mono-, di-, and triphosphates: deoxyadenosine mono-, di- and triphosphate; deoxyguanosine mono-, di- and triphosphate; deoxythymidine mono-, di- and triphosphate; deoxycytidine mono-, di- and triphosphate; deoxyuridine mono-, di- and triphosphate; and deoxyinosine mono-, di- and triphosphate (referred to herein as dA, dG, dT, dC, dU and dl, or A, G, T, C, U and I respectively). Nucleotides also include, but are not limited to, modified nucleotides and nucleotide analogs. Modified nucleotides and nucleotide analogs include, without limitation, deazapurine nucleotides, e.g., 7-deaza-deoxyguanosine (7-deaza-dG) and 7-deaza-deoxyadenosine (7-deaza-dA) mono-, di- and triphosphates, deutero-deoxythymidine (deutero-dT) mon-, di- and triphosphates, methylated nucleotides e.g., 5-methyldeoxycytidine triphosphate, .sup.13C/.sup.15N labelled nucleotides and deoxyinosine mono-, di- and triphosphate. Modified nucleotides, isotopically enriched nucleotides, depleted nucleotides, tagged and labeled nucleotides and nucleotide analogs can be obtained using a variety of combinations of functionality and attachment positions.

The term “composition” as used herein with reference to nucleic acids refers to a tangible item that includes one or more nucleic acids. A composition sometimes is a sample extracted from a source, but also a composition of all samples at the source, and at times is the source of one or more nucleic acids.

A nucleic acid sample may be derived from one or more sources. A sample may be collected from an organism, mineral or geological site (e.g., soil, rock, mineral deposit, fossil), or forensic site (e.g., crime scene, contraband or suspected contraband), for example. Thus, a source may be environmental, such as geological, agricultural, combat theater or soil sources, for example. A source also may be from any type of organism such as any plant, fungus, protistan, moneran, virus or animal, including but not limited, human, non-human, mammal, reptile, cattle, cat, dog, goat, swine, pig, monkey, ape, gorilla, bull, cow, bear, horse, sheep, poultry, mouse, rat, fish, dolphin, whale, and shark, or any animal or organism that may have a detectable nucleic acids. Sources also can refer to different parts of an organism such as internal parts, external parts, living or non-living cells, tissue, fluid and the like. A sample therefore may be a “biological sample,” which refers to any material obtained from a living source or formerly-living source, for example, an animal such as a human or other mammal, a plant, a bacterium, a fungus, a protist or a virus. A source can be in any form, including, without limitation, a solid material such as a tissue, cells, a cell pellet, a cell extract, or a biopsy, or a biological fluid such as urine, blood, saliva, amniotic fluid, exudate from a region of infection or inflammation, or a mouth wash containing buccal cells, hair, cerebral spinal fluid and synovial fluid and organs. A sample also may be isolated at a different time point as compared to another sample, where each of the samples are from the same or a different source. A nucleic acid may be from a nucleic acid library, such as a cDNA or RNA library, for example. A nucleic acid may be a result of nucleic acid purification or isolation and/or amplification of nucleic acid molecules from the sample. Nucleic acid provided for sequence analysis processes described herein may contain nucleic acid from one sample or from two or more samples (e.g., from 1, 2, 3, 4, 5, 6, 7, 8, 9, 10, 11, 12, 13, 14, 15, 16, 17, 18, 19, 20, 25, 50, 75, 100, 200, 300, 400, 500, 600, 700, 800, 900 or 1000 or more samples).

Nucleic acids may be treated in a variety of manners. For example, a nucleic acid may be reduced in size (e.g., sheared, digested by nuclease or restriction enzyme, de-phosphorylated, de-methylated), increased in size (e.g., phosphorylated, reacted with a methylation-specific reagent, attached to a detectable label), treated with inhibitors of nucleic acid cleavage and the like.

Nucleic acids may be provided for conducting methods described herein without processing, in certain embodiments. In some embodiments, nucleic acid is provided for conducting methods described herein after processing. For example, a nucleic acid may be extracted, isolated, purified or amplified from a sample. The term “isolated” as used herein refers to nucleic acid removed from its original environment (e.g., the natural environment if it is naturally occurring, or a host cell if expressed exogenously), and thus is altered “by the hand of man” from its original environment. An isolated nucleic acid generally is provided with fewer non-nucleic acid components (e.g., protein, lipid) than the amount of components present in a source sample. A composition comprising isolated nucleic acid can be substantially isolated (e.g., about 90%, 91%, 92%, 93%, 94%, 95%, 96%, 97%, 98%, 99% or greater than 99% free of non-nucleic acid components). The term “purified” as used herein refers to nucleic acid provided that contains fewer nucleic acid species than in the sample source from which the nucleic acid is derived. A composition comprising nucleic acid may be substantially purified (e.g., about 90%, 91%, 92%, 93%, 94%, 95%, 96%, 97%, 98%, 99% or greater than 99% free of other nucleic acid species).

Nucleic acids may be processed by a method that generates nucleic acid fragments, in certain embodiments, before providing nucleic acid for a process described herein. In some embodiments, nucleic acid subjected to fragmentation or cleavage may have a nominal, average or mean length of about 5 to about 10,000 base pairs, about 100 to about 1,00 base pairs, about 100 to about 500 base pairs, or about 10, 15, 20, 25, 30, 35, 40, 45, 50, 55, 60, 65, 70, 75, 80, 85, 90, 95, 100, 200, 300, 400, 500, 600, 700, 800, 900, 1000, 2000, 3000, 4000, 5000, 6000, 7000, 8000, 9000 or 10000 base pairs. Fragments can be generated by any suitable method known in the art, and the average, mean or nominal length of nucleic acid fragments can be controlled by selecting an appropriate fragment-generating procedure. In certain embodiments, nucleic acid of a relatively shorter length can be utilized to analyze sequences that contain little sequence variation and/or contain relatively large amounts of known nucleotide sequence information. In some embodiments, nucleic acid of a relatively longer length can be utilized to analyze sequences that contain greater sequence variation and/or contain relatively small amounts of unknown nucleotide sequence information.

As used herein, the term “target nucleic acid” refers to any nucleic acid species of interest in a sample. A target nucleic acid includes, without limitation, (i) a particular allele amongst two or more possible alleles, and (ii) a nucleic acid having, or not having, a particular mutation, nucleotide substitution, sequence variation, repeat sequence, marker or distinguishing sequence. As used herein, the term “different target nucleic acids” refers to nucleic acid species that differ by one or more features. Features include, without limitation, one or more methyl groups or a methylation state, one or more phosphates, one or more acetyl groups, and one or more deletions, additions or substitutions of one or more nucleotides. Examples of one or more deletions, additions or substitutions of one or more nucleotides include, without limitation, the presence or absence of a particular mutation, presence or absence of a nucleotide substitution (e.g., single nucleotide polymorphism (SNP)), presence or absence of a repeat sequence (e.g., di-, tri-, tetra-, penta-nucleotide repeat), presence or absence of a marker (e.g., microsatellite) and presence of absence of a distinguishing sequence (e.g., a sequence that distinguishes one organism from another (e.g., a sequence that distinguishes one viral strain from another viral strain)). Different target nucleic acids may be distinguished by any known method, for example, by mass, binding, distinguishable tags and the like, as described herein.

As used herein, the term “plurality of target nucleic acids” refers to more than one target nucleic acid. A plurality of target nucleic acids can be about 2 to about 10000 nucleic acid species, about 2 to about 1000 nucleic acid species, about 2 to about 500 nucleic acid species, or sometimes about 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 80, 85, 90, 95, 100, 125, 150, 175, 200, 225, 250, 275, 300, 325, 350, 375, 400, 425, 450, 475, 500, 600, 700, 800, 900,1000, 2000, 3000, 4000, 5000, 6000, 7000, 8000, 9000 or 10000 nucleic acid species, in certain embodiments. Detection or identification of nucleic acids results in detection of the target and can indicate the presence or absence of a particular mutation, sequence variation (mutation or polymorphism). Within the plurality of target nucleic acids, there may be detection of the same or different target nucleic acids. The plurality of target nucleic acids may also be identified quantitatively as well as qualitatively in terms of identification. Also refer to multiplexing below.

### Amplification and Extension

A nucleic acid (e.g., a target nucleic acid) can be amplified in certain embodiments. As used herein, the term “amplifying,” and grammatical variants thereof, refers to a process of generating copies of a template nucleic acid. For example, nucleic acid template may be subjected to a process that linearly or exponentially generates two or more nucleic acid amplicons (copies) having the same or substantially the same nucleotide sequence as the nucleotide sequence of the template, or a portion of the template. Nucleic acid amplification often is specific (e.g., amplicons have the same or substantially the same sequence), and can be non-specific (e.g., amplicons have different sequences) in certain embodiments. Nucleic acid amplification sometimes is beneficial when the amount of target sequence present in a sample is low. By amplifying the target sequences and detecting the amplicon synthesized, sensitivity of an assay can be improved, since fewer target sequences are needed at the beginning of the assay for detection of a target nucleic acid. A target nucleic acid sometimes is not amplified prior to hybridizing an extension oligonucleotide, in certain embodiments.

Amplification conditions are known and can be selected for a particular nucleic acid that will be amplified. Amplification conditions include certain reagents some of which can include, without limitation, nucleotides (e.g., nucleotide triphosphates), modified nucleotides, oligonucleotides (e.g., primer oligonucleotides for polymerase-based amplification and oligonucleotide building blocks for ligase-based amplification), one or more salts (e.g., magnesium-containing salt), one or more buffers, one or more polymerizing agents (e.g., ligase enzyme, polymerase enzyme), one or more nicking enzymes (e.g., an enzyme that cleaves one strand of a double-stranded nucleic acid) and one or more nucleases (e.g., exonuclease, endonuclease, RNase). Any polymerase suitable for amplification may be utilized, such as a polymerase with or without exonuclease activity, DNA polymerase and RNA polymerase, mutant forms of these enzymes, for example. Any ligase suitable for joining the 5′ of one oligonucleotide to the 3′ end of another oligonucleotide can be utilized. Amplification conditions also can include certain reaction conditions, such as isothermal or temperature cycle conditions. Methods for cycling temperature in an amplification process are known, such as by using a thermocycle device. Amplification conditions also can, in some embodiments, include an emulsion agent (e.g., oil) that can be utilized to form multiple reaction compartments within which single nucleic acid molecule species can be amplified.

A strand of a single-stranded nucleic acid target can be amplified and one or two strands of a double-stranded nucleic acid target can be amplified. An amplification product (amplicon), in some embodiments, is about 10 nucleotides to about 10,000 nucleotides in length, about 10 to about 1000 nucleotides in length, about 10 to about 500 nucleotides in length, 10 to about 100 nucleotides in length, and sometimes about 10, 11, 12, 13, 14, 15, 16, 17, 18, 19, 20, 25, 30, 35, 40, 45, 50, 55, 60, 65, 70, 75, 80, 80, 85, 90, 95, 100, 125, 150, 175, 200, 225, 250, 275, 300, 325, 350, 375, 400, 425, 450, 475, 500, 600, 700, 800, 900 or 1000 nucleotides in length.

Any suitable amplification technique and amplification conditions can be selected for a particular nucleic acid for amplification. Known amplification processes include, without limitation, polymerase chain reaction (PCR), extension and ligation, ligation amplification (or ligase chain reaction (LCR)) and amplification methods based on the use of Q-beta replicase or template-dependent polymerase (see US Patent Publication Number US20050287592). Also useful are strand displacement amplification (SDA), thermophilic SDA, nucleic acid sequence based amplification (3SR or NASBA) and transcription-associated amplification (TAA). Reagents, apparatus and hardware for conducting amplification processes are commercially available, and amplification conditions are known and can be selected for the target nucleic acid at hand.

Polymerase-based amplification can be effected, in certain embodiments, by employing universal primers. In such processes, hybridization regions that hybridize to one or more universal primers are incorporated into a template nucleic acid. Such hybridization regions can be incorporated into (i) a primer that hybridizes to a target nucleic acid and is extended, and/or (ii) an oligonucleotide that is joined (e.g., ligated using a ligase enzyme) to a target nucleic acid or a product of (i), for example. Amplification processes that involve universal primers can provide an advantage of amplifying a plurality of target nucleic acids using only one or two amplification primers, for example.

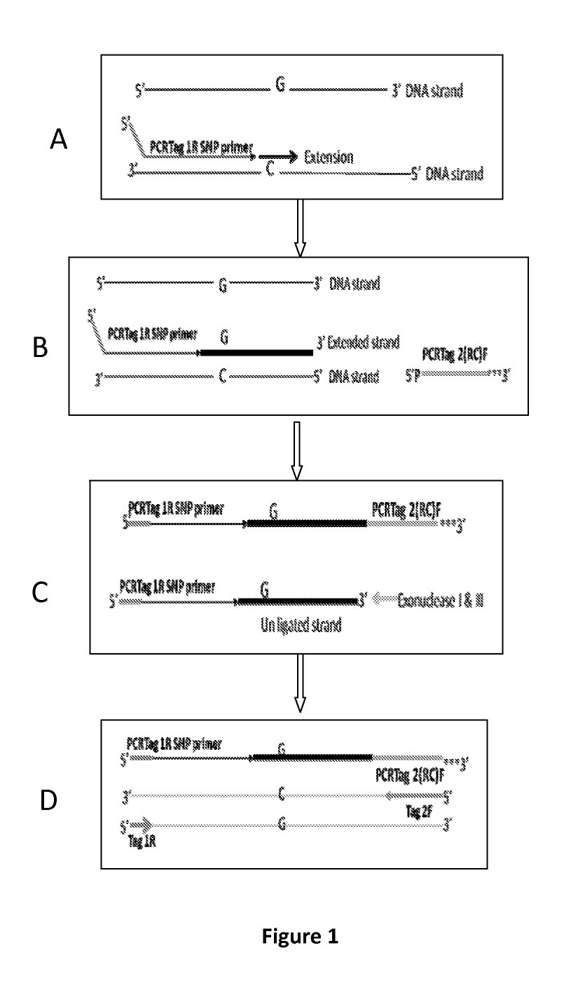

FIG. 1 shows certain embodiments of amplification processes. In certain embodiments, only one primer is utilized for amplification (e.g., FIG. 1A). In certain embodiments, two primers are utilized. Under amplification conditions at least one primer has a complementary distinguishable tag. The gene specific extend primer has a 5′ universal PCRTag1 R (e.g., FIG. 1A). It may be extended on any nucleic acid, for example genomic DNA. The DNA or the PCR Tag1 R gene specific extend primer may be biotinylated, to facilitate clean up of the reaction. The extended strand then is ligated by a single strand ligase to a universal phosphorylated oligonucleotide, which has a sequence that is the reverse complement of Tag2F (universal PCR primer; FIG. 1B). To facilitate cleanup in the next step, the phosphorylated oligonucleotide can include exonuclease resistant nucleotides at its 3′ end. During the exonuclease treatment, all non-ligated extended strands are degraded, whereas ligated products are protected and remain in the reaction (e.g., FIG. 1C). A universal PCR then is performed, using Tag1R and the Tag2F primers, to amplify multiple targets (e.g., FIG. 1D).

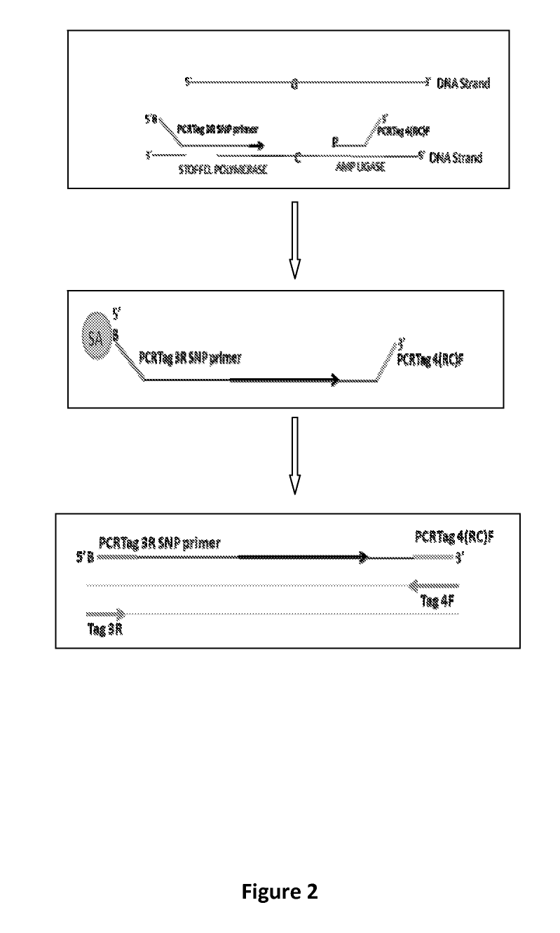

FIG. 2 also shows certain embodiments of amplification processes. In some embodiments, a method involving primer extension and ligation takes place in the same reaction (e.g., FIG. 2A). Biotinylated PCRTag3R gene-specific primer is an extension primer. The phosphorylated oligonucleotide has a gene-specific sequence and binds about 40 bases (e.g., 4 to 100 or more) away from the primer extension site, to the same strand of DNA. Thus a DNA polymerase, such as Stoffel polymerase, extends the strand, until it reaches the phosphorylated oligonucleotide. A ligase enzyme ligates the gene specific sequence of the phosphorylated oligonucleotide to the extended strand. The 3′ end of phosphorylated oligonucleotide has PCRTag4(RC)F as its universal tag. The biotinylated extended strands then are bound to streptavidin beads. This approach facilitates cleanup of the reaction (e.g., FIG. 2B). DNA, such as genomic DNA, and the gene specific phosphorylated oligonucleotides are washed away. A universal PCR then is performed, using Tag3R and Tag4F as primers, to amplify different genes of interest (e.g., FIG. 2C).

Certain nucleic acids can be extended in certain embodiments. The term “extension,” and grammatical variants thereof, as used herein refers to elongating one strand of a nucleic acid. For example, an oligonucleotide that hybridizes to a target nucleic acid or an amplicon generated from a target nucleic acid can be extended in certain embodiments. An extension reaction is conducted under extension conditions, and a variety of such conditions are known and selected for a particular application. Extension conditions include certain reagents, including without limitation, one or more oligonucleotides, extension nucleotides (e.g., nucleotide triphosphates (dNTPs)), terminating nucleotides (e.g., one or more dideoxynucleotide triphosphates (ddNTPs)), one or more salts (e.g., magnesium-containing salt), one or more buffers (e.g., with beta-NAD, Triton X-100), and one or more polymerizing agents (e.g., DNA polymerase, RNA polymerase). Extension can be conducted under isothermal conditions or under non-isothermal conditions (e.g., thermocycled conditions), in certain embodiments. One or more nucleic acid species can be extended in an extension reaction, and one or more molecules of each nucleic acid species can be extended. A nucleic acid can be extended by one or more nucleotides, and in some embodiments, the extension product is about 10 nucleotides to about 10,000 nucleotides in length, about 10 to about 1000 nucleotides in length, about 10 to about 500 nucleotides in length, 10 to about 100 nucleotides in length, and sometimes about 10, 11, 12, 13, 14, 15, 16, 17, 18, 19, 20, 25, 30, 35, 40, 45, 50, 55, 60, 65, 70, 75, 80, 80, 85, 90, 95, 100, 125, 150, 175, 200, 225, 250, 275, 300, 325, 350, 375, 400, 425, 450, 475, 500, 600, 700, 800, 900 or 1000 nucleotides in length. Incorporation of a terminating nucleotide (e.g., ddNTP), the hybridization location, or other factors, can determine the length to which the oligonucleotide is extended. In certain embodiments, amplification and extension processes are carried out in the same detection procedure.

Any suitable extension reaction can be selected and utilized. An extension reaction can be utilized, for example, to discriminate SNP alleles by the incorporation of deoxynucleotides and/or dideoxynucleotides to an extension oligonucleotide that hybridizes to a region adjacent to the SNP site in a target nucleic acid. The primer often is extended with a polymerase. In some embodiments, the oligonucleotide is extended by only one deoxynucleotide or dideoxynucleotide complementary to the SNP site. In some embodiments, an oligonucleotide may be extended by dNTP incorporation and terminated by a ddNTP, or terminated by ddNTP incorporation without dNTP extension in certain embodiments. One or more dNTP and/or ddNTP used during the extension reaction are labeled with a moiety allowing immobilization to a solid support, such as biotin, in some embodiments. Extension may be carried out using unmodified extension oligonucleotides and unmodified dideoxynucleotides, unmodified extension oligonucleotides and biotinylated dideoxynucleotides, extension oligonucleotides containing a deoxyinosine and unmodified dideoxynucleotides, extension oligonucleotides containing a deoxyinosine and biotinylated dideoxynucleotides, extension by biotinylated dideoxynucleotides, or extension by biotinylated deoxynucleotide and/or unmodified dideoxynucleotides, in some embodiments

Any suitable type of nucleotides can be incorporated into an amplification product or an extension product. Nucleotides may be naturally occurring nucleotides, terminating nucleotides, or non-naturally occurring nucleotides (e.g., nucleotide analog or derivative), in some embodiments. Certain nucleotides can comprise a detectable label and/or a member of a binding pair (e.g., the other member of the binding pair may be linked to a solid phase), in some embodiments.

A solution containing amplicons produced by an amplification process, or a solution containing extension products produced by an extension process, can be subjected to further processing. For example, a solution can be contacted with an agent that removes phosphate moieties from free nucleotides that have not been incorporated into an amplicon or extension product. An example of such an agent is a phosphatase (e.g., alkaline phosphatase). Amplicons and extension products also may be associated with a solid phase, may be washed, may be contacted with an agent that removes a terminal phosphate (e.g., exposure to a phosphatase), may be contacted with an agent that removes a terminal nucleotide (e.g., exonuclease), may be contacted with an agent that cleaves (e.g., endonuclease, ribonuclease), and the like.

The term “oligonucleotide” as used herein refers to two or more nucleotides or nucleotide analogs linked by a covalent bond. An oligonucleotide is of any convenient length, and in some embodiments is about 5 to about 200 nucleotides in length, about 5 to about 150 nucleotides in length, about 5 to about 100 nucleotides in length, about 5 to about 75 nucleotides in length or about 5 to about 50 nucleotides in length, and sometimes is about 5, 6, 7, 8, 9, 10, 11, 12, 13, 14, 15, 16, 17, 18, 19, 20, 25, 30, 35, 40, 45, 50, 55, 60, 65, 70, 75, 80, 80, 85, 90, 95, 100, 125, 150, 175, or 200 nucleotides in length. Oligonucleotides may include deoxyribonucleic acid (DNA), ribonucleic acid (RNA), naturally occurring and/or non-naturally occurring nucleotides or combinations thereof and any chemical or enzymatic modification thereof (e.g. methylated DNA, DNA of modified nucleotides). The length of an oligonucleotide sometimes is shorter than the length of an amplicon or target nucleic acid, but not necessarily shorter than a primer or polynucleotide used for amplification. An oligonucleotide often comprises a nucleotide subsequence or a hybridization sequence that is complementary, or substantially complementary, to an amplicon, target nucleic acid or complement thereof (e.g., about 95%, 96%, 97%, 98%, 99% or greater than 99% identical to the amplicon or target nucleic acid complement when aligned). An oligonucleotide may contain a nucleotide subsequence not complementary to, or not substantially complementary to, an amplicon, target nucleic acid or complement thereof (e.g., at the 3′ or 5′ end of the nucleotide subsequence in the primer complementary to or substantially complementary to the amplicon). An oligonucleotide in certain embodiments, may contain a detectable molecule (e.g., a tag, fluorophore, radioisotope, colormetric agent, particle, enzyme and the like) and/or a member of a binding pair, in certain embodiments.

The term “in solution” as used herein refers to a liquid, such as a liquid containing one or more nucleic acids, for example. Nucleic acids and other components in solution may be dispersed throughout, and a solution often comprises water (e.g., aqueous solution). A solution may contain any convenient number of oligonucleotide species, and there often are at least the same number of oligonucleotide species as there are amplicon species or target nucleic acid species to be detected.

The term “hybridization sequence” as used herein refers to a nucleotide sequence in an oligonucleotide capable of specifically hybridizing to an amplicon, target nucleic acid or complement thereof. The hybridization sequence is readily designed and selected and can be of a length suitable for hybridizing to an amplicon, target sequence or complement thereof in solution as described herein. In some embodiments, the hybridization sequence in each oligonucleotide is about 5 to about 200 nucleotides in length (e.g., about 5 to 10, about 10 to 15, about 15 to 20, about 20 to 25, about 25 to 30, about 30 to 35, about 35 to 40, about 40 to 45, or about 45 to 50, about 50 to 70, about 80 to 90, about 90 to 110, about 100 to 120, about 110 to 130, about 120 to 140, about 130 to 150, about 140 to 160, about 150 to 170, about 160 to 180, about 170 to 190, about 180 to 200 nucleotides in length).

The term “hybridization conditions” as used herein refers to conditions under which two nucleic acids having complementary nucleotide sequences can interact with one another. Hybridization conditions can be high stringency, medium stringency or low stringency, and conditions for these varying degrees of stringency are known. Hybridization conditions often are selected that allow for amplification and/or extension depending on the application of interest.

The term “specifically hybridizing to one amplicon or target nucleic acid” as used herein refers to hybridizing substantially to one amplicon species or target nucleic acid species and not substantially hybridizing to other amplicon species or target nucleic acid species in the solution. Specific hybridization rules out mismatches so that, for example, an oligonucleotide may be designed to hybridize specifically to a certain allele and only to that allele. An oligonucleotide that is homogenously matched or complementary to an allele will specifically hybridize to that allele, whereas if there is one or more base mismatches then no hybridization will occur.

The term “hybridization location” as used herein refers to a specific location on an amplicon or target nucleic acid to which another nucleic acid hybridizes. In certain embodiments, the terminus of an oligonucleotide is adjacent to or substantially adjacent to a site on an amplicon species or target nucleic acid species that has a different sequence than another amplicon species or target nucleic acid species. The terminus of an oligonucleotide is “adjacent” to a site when there are no nucleotides between the site and the oligonucleotide terminus. The terminus of an oligonucleotide is “substantially adjacent” to a site when there are 1, 2, 3, 4, 5, 6, 7, 8, 9 or 10 nucleotides between the site and the oligonucleotide terminus, in certain embodiments.

### Capture Agents and Solid Phases

One or more capture agents may be utilized for the methods described herein. There are several different types of capture agents available for processes described herein, including, without limitation, members of a binding pair, for example. Examples of binding pairs, include, without limitation, (a) non-covalent binding pairs (e.g., antibody/antigen, antibody/antibody, antibody/antibody fragment, antibody/antibody receptor, antibody/protein A or protein G, hapten/anti-hapten, biotin/avidin, biotin/streptavidin, folic acid/folate binding protein and vitamin B12/intrinsic factor; and (b) covalent attachment pairs (e.g., sulfhydryl/maleimide, sulfhydryl/haloacetyl derivative, amine/isotriocyanate, amine/succinimidyl ester, and amine/sulfonyl halides), and the like. In some embodiments, one member of a binding pair is in association with an extended oligonucleotide or amplification product and another member in association with a solid phase. The term “in association with” as used herein refers to an interaction between at least two units, where the two units are bound or linked to one another, for example.

The term “solid support” or “solid phase” as used herein refers to an insoluble material with which nucleic acid can be associated. Examples of solid supports for use with processes described herein include, without limitation, arrays, beads (e.g., paramagnetic beads, magnetic beads, microbeads, nanobeads) and particles (e.g., microparticles, nanoparticles). Particles or beads having a nominal, average or mean diameter of about 1 nanometer to about 500 micrometers can be utilized, such as those having a nominal, mean or average diameter, for example, of about 10 nanometers to about 100 micrometers; about 100 nanometers to about 100 micrometers; about 1 micrometer to about 100 micrometers; about 10 micrometers to about 50 micrometers; about 1, 5, 10, 15, 20, 25, 30, 35, 40, 45, 50, 55, 60, 65, 70, 75, 80, 85, 90, 95, 100, 200, 300, 400, 500, 600, 700, 800 or 900 nanometers; or about 1, 5, 10, 15, 20, 25, 30, 35, 40, 45, 50, 55, 60, 65, 70, 75, 80, 85, 90, 95, 100, 200, 300, 400, 500 micrometers.

A solid support can comprise virtually any insoluble or solid material, and often a solid support composition is selected that is insoluble in water. For example, a solid support can comprise or consist essentially of silica gel, glass (e.g. controlled-pore glass (CPG)), nylon, Sephadex®, Sepharose®, cellulose, a metal surface (e.g. steel, gold, silver, aluminum, silicon and copper), a magnetic material, a plastic material (e.g., polyethylene, polypropylene, polyamide, polyester, polyvinylidenedifluoride (PVDF)) and the like. Beads or particles may be swellable (e.g., polymeric beads such as Wang resin) or non-swellable (e.g., CPG). Commercially available examples of beads include without limitation Wang resin, Merrifield resin and Dynabeads® and SoluLink.

A solid support may be provided in a collection of solid supports. A solid support collection comprises two or more different solid support species. The term “solid support species” as used herein refers to a solid support in association with one particular solid phase nucleic acid species or a particular combination of different solid phase nucleic acid species. In certain embodiments, a solid support collection comprises 2 to 10,000 solid support species, 10 to 1,000 solid support species or about 2, 3, 4, 5, 6, 7, 8, 9, 10, 15, 20, 25, 30, 35, 40, 45, 50, 55, 60, 65, 70, 75, 80, 85, 90, 95, 100, 200, 300, 400, 500, 600, 700, 800, 900, 1000, 2000, 3000, 4000, 5000, 6000, 7000, 8000, 9000 or 10000 unique solid support species. The solid supports (e.g., beads) in the collection of solid supports may be homogeneous (e.g., all are Wang resin beads) or heterogeneous (e.g., some are Wang resin beads and some are magnetic beads). Each solid support species in a collection of solid supports sometimes is labelled with a specific identification tag. An identification tag for a particular solid support species sometimes is a nucleic acid (e.g., “solid phase nucleic acid”) having a unique sequence in certain embodiments. An identification tag can be any molecule that is detectable and distinguishable from identification tags on other solid support species.

Solid phase nucleic acid often is single-stranded and is of any type suitable for hybridizing nucleic acid (e.g., DNA, RNA, analogs thereof (e.g., peptide nucleic acid (PNA)), chimeras thereof (e.g., a single strand comprises RNA bases and DNA bases) and the like). Solid phase nucleic acid is associated with the solid support in any manner known by the person of ordinary skill and suitable for hybridization of solid phase nucleic acid to nucleic acid. Solid phase nucleic acid may be in association with a solid support by a covalent linkage or a non-covalent interaction. Non-limiting examples of non-covalent interactions include hydrophobic interactions (e.g., C18 coated solid support and tritylated nucleic acid), polar interactions, and the like. Solid phase nucleic acid may be associated with a solid support by different methodology known to the person of ordinary skill, which include without limitation (i) sequentially synthesizing nucleic acid directly on a solid support, and (ii) synthesizing nucleic acid, providing the nucleic acid in solution phase and linking the nucleic acid to a solid support. Solid phase nucleic acid may be linked covalently at various sites in the nucleic acid to the solid support, such as (i) at a 1′, 2′, 3′, 4′ or 5′ position of a sugar moiety or (ii) a pyrimidine or purine base moiety, of a terminal or non-terminal nucleotide of the nucleic acid, for example. The 5′ terminal nucleotide of the solid phase nucleic acid is linked to the solid support in certain embodiments.

After extended oligonucleotides are associated with a solid phase (i.e. post capture), unextended oligonucleotides and/or unwanted reaction components that do not bind often are washed away or degraded. Extended oligonucleotides may be treated by one or more procedures prior to detection. For example, extended oligonucleotides may be conditioned prior to detection (e.g., homogenizing the type of cation and/or anion associated with captured nucleic acid by ion exchange). Extended oligonucleotides may be released from a solid phase prior to detection in certain embodiments.

### Distinguishable Labels and Release

As used herein, the terms “distinguishable labels” and distinguishable tags” refer to types of labels or tags that can be distinguished from one another and used to identify the nucleic acid to which the tag is attached. A variety of types of labels and tags may be selected and used for multiplex methods provided herein. For example, oligonucleotides, amino acids, small organic molecules, light-emitting molecules, light-absorbing molecules, light-scattering molecules, luminescent molecules, isotopes, enzymes and the like may be used as distinguishable labels or tags. In certain embodiments, oligonucleotides, amino acids, and/or small molecule organic molecules of varying lengths, varying mass-to-charge ratios, varying electrophoretic mobility (e.g., capillary electrophoresis mobility) and/or varying mass also can be used as distinguishable labels or tags. Accordingly, a fluorophore, radioisotope, colormetric agent, light emitting agent, chemiluminescent agent, light scattering agent, and the like, may be used as a label. The choice of label may depend on the sensitivity required, ease of conjugation with a nucleic acid, stability requirements, and available instrumentation. The term “distinguishable feature,” as used herein with respect to distinguishable labels and tags, refers to any feature of one label or tag that can be distinguished from another label or tag (e.g., mass and others described herein).

For methods used herein, a particular target nucleic acid species, amplicon species and/or extended oligonucleotide species often is paired with a distinguishable detectable label species, such that the detection of a particular label or tag species directly identifies the presence of a particular target nucleic acid species, amplicon species and/or extended oligonucleotide species in a particular composition. Accordingly, one distinguishable feature of a label species can be used, for example, to identify one target nucleic acid species in a composition, as that particular distinguishable feature corresponds to the particular target nucleic acid. Labels and tags may be attached to a nucleic acid (e.g., oligonucleotide) by any known methods and in any location (e.g., at the 5′ of an oligonucleotide). Thus, reference to each particular label species as “specifically corresponding” to each particular target nucleic acid species, as used herein, refers to one label species being paired with one target species. When the presence of a label species is detected, then the presence of the target nucleic acid species associated with that label species thereby is detected, in certain embodiments.

The term “species,” as used herein with reference to a distinguishable tag or label (collectively, “label”), refers to one label that that is detectably distinguishable from another label. In certain embodiments, the number of label species, includes, but is not limited to, about 2 to about 10000 label species, about 2 to about 500,000 label species, about 2 to about 100,000, about 2 to about 50000, about 2 to about 10000, and about 2 to about 500 label species, or sometimes about 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 80, 85, 90, 95, 100, 125, 150, 175, 200, 225, 250, 275, 300, 325, 350, 375, 400, 425, 450, 475, 500, 600, 700, 800, 900, 1000, 2000, 3000, 4000, 5000, 6000, 7000, 8000, 9000, 10000, 20000, 30000, 40000, 50000, 60000, 70000, 80000, 90000,100000, 200000, 300000, 400000 or 500000 label species.

The term “mass distinguishable label” as used herein refers to a label that is distinguished by mass as a feature. A variety of mass distinguishable labels can be selected and used, such as for example a compomer, amino acid and/or a concatemer. Different lengths and/or compositions of nucleotide strings (e.g., nucleic acids; compomers), amino acid strings (e.g., peptides; polypeptides; compomers) and/or concatemers can be distinguished by mass and be used as labels. Any number of units can be utilized in a mass distinguishable label, and upper and lower limits of such units depends in part on the mass window and resolution of the system used to detect and distinguish such labels. Thus, the length and composition of mass distinguishable labels can be selected based in part on the mass window and resolution of the detector used to detect and distinguish the labels.

The term “compomer” as used herein refers to the composition of a set of monomeric units and not the particular sequence of the monomeric units. For a nucleic acid, the term “compomer” refers to the base composition of the nucleic acid with the monomeric units being bases. The number of each type of base can be denoted by Bₙ (i.e.: AₐC_{c}G_{g}Tₜ, with A₀C₀G₀T₀ representing an “empty” compomer or a compomer containing no bases). A natural compomer is a compomer for which all component monomeric units (e.g., bases for nucleic acids and amino acids for polypeptides) are greater than or equal to zero. In certain embodiments, at least one of a, c, g or t equals 1 or more (e.g., A₀C₀G₁T₀ A₁C₀G₁T₀, A₂C₁G₁T₂, A₃C₂G₁T₅). For purposes of comparing sequences to determine sequence variations, in the methods provided herein, “unnatural” compomers containing negative numbers of monomeric units can be generated by an algorithm utilized to process data. For polypeptides, a compomer refers to the amino acid composition of a polypeptide fragment, with the number of each type of amino acid similarly denoted. A compomer species can correspond to multiple sequences. For example, the compomer A₂G₃ corresponds to the sequences AGGAG, GGGAA, AAGGG, GGAGA and others. In general, there is a unique compomer corresponding to a sequence, but more than one sequence can correspond to the same compomer. In certain embodiments, one compomer species is paired with (e.g., corresponds to) one target nucleic acid species, amplicon species and/or oligonucleotide species. Different compomer species have different base compositions, and distinguishable masses, in embodiments herein (e.g., A₀C₀G₅T₀ and A₀C₅G₀T₀ are different and mass-distinguishable compomer species). In some embodiments, a set of compomer species differ by base composition and have the same length. In certain embodiments, a set of compomer species differ by base compositions and length.

A nucleotide compomer used as a mass distinguishable label can be of any length for which all compomer species can be detectably distinguished, for example about 1 to 15, 5 to 20, 1 to 30, 5 to 35, 10 to 30, 15 to 30, 20 to 35, 25 to 35, 30 to 40, 35 to 45, 40 to 50, or 25 to 50, or sometimes about 55, 60, 65, 70, 75, 80, 85, 90, 85 or 100, nucleotides in length. A peptide or polypeptide compomer used as a mass distinguishable label can be of any length for which all compomer species can be detectably distinguished, for example about 1 to 20, 10 to 30, 20 to 40, 30 to 50, 40 to 60, 50 to 70, 60 to 80, 70 to 90, or 80 to 100 amino acids in length. As noted above, the limit to the number of units in a compomer often is limited by the mass window and resolution of the detection method used to distinguish the compomer species.

The terms “concatemer” and “concatamer” are used herein synonymously (collectively “concatemer”), and refer to a molecule that contains two or more units linked to one another (e.g., often linked in series; sometimes branched in certain embodiments). A concatemer sometimes is a nucleic acid and/or an artificial polymer in some embodiments. A concatemer can include the same type of units (e.g., a homoconcatemer) in some embodiments, and sometimes a concatemer can contain different types of units (e.g., a heteroconcatemer). A concatemer can contain any type of unit(s), including nucleotide units, amino acid units, small organic molecule units (e.g., trityl), particular nucleotide sequence units, particular amino acid sequence units, and the like. A homoconcatemer of three particular sequence units ABC is ABCABCABC, in an embodiment. A concatemer can contain any number of units so long as each concatemer species can be detectably distinguished from other species. For example, a trityl concatemer species can contain about 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 80, 85, 90, 95, 100, 125, 150, 175, 200, 225, 250, 275, 300, 325, 350, 375, 400, 425, 450, 475, 500, 600, 700, 800, 900 or 1000 trityl units, in some embodiments.

A distinguishable label can be released from a nucleic acid product (e.g., an extended oligonucleotide) in certain embodiments. The linkage between the distinguishable label and a nucleic acid can be of any type that can be transcribed and cleaved, cleaved and allow for detection of the released label or labels (e.g., U.S. patent application publication no. US20050287533A1, entitled “Target-Specific Compomers and Methods of Use,” naming Ehrich et al.). Such linkages and methods for cleaving the linkages (“cleaving conditions”) are known. In certain embodiments, a label can be separated from other portions of a molecule to which it is attached. In some embodiments, a label (e.g., a compomer) is cleaved from a larger string of nucleotides (e.g., extended oligonucleotides). Non-limiting examples of linkages include linkages that can be cleaved by a nuclease (e.g., ribonuclease, endonuclease); linkages that can be cleaved by a chemical; linkages that can be cleaved by physical treatment; and photocleavable linkers that can be cleaved by light (e.g., o-nitrobenzyl, 6-nitroveratryloxycarbonyl, 2-nitrobenzyl group). Photocleavable linkers provide an advantage when using a detection system that emits light (e.g., matrix-assisted laser desorption ionization (MALDI) mass spectrometry involves the laser emission of light), as cleavage and detection are combined and occur in a single step.

In certain embodiments, a label can be part of a larger unit, and can be separated from that unit prior to detection. For example, in certain embodiments, a label is a set of contiguous nucleotides in a larger nucleotide sequence, and the label is cleaved from the larger nucleotide sequence. In such embodiments, the label often is located at one terminus of the nucleotide sequence or the nucleic acid in which it resides. In some embodiments, the label, or a precursor thereof, resides in a transcription cassette that includes a promoter sequence operatively linked with the precursor sequence that encodes the label. In the latter embodiments, the promoter sometimes is a RNA polymerase-recruiting promoter that generates an RNA that includes or consists of the label. An RNA that includes a label can be cleaved to release the label prior to detection (e.g., with an RNase).

### Detection and Degree of Multiplexing

The term “detection” of a label as used herein refers to identification of a label species. Any suitable detection device can be used to distinguish label species in a sample. Detection devices suitable for detecting mass distinguishable labels, include, without limitation, certain mass spectrometers and gel electrophoresis devices. Examples of mass spectrometry formats include, without limitation, Matrix-Assisted Laser Desorption/lonization Time-of-Flight (MALDI-TOF) Mass Spectrometry (MS), MALDI orthogonal TOF MS (OTOF MS; two dimensional), Laser Desorption Mass Spectrometry (LDMS), Electrospray (ES) MS, Ion Cyclotron Resonance (ICR) MS, and Fourier Transform MS. Methods described herein are readily applicable to mass spectrometry formats in which analyte is volatized and ionized (“ionization MS,” e.g., MALDI-TOF MS, LDMS, ESMS, linear TOF, OTOF). Orthogonal ion extraction MALDI-TOF and axial MALDI-TOF can give rise to relatively high resolution, and thereby, relatively high levels of multiplexing. Detection devices suitable for detecting light-emitting, light absorbing and/or light-scattering labels, include, without limitation, certain light detectors and photodetectors (e.g., for fluorescence, chemiluminescence, absorbtion, and/or light scattering labels).

Methods provided herein allow for high-throughput detection or discovery of target nucleic acid species in a plurality of target nucleic acids. Multiplexing refers to the simultaneous detection of more than one target nucleic acid species. General methods for performing multiplexed reactions in conjunction with mass spectrometry, are known (see, e.g., U.S. Pat. Nos. 6,043,031, 5,547,835 and International PCT application No. WO 97/37041). Multiplexing provides an advantage that a plurality of target nucleic acid species (e.g., some having different sequence variations) can be identified in as few as a single mass spectrum, as compared to having to perform a separate mass spectrometry analysis for each individual target nucleic acid species. Methods provided herein lend themselves to high-throughput, highly-automated processes for analyzing sequence variations with high speed and accuracy, in some embodiments. In some embodiments, methods herein may be multiplexed at high levels in a single reaction. Multiplexing is applicable when the genotype at a polymorphic locus is not known, and in some embodiments, the genotype at a locus is known.

In certain embodiments, the number of target nucleic acid species multiplexed include, without limitation, about 1-3, 3-5, 5-7, 7-9, 9-11, 11-13, 13-15, 15-17, 17-19, 19-21, 21-23, 23-25, 25-27, 27-29, 29-31, 31-33, 33-35, 35-37, 37-39, 39-41, 41-43, 43-45, 45-47, 47-49, 49-51, 51-53, 53-55, 55-57, 57-59, 59-61, 61-63, 63-65, 65-67, 67-69, 69-71, 71-73, 73-75, 75-77, 77-79, 79-81, 81-83, 83-85, 85-87, 87-89, 89-91, 91-93, 93-95, 95-97, 97-101, 101-103, 103-105, 105-107, 107-109, 109-111, 111-113, 113-115, 115-117, 117-119, 121-123, 123-125, 125-127, 127-129, 129-131, 131-133, 133-135, 135-137, 137-139, 139-141, 141-143, 143-145, 145-147, 147-149, 149-151, 151-153, 153-155, 155-157, 157-159, 159-161, 161-163, 163-165, 165-167, 167-169, 169-171, 171-173, 173-175, 175-177, 177-179, 179-181, 181-183, 183-185, 185-187, 187-189, 189-191, 191-193, 193-195, 195-197, 197-199, 199-201, 201-203, 203-205, 205-207, 207-209, 209-211, 211-213, 213-215, 215-217, 217-219, 219-221, 221-223, 223-225, 225-227, 227-229, 229-231, 231-233, 233-235, 235-237, 237-239, 239-241, 241-243, 243-245, 245-247, 247-249, 249-251, 251-253, 253-255, 255-257, 257-259, 259-261, 261-263, 263-265, 265-267, 267-269, 269-271, 271-273, 273-275, 275-277, 277-279, 279-281, 281-283, 283-285, 285-287, 287-289, 289-291, 291-293, 293-295, 295-297, 297-299, 299-301, 301-303, 303-305, 305-307, 307-309, 309-311, 311-313, 313-315, 315-317, 317-319, 319-321, 321-323, 323-325, 325-327, 327-329, 329-331, 331-333, 333-335, 335-337, 337-339, 339-341, 341-343, 343-345, 345-347, 347-349, 349-351, 351-353, 353-355, 355-357, 357-359, 359-361, 361-363, 363-365, 365-367, 367-369, 369-371, 371-373, 373-375, 375-377, 377-379, 379-381, 381-383, 383-385, 385-387, 387-389, 389-391, 391-393, 393-395, 395-397, 397-401, 401-403, 403-405, 405-407, 407-409, 409-411, 411-413, 413-415, 415-417, 417-419, 419-421, 421-423, 423-425, 425-427, 427-429, 429-431, 431-433, 433-435, 435-437, 437-439, 439-441, 441-443, 443-445, 445-447, 447-449, 449-451, 451-453, 453-455, 455-457, 457-459, 459-461, 461-463, 463-465, 465-467, 467-469, 469-471, 471-473, 473-475, 475-477, 477-479, 479-481, 481-483, 483-485, 485-487, 487-489, 489-491, 491-493, 493-495, 495-497, 497-501 or more.

Design methods for achieving resolved mass spectra with multiplexed assays can include primer and oligonucleotide design methods and reaction design methods. For primer and oligonucleotide design in multiplexed assays, the same general guidelines for primer design applies for uniplexed reactions, such as avoiding false priming and primer dimers, only more primers are involved for multiplex reactions. In addition, analyte peaks in the mass spectra for one assay are sufficiently resolved from a product of any assay with which that assay is multiplexed, including pausing peaks and any other by-product peaks. Also, analyte peaks optimally fall within a user-specified mass window, for example, within a range of 5,000-8,500 Da. Extension oligonucleotides can be designed with respect to target sequences of a given SNP strand, in some embodiments. In such embodiments, the length often is between limits that can be, for example, user-specified (e.g., 17 to 24 bases or 17-26 bases) and often do not contain bases that are uncertain in the target sequence. Hybridization strength sometimes is gauged by calculating the sequence-dependent melting (or hybridization/dissociation) temperature, Tₘ. A particular primer choice may be disallowed, or penalized relative to other choices of primers, because of its hairpin potential, false priming potential, primer-dimer potential, low complexity regions, and problematic subsequences such as GGGG. Methods and software for designing extension oligonucleotides (e.g., according to these criteria) are known, and include, for example, SpectroDESIGNER (Sequenom).

As used herein, the term “call rate” or “calling rate” refers to the number of calls (e.g., genotypes determined) obtained relative to the number of calls attempted to be obtained. In other words, for a 12-plex reaction, if 10 genotypes are ultimately determined from conducting methods provided herein, then 10 calls have been obtained with a call rate of 10/12. Different events can lead to failure of a particular attempted assay, and lead to a call rate lower than 100%. Occasionally, in the case of a mix of dNTPs and ddNTPs for termination, inappropriate extension products can occur by pausing of a polymerase after incorporation of one non-terminating nucleotide (i.e., dNTP), resulting in a prematurely terminated extension primer, for example. The mass difference between this falsely terminated and a correctly terminated primer mass extension reaction at the polymorphic site sometimes is too small to resolve consistently and can lead to miscalls if an inappropriate termination mix is used. The mass differences between a correct termination and a false termination (i.e., one caused by pausing) as well between a correct termination and salt adducts as well as a correct termination and an unspecific incorporation often is maximized to reduce the number of miscalls.

Multiplex assay accuracy may be determined by assessing the number of calls obtained (e.g., correctly or accurately assessed) and/or the number of false positive and/or false negative events in one or more assays. Accuracy also may be assessed by comparison with the accuracy of corresponding uniplex assays for each of the targets assessed in the multiplex assay. In certain embodiments, one or more methods may be used to determine a call rate. For example, a manual method may be utilized in conjunction with an automated or computer method for making calls, and in some embodiments, the rates for each method may be summed to calculate an overall call rate. In certain embodiments, accuracy or call rates, when multiplexing two or more target nucleic acids (e.g., fifty or more target nucleic acids), can be about 99% or greater, 98%, 97%, 96%, 95%, 94%, 93%, 92%, 91%, 90%, 89%, 87-88%, 85-86%, 83-84%, 81-82%, 80%, 78-79% or 76-77%, for example.

In certain embodiments the error rate may be determined based on the call rate or rate of accuracy. For example, the error rate may be the number of calls made in error. In some embodiments, for example, the error rate may be 100% less the call rate or rate of accuracy. The error rate may also be referred to as the “fail rate.” Identification of false positives and/or false negatives can readjust both the call and error rates. In certain embodiments running more assays can also help in identifying false positives and/or false negatives, thereby adjusting the call and/or error rates. In certain embodiments, error rates, when multiplexing two or more target nucleic acids (e.g., fifty or more target nucleic acids), can be about 1% or less, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24% or 25%, for example.

### Applications

Following are examples of non-limiting applications of multiplex technology described herein.

1. Microbial Identification

Provided herein is a process or method for identifying genera, species, strains, clones or subtypes of microorganisms and viruses. The microorganism(s) and viruses are selected from a variety of organisms including, but not limited to, bacteria, fungi, protozoa, ciliates, and viruses. The microorganisms are not limited to a particular genus, species, strain, subtype or serotype or any other classification. The microorganisms and viruses can be identified by determining sequence variations in a target microorganism sequence relative to one or more reference sequences or samples. The reference sequence(s) can be obtained from, for example, other microorganisms from the same or different genus, species strain or serotype or any other classification, or from a host prokaryotic or eukaryotic organism or any mixed population.

Identification and typing of pathogens (e.g., bacterial or viral) is critical in the clinical management of infectious diseases. Precise identity of a microbe is used not only to differentiate a disease state from a healthy state, but is also fundamental to determining the source of the infection and its spread and whether and which antibiotics or other antimicrobial therapies are most suitable for treatment. In addition treatment can be monitored. Traditional methods of pathogen typing have used a variety of phenotypic features, including growth characteristics, color, cell or colony morphology, antibiotic susceptibility, staining, smell, serotyping, biochemical typing and reactivity with specific antibodies to identify microbes (e.g., bacteria). All of these methods require culture of the suspected pathogen, which suffers from a number of serious shortcomings, including high material and labor costs, danger of worker exposure, false positives due to mishandling and false negatives due to low numbers of viable cells or due to the fastidious culture requirements of many pathogens. In addition, culture methods require a relatively long time to achieve diagnosis, and because of the potentially life-threatening nature of such infections, antimicrobial therapy is often started before the results can be obtained. Some organisms cannot be maintained in culture or exhibit prohibitively slow growth rates (e.g., up to 6-8 weeks for Mycobacterium tuberculosis).

In many cases, the pathogens are present in minor amounts and/or are very similar to the organisms that make up the normal flora, and can be indistinguishable from the innocuous strains by the methods cited above. In these cases, determination of the presence of the pathogenic strain can require the higher resolution afforded by the molecular typing methods provided herein.

2. Detection of Sequence variations

Provided are improved methods for identifying the genomic basis of disease and markers thereof. The sequence variation candidates that can be identified by the methods provided herein include sequences containing sequence variations that are polymorphisms. Polymorphisms include both naturally occurring, somatic sequence variations and those arising from mutation. Polymorphisms include but are not limited to: sequence microvariants where one or more nucleotides in a localized region vary from individual to individual, insertions and deletions which can vary in size from one nucleotides to millions of bases, and microsatellite or nucleotide repeats which vary by numbers of repeats. Nucleotide repeats include homogeneous repeats such as dinucleotide, trinucleotide, tetranucleotide or larger repeats, where the same sequence in repeated multiple times, and also heteronucleotide repeats where sequence motifs are found to repeat. For a given locus the number of nucleotide repeats can vary depending on the individual.

A polymorphic marker or site is the locus at which divergence occurs. Such a site can be as small as one base pair (an SNP). Polymorphic markers include, but are not limited to, restriction fragment length polymorphisms (RFLPs), variable number of tandem repeats (VNTR's), hypervariable regions, minisatellites, dinucleotide repeats, trinucleotide repeats, tetranucleotide repeats and other repeating patterns, simple sequence repeats and insertional elements, such as Alu. Polymorphic forms also are manifested as different Mendelian alleles for a gene.

Polymorphisms can be observed by differences in proteins, protein modifications, RNA expression modification, DNA and RNA methylation, regulatory factors that alter gene expression and DNA replication, and any other manifestation of alterations in genomic nucleic acid or organelle nucleic acids.

Furthermore, numerous genes have polymorphic regions. Since individuals have any one of several allelic variants of a polymorphic region, individuals can be identified based on the type of allelic variants of polymorphic regions of genes. This can be used, for example, for forensic purposes. In other situations, it is crucial to know the identity of allelic variants that an individual has. For example, allelic differences in certain genes, for example, major histocompatibility complex (MHC) genes, are involved in graft rejection or graft versus host disease in bone marrow transportation. Accordingly, it is highly desirable to develop rapid, sensitive, and accurate methods for determining the identity of allelic variants of polymorphic regions of genes or genetic lesions. A method or a kit as provided herein can be used to genotype a subject by determining the identity of one or more allelic variants of one or more polymorphic regions in one or more genes or chromosomes of the subject. Genotyping a subject using a method as provided herein can be used for forensic or identity testing purposes and the polymorphic regions can be present in mitochondrial genes or can be short tandem repeats.

Single nucleotide polymorphisms (SNPs) are generally biallelic systems, that is, there are two alleles that an individual can have for any particular marker. This means that the information content per SNP marker is relatively low when compared to microsatellite markers, which can have upwards of 10 alleles. SNPs also tend to be very population-specific; a marker that is polymorphic in one population can not be very polymorphic in another. SNPs, found approximately every kilobase (see Wang et al. (1998) Science 280:1077-1082), offer the potential for generating very high density genetic maps, which will be extremely useful for developing haplotyping systems for genes or regions of interest, and because of the nature of SNPS, they can in fact be the polymorphisms associated with the disease phenotypes under study. The low mutation rate of SNPs also makes them excellent markers for studying complex genetic traits.

Much of the focus of genomics has been on the identification of SNPs, which are important for a variety of reasons. They allow indirect testing (association of haplotypes) and direct testing (functional variants). They are the most abundant and stable genetic markers. Common diseases are best explained by common genetic alterations, and the natural variation in the human population aids in understanding disease, therapy and environmental interactions.

3. Detecting the Presence of Viral or Bacterial Nucleic Acid Sequences Indicative of an Infection

The methods provided herein can be used to determine the presence of viral or bacterial nucleic acid sequences indicative of an infection by identifying sequence variations that are present in the viral or bacterial nucleic acid sequences relative to one or more reference sequences. The reference sequence(s) can include, but are not limited to, sequences obtained from an infectious organism, related non-infectious organisms, or sequences from host organisms.

Viruses, bacteria, fungi and other infectious organisms contain distinct nucleic acid sequences, including sequence variants, which are different from the sequences contained in the host cell. A target DNA sequence can be part of a foreign genetic sequence such as the genome of an invading microorganism, including, for example, bacteria and their phages, viruses, fungi, protozoa, and the like. The processes provided herein are particularly applicable for distinguishing between different variants or strains of a microorganism (e.g., pathogenic, less pathogenic, resistant versus non-resistant and the like) in order, for example, to choose an appropriate therapeutic intervention. Examples of disease-causing viruses that infect humans and animals and that can be detected by a disclosed process include but are not limited to Retroviridae (e.g., human immunodeficiency viruses such as HIV-1 (also referred to as HTLV-III, LAV or HTLV-III/LAV; Ratner et al., Nature, 313:227-284 (1985); Wain Hobson et al., Cell, 40:9-17 (1985), HIV-2 (Guyader et al., Nature, 328:662-669 (1987); European Patent Publication No. 0 269 520; Chakrabarti et al., Nature, 328:543-547 (1987); European Patent Application No. 0 655 501), and other isolates such as HIV-LP (International Publication No. WO 94/00562); Picornaviridae (e.g., polioviruses, hepatitis A virus, (Gust et al., Intervirology, 20:1-7 (1983)); enteroviruses, human coxsackie viruses, rhinoviruses, echoviruses); Calcivirdae (e.g. strains that cause gastroenteritis); Togaviridae (e.g., equine encephalitis viruses, rubella viruses); Flaviridae (e.g., dengue viruses, encephalitis viruses, yellow fever viruses); Coronaviridae (e.g., coronaviruses); Rhabdoviridae (e.g., vesicular stomatitis viruses, rabies viruses); Filoviridae (e.g., ebola viruses); Paramyxoviridae (e.g., parainfluenza viruses, mumps virus, measles virus, respiratory syncytial virus); Orthomyxoviridae (e.g., influenza viruses); Bungaviridae (e.g., Hantaan viruses, bunga viruses, phleboviruses and Nairo viruses); Arenaviridae (hemorrhagic fever viruses); Reoviridae (e.g., reoviruses, orbiviruses and rotaviruses); Birnaviridae; Hepadnaviridae (Hepatitis B virus); Parvoviridae (parvoviruses); Parvoviridae (most adenoviruses); Papovaviridae (papilloma viruses, polyoma viruses); Adenoviridae (most adenoviruses); Herpesviridae (herpes simplex virus type 1 (HSV-1) and HSV-2, varicella zoster virus, cytomegalovirus, herpes viruses; Poxviridae (variola viruses, vaccinia viruses, pox viruses); Iridoviridae (e.g., African swine fever virus); and unclassified viruses (e.g., the etiological agents of Spongiform encephalopathies, the agent of delta hepatitis (thought to be a defective satellite of hepatitis B virus), the agents of non-A, non-B hepatitis (class 1=internally transmitted; class 2=parenterally transmitted, i.e., Hepatitis C); Norwalk and related viruses, and astroviruses.

Examples of infectious bacteria include but are not limited to Helicobacter pyloris, Borelia burgdorferi, Legionella pneumophilia, Mycobacteria sp. (e.g. M. tuberculosis, M. avium, M. intracellulare, M. kansaii, M. gordonae), Salmonella, Staphylococcus aureus, Neisseria gonorrheae, Neisseria meningitidis, Listeria monocytogenes, Streptococcus pyogenes (Group A Streptococcus), Streptococcus agalactiae (Group B Streptococcus), Streptococcus sp. (viridans group), Streptococcus faecalis, Streptococcus bovis, Streptococcus sp. (anaerobic species), Streptococcus pneumoniae, pathogenic Campylobacter sp., Enterococcus sp., Haemophilus influenzae, Bacillus anthracis, Corynebacterium diphtheriae, Corynebacterium sp., Erysipelothrix rhusiopathiae, Clostridium perfringens, Clostridium tetani, Escherichia coli, Enterobacter aerogenes, Klebsiella pneumoniae, Pasturella multocida, Bacteroides sp., Fusobacterium nucleatum, Streptobacillus moniliformis, Treponema pallidium, Treponema pertenue, Leptospira, and Actinomyces israelli and any variants including antibiotic resistance variants

Examples of infectious fungi include but are not limited to Cryptococcus neoformans, Histoplasma capsulatum, Coccidioides immitis, Blastomyces dermatitidis, Chlamydia trachomatis, Candida albicans. Other infectious organisms include protists such as Plasmodium falciparum and Toxoplasma gondii.

4. Antibiotic Profiling

Methods provided herein can improve the speed and accuracy of detection of nucleotide changes involved in drug resistance, including antibiotic resistance. Genetic loci involved in resistance to isoniazid, rifampin, streptomycin, fluoroquinolones, and ethionamide have been identified [Heym et al., Lancet 344:293 (1994) and Morris et al., J. Infect. Dis. 171:954 (1995)]. A combination of isoniazid (inh) and rifampin (rif) along with pyrazinamide and ethambutol or streptomycin, is routinely used as the first line of attack against confirmed cases of M. tuberculosis [Banerjee et al., Science 263:227 (1994)]. The increasing incidence of such resistant strains necessitates the development of rapid assays to detect them and thereby reduce the expense and community health hazards of pursuing ineffective, and possibly detrimental, treatments. The identification of some of the genetic loci involved in drug resistance has facilitated the adoption of mutation detection technologies for rapid screening of nucleotide changes that result in drug resistance. In addition, the technology facilitates treatment monitoring and tracking or microbial population structures as well as surveillance monitoring during treatment. In addition, correlations and surveillance monitoring of mixed populations can be performed.

5. Identifying Disease Markers

Provided herein are methods for the rapid and accurate identification of sequence variations that are genetic markers of disease, which can be used to diagnose or determine the prognosis of a disease. Diseases characterized by genetic markers can include, but are not limited to, atherosclerosis, obesity, diabetes, autoimmune disorders, and cancer. Diseases in all organisms have a genetic component, whether inherited or resulting from the body's response to environmental stresses, such as viruses and toxins. The ultimate goal of ongoing genomic research is to use this information to develop new ways to identify, treat and potentially cure these diseases. The first step has been to screen disease tissue and identify genomic changes at the level of individual samples. The identification of these “disease” markers is dependent on the ability to detect changes in genomic markers in order to identify errant genes or sequence variants. Genomic markers (all genetic loci including single nucleotide polymorphisms (SNPs), microsatellites and other noncoding genomic regions, tandem repeats, introns and exons) can be used for the identification of all organisms, including humans. These markers provide a way to not only identify populations but also allow stratification of populations according to their response to disease, drug treatment, resistance to environmental agents, and other factors.

6. Haplotyping

The methods provided herein can be used to detect haplotypes. In any diploid cell, there are two haplotypes at any gene or other chromosomal segment that contain at least one distinguishing variance. In many well-studied genetic systems, haplotypes are more powerfully correlated with phenotypes than single nucleotide variations. Thus, the determination of haplotypes is valuable for understanding the genetic basis of a variety of phenotypes including disease predisposition or susceptibility, response to therapeutic interventions, and other phenotypes of interest in medicine, animal husbandry, and agriculture.

Haplotyping procedures as provided herein permit the selection of a portion of sequence from one of an individual's two homologous chromosomes and to genotype linked SNPs on that portion of sequence. The direct resolution of haplotypes can yield increased information content, improving the diagnosis of any linked disease genes or identifying linkages associated with those diseases.

7. Microsatellites

Methods provided herein allow for rapid, unambiguous detection of microsatellite sequence variations. Microsatellites (sometimes referred to as variable number of tandem repeats or VNTRs) are short tandemly repeated nucleotide units of one to seven or more bases, the most prominent among them being di-, tri-, and tetranucleotide repeats. Microsatellites are present every 100,000 by in genomic DNA (J. L. Weber and P. E. Can, Am. J. Hum. Genet. 44, 388 (1989); J. Weissenbach et al., Nature 359, 794 (1992)). CA dinucleotide repeats, for example, make up about 0.5% of the human extra-mitochondrial genome; CT and AG repeats together make up about 0.2%. CG repeats are rare, most probably due to the regulatory function of CpG islands. Microsatellites are highly polymorphic with respect to length and widely distributed over the whole genome with a main abundance in non-coding sequences, and their function within the genome is unknown. Microsatellites can be important in forensic applications, as a population will maintain a variety of microsatellites characteristic for that population and distinct from other populations which do not interbreed.

Many changes within microsatellites can be silent, but some can lead to significant alterations in gene products or expression levels. For example, trinucleotide repeats found in the coding regions of genes are affected in some tumors (C. T. Caskey et al., Science 256, 784 (1992) and alteration of the microsatellites can result in a genetic instability that results in a predisposition to cancer (P. J. McKinnen, Hum. Genet. 1 75, 197 (1987); J. German et al., Clin. Genet. 35, 57 (1989)).

8. Short Tandem Repeats

The methods provided herein can be used to identify short tandem repeat (STR) regions in some target sequences of the human genome relative to, for example, reference sequences in the human genome that do not contain STR regions. STR regions are polymorphic regions that are not related to any disease or condition. Many loci in the human genome contain a polymorphic short tandem repeat (STR) region. STR loci contain short, repetitive sequence elements of 3 to 7 base pairs in length. It is estimated that there are 200,000 expected trimeric and tetrameric STRs, which are present as frequently as once every 15 kb in the human genome (see, e.g., International PCT application No. WO 9213969 A1, Edwards et al., Nucl. Acids Res. 19:4791 (1991); Beckmann et al. (1992) Genomics 12:627-631). Nearly half of these STR loci are polymorphic, providing a rich source of genetic markers. Variation in the number of repeat units at a particular locus is responsible for the observed sequence variations reminiscent of variable nucleotide tandem repeat (VNTR) loci (Nakamura et al. (1987) Science 235:1616-1622); and minisatellite loci (Jeffreys et al. (1985) Nature 314:67-73), which contain longer repeat units, and microsatellite or dinucleotide repeat loci (Luty et al. (1991) Nucleic Acids Res. 19:4308; Litt et al. (1990) Nucleic Acids Res. 18:4301; Litt et al. (1990) Nucleic Acids Res. 18:5921; Luty et al. (1990) Am. J. Hum. Genet. 46:776-783; Tautz (1989) Nucl. Acids Res. 17:6463-6471; Weber et al. (1989) Am. J. Hum. Genet. 44:388-396; Beckmann et al. (1992) Genomics 12:627-631). VNTR typing is a very established tool in microbial typing e.g. M. tuberculosis (MIRU typing).

Examples of STR loci include, but are not limited to, pentanucleotide repeats in the human CD4 locus (Edwards et al., Nucl. Acids Res. 19:4791 (1991)); tetranucleotide repeats in the human aromatase cytochrome P-450 gene (CYP19; Polymeropoulos et al., Nucl. Acids Res. 19:195 (1991)); tetranucleotide repeats in the human coagulation factor XIII A subunit gene (F13A1;

Polymeropoulos et al., Nucl. Acids Res. 19:4306 (1991)); tetranucleotide repeats in the F13B locus (Nishimura et al., Nucl. Acids Res. 20:1167 (1992)); tetranucleotide repeats in the human c-les/fps, proto-oncogene (FES; Polymeropoulos et al., Nucl. Acids Res. 19:4018 (1991)); tetranucleotide repeats in the LFL gene (Zuliani et al., Nucl. Acids Res. 18:4958 (1990)); trinucleotide repeat sequence variations at the human pancreatic phospholipase A-2 gene (PLA2; Polymeropoulos et al., Nucl. Acids Res. 18:7468 (1990)); tetranucleotide repeat sequence variations in the VWF gene (Ploos et al., Nucl. Acids Res. 18:4957 (1990)); and tetranucleotide repeats in the human thyroid peroxidase (hTPO) locus (Anker et al., Hum. Mol. Genet. 1:137 (1992)).

9. Organism Identification

Polymorphic STR loci and other polymorphic regions of genes are sequence variations that are extremely useful markers for human identification, paternity and maternity testing, genetic mapping, immigration and inheritance disputes, zygosity testing in twins, tests for inbreeding in humans, quality control of human cultured cells, identification of human remains, and testing of semen samples, blood stains, microbes and other material in forensic medicine. Such loci also are useful markers in commercial animal breeding and pedigree analysis and in commercial plant breeding. Traits of economic importance in plant crops and animals can be identified through linkage analysis using polymorphic DNA markers. Efficient and accurate methods for determining the identity of such loci are provided herein.

10. Detecting Allelic Variation

The methods provided herein allow for high-throughput, fast and accurate detection of allelic variants. Studies of allelic variation involve not only detection of a specific sequence in a complex background, but also the discrimination between sequences with few, or single, nucleotide differences. One method for the detection of allele-specific variants by PCR is based upon the fact that it is difficult for Taq polymerase to synthesize a DNA strand when there is a mismatch between the template strand and the 3′ end of the primer. An allele-specific variant can be detected by the use of a primer that is perfectly matched with only one of the possible alleles; the mismatch to the other allele acts to prevent the extension of the primer, thereby preventing the amplification of that sequence. The methods herein also are applicable to association studies, copy number variations, detection of disease marker and SNP sets for typing and the like.

11. Determining Allelic Frequency

The methods herein described are valuable for identifying one or more genetic markers whose frequency changes within the population as a function of age, ethnic group, sex or some other criteria. For example, the age-dependent distribution of ApoE genotypes is known in the art (see, Schchter et al. (1994) Nature Genetics 6:29-32). The frequencies of sequence variations known to be associated at some level with disease can also be used to detect or monitor progression of a disease state. For example, the N291 S polymorphism (N291 S) of the Lipoprotein Lipase gene, which results in a substitution of a serine for an asparagine at amino acid codon 291, leads to reduced levels of high density lipoprotein cholesterol (HDL-C) that is associated with an increased risk of males for arteriosclerosis and in particular myocardial infarction (see, Reymer et al. (1995) Nature Genetics 10:28-34). In addition, determining changes in allelic frequency can allow the identification of previously unknown sequence variations and ultimately a gene or pathway involved in the onset and progression of disease.

12. Epigenetics

The methods provided herein can be used to study variations in a target nucleic acid or protein relative to a reference nucleic acid or protein that are not based on sequence, e.g., the identity of bases or amino acids that are the naturally occurring monomeric units of the nucleic acid or protein. For example, methods provided herein can be used to recognize differences in sequence-independent features such as methylation patterns, the presence of modified bases or amino acids, or differences in higher order structure between the target molecule and the reference molecule, to generate fragments that are cleaved at sequence-independent sites. Epigenetics is the study of the inheritance of information based on differences in gene expression rather than differences in gene sequence. Epigenetic changes refer to mitotically and/or meiotically heritable changes in gene function or changes in higher order nucleic acid structure that cannot be explained by changes in nucleic acid sequence. Examples of features that are subject to epigenetic variation or change include, but are not limited to, DNA methylation patterns in animals, histone modification and the Polycomb-trithorax group (Pc-G/tx) protein complexes (see, e.g., Bird, A., Genes Dev., 16:6-21 (2002)).

Epigenetic changes usually, although not necessarily, lead to changes in gene expression that are usually, although not necessarily, inheritable. For example, as discussed further below, changes in methylation patterns is an early event in cancer and other disease development and progression. In many cancers, certain genes are inappropriately switched off or switched on due to aberrant methylation. The ability of methylation patterns to repress or activate transcription can be inherited. The Pc-G/trx protein complexes, like methylation, can repress transcription in a heritable fashion. The Pc-G/trx multiprotein assembly is targeted to specific regions of the genome where it effectively freezes the embryonic gene expression status of a gene, whether the gene is active or inactive, and propagates that state stably through development. The ability of the Pc-G/trx group of proteins to target and bind to a genome affects only the level of expression of the genes contained in the genome, and not the properties of the gene products. The methods provided herein can be used with specific cleavage reagents or specific extension reactions that identify variations in a target sequence relative to a reference sequence that are based on sequence-independent changes, such as epigenetic changes.

13. Methylation Patterns

The methods provided herein can be used to detect sequence variations that are epigenetic changes in the target sequence, such as a change in methylation patterns in the target sequence. Analysis of cellular methylation is an emerging research discipline. The covalent addition of methyl groups to cytosine is primarily present at CpG dinucleotides (microsatellites). Although the function of CpG islands not located in promoter regions remains to be explored, CpG islands in promoter regions are of special interest because their methylation status regulates the transcription and expression of the associated gene. Methylation of promotor regions leads to silencing of gene expression. This silencing is permanent and continues through the process of mitosis. Due to its significant role in gene expression, DNA methylation has an impact on developmental processes, imprinting and X-chromosome inactivation as well as tumor genesis, aging, and also suppression of parasitic DNA. Methylation is thought to be involved in the cancerogenesis of many widespread tumors, such as lung, breast, and colon cancer, and in leukemia. There is also a relation between methylation and protein dysfunctions (long Q-T syndrome) or metabolic diseases (transient neonatal diabetes, type 2 diabetes).

Bisulfite treatment of genomic DNA can be utilized to analyze positions of methylated cytosine residues within the DNA. Treating nucleic acids with bisulfite deaminates cytosine residues to uracil residues, while methylated cytosine remains unmodified. Thus, by comparing the sequence of a target nucleic acid that is not treated with bisulfite with the sequence of the nucleic acid that is treated with bisulfite in the methods provided herein, the degree of methylation in a nucleic acid as well as the positions where cytosine is methylated can be deduced.

Methylation analysis via restriction endonuclease reaction is made possible by using restriction enzymes which have methylation-specific recognition sites, such as HpaII and MSPI. The basic principle is that certain enzymes are blocked by methylated cytosine in the recognition sequence. Once this differentiation is accomplished, subsequent analysis of the resulting fragments can be performed using the methods as provided herein.

These methods can be used together in combined bisulfite restriction analysis (COBRA). Treatment with bisulfite causes a loss in BstUl recognition site in amplified PCR product, which causes a new detectable fragment to appear on analysis compared to untreated sample. Methods provided herein can be used in conjunction with specific cleavage of methylation sites to provide rapid, reliable information on the methylation patterns in a target nucleic acid sequence.

14. Resequencing

The dramatically growing amount of available genomic sequence information from various organisms increases the need for technologies allowing large-scale comparative sequence analysis to correlate sequence information to function, phenotype, or identity. The application of such technologies for comparative sequence analysis can be widespread, including SNP discovery and sequence-specific identification of pathogens. Therefore, resequencing and high-throughput mutation screening technologies are critical to the identification of mutations underlying disease, as well as the genetic variability underlying differential drug response.

Several approaches have been developed in order to satisfy these needs. Current technology for high-throughput DNA sequencing includes DNA sequencers using electrophoresis and laser-induced fluorescence detection. Electrophoresis-based sequencing methods have inherent limitations for detecting heterozygotes and are compromised by GC compressions. Thus a DNA sequencing platform that produces digital data without using electrophoresis will overcome these problems. Matrix-assisted laser desorption/ionization time-of-flight mass spectrometry (MALDI-TOF MS) measures nucleic acid fragments with digital data output. Methods provided herein allow for high-throughput, high speed and high accuracy in the detection of sequence identity and sequence variations relative to a reference sequence. This approach makes it possible to routinely use MALDI-TOF MS sequencing for accurate mutation detection, such as screening for founder mutations in BRCA1 and BRCA2, which are linked to the development of breast cancer.

15. Disease outbreak monitoring

In times of global transportation and travel outbreaks of pathogenic endemics require close monitoring to prevent their worldwide spread and enable control. DNA based typing by high-throughput technologies enable a rapid sample throughput in a comparatively short time, as required in an outbreak situation (e.g. monitoring in the hospital environment, early warning systems). Monitoring is dependent of the microbial marker region used, but can facilitate monitoring to the genus, species, strain or subtype specific level. Such approaches can be useful in biodefense, in clinical and pharmaceutical monitoring and metagenomics applications (e.g. analysis of gut flora). Such monitoring of treatment progress or failure is described in U.S. Pat. No. 7,255,992, U.S. Pat. No. 7,217,510, U.S. Pat. No. 7,226,739 and U.S. Pat. No. 7,108,974 which are incorporated by reference herein.

16. Vaccine Quality Control and Production Clone Quality Control

Methods provided herein can be used to control the identity of recombinant production clones (not limited to vaccines), which can be vaccines or e.g. insulin or any other production clone or biological or medical product.

17. Microbial Monitoring in Pharmacology for Production Control and Quality

Methods provided herein can be used to control the quality of pharmacological products by, for example, detecting the presence or absence of certain microorganism target nucleic acids in such products.

### EXAMPLES

The examples set forth below illustrate, and do not limit, the technology.

### Example 1

### Pre-PCR Reaction

The presented process provides an alternative biochemistry to the regular PCR, which usually has two gene specific primers amplifying the same target. The process is suited for the amplification of target regions e.g. containing a SNP.

Approach 1: This method uses only one primer to extend, see FIG. 1. The gene specific extend primer has a 5′ universal PCRTag1 R. It is extended on the genomic DNA. The DNA or the PCR Tag1R gene specific extend primer may be biotinylated, to facilitate clean up of the reaction. The extended strand is then ligated to a universal phosphorylated oligo, which has sequence which is reverse complement of Tag2F (universal PCR primer). To facilitate clean up in the next step, the phosphorylated oligo has exonuclease resistant nucleotides at its 3′ end. During the exonuclease treatment, all non-ligated extend strands are digested, whereas ligated products are protected and remain in the reaction. A universal PCR is then performed using Tag1R and the Tag2F primers, to amplify multiple targets. An overview of concept-1 is outlined in FIG. 1.

Approach 2: In this method, primer extension and ligation takes place in the same reaction. FIG. 2 shows the use of a biotinylated PCRTag3R gene specific primer as an extension primer. The phosphorylated oligo has a gene specific sequence and binds around 40 bases away from the primer extension site, to the same strand of DNA. Thus, Stoffel DNA polymerase extends the strand, until it reaches the phosphorylated oligo. Amp ligase (Epicentre) ligates the gene specific sequence of the phosphorylated oligo to the extended strand. The 3′ end of Phospho oligo has PCRTag4(RC)F as its universal tag. The biotinylated extended strands are then bound to streptavidin beads. This facilitates clean up of the reaction. Genomic DNA and the gene specific phosphorylated oligos will get washed away. A universal PCR is then performed using Tag3R and Tag4F as primers, to amplify different genes of interest. An overview of concept-2 is as shown in FIG. 2.

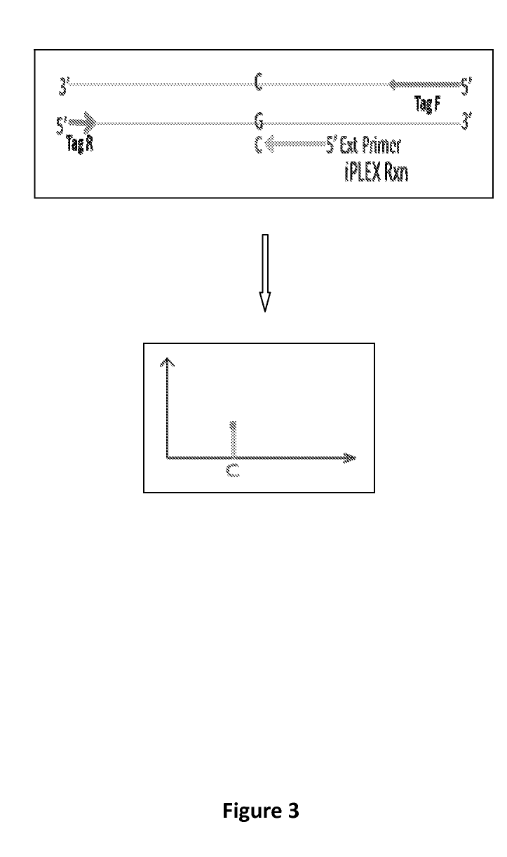

The universal PCR products from both the Approach 1 and 2 can be identified using the post-PCR reaction, as shown in FIG. 3. SAP was used to clean up the PCR reaction. Post-PCR reactions were performed using gene specific oligos binding just before the SNP and the single base extended products were spotted on a chip array and analyzed on mass spectrometry. Alternatively the methods provided herein can be used for post-PCR read-out.

### Example 2

### Pre-PCR Reaction Materials from Example 1

Approach 1:

1a) Extension: A 90 ul reaction was performed with 18 ng plasmid insert, 1×Qiagen PCR buffer with Mg, 2.82 mM of total MgCl₂, 10 mM Tris,pH 9.5, 50 uM dNTPs, 0.5 uM 5′ PCR tag1R gene specific extension primer, 5.76U Thermosequenase. The thermo cycling conditions used were 2 minutes at 94° C. followed by 45 cycles of 10 second denaturation at 94° C.; 10 seconds annealing at 56° C.; 20 seconds extension at 72° C.

1b) Ligation: 5 ul of extended product was ligated with 500 pmols of a phospho oligo (reverse complement of the Tag2F primer) which is exonuclease resistant at its 3′end.The extension product and phosphooligo were denatured at 65° C./10 minutes, cooled before volume made to 50 ul with 50 mM Tris-HCl, pH 7.8, 10 mM MgCl₂, 10 mM DTT, 1 mM ATP and 50 U T4 RNA Ligase1. Incubation was carried out at 37° C./4 hours, 65° C./20 minutes.

1c) Exonuclease treatment: 10 ul of the ligated product was denatured at 95° C./5minutes, cooled and diluted with 0.5×exonuclease III buffer containing 20U exonuclease I and 1000 exonuclease III in a total volume of 20 ul. The reaction was incubated at 37° C./4 hours, 80° C./20 minutes. 1d) Universal PCR: 2 ul of the exonuclease treated product was amplified with 0.4 uM each of M13 forward and reverse primers in a 25 ul reaction containing 1×Qiagen buffer containing 1.5 mM MgCl₂, 200 uM dNTP and 0.625U Hot star DNA polymerase. The thermo cycling conditions used were 15 minutes at 94° C., followed by 45 cycles of 30 second denaturation at 94° C.; 30 seconds annealing at 55° C. and one minute extension at 72° C.

The primers and PCR tag sequences used were:

(SEQ ID NO: 1)
Universal Tag 1R (rs10063237) =
5′ GGAAACAGCTATGACCATG-(GTAATTGTACTGTGAGTGGC) gene
specific sequence 3′
(SEQ ID NO: 2)
Universal Tag2 (RC) F =
5′P-CATGTCGTTTTACAACGTCG*T*G*ddC 3′
(The * represents exonuclease resistant linkages
between the nucleotides)
(SEQ ID NO: 3)
Tag1R (M13R) =
5′ GGAAACAGCTATGACCATG 3′
(SEQ ID NO: 4)
Tag2F (M13F) =
5′ CACGACGTTGTAAAACGAC 3′
(SEQ ID NO: 5)
rs10063237_E1 (for post-PCR reaction):
5′TCAAAGAATTATATGGCTAAGG 3′

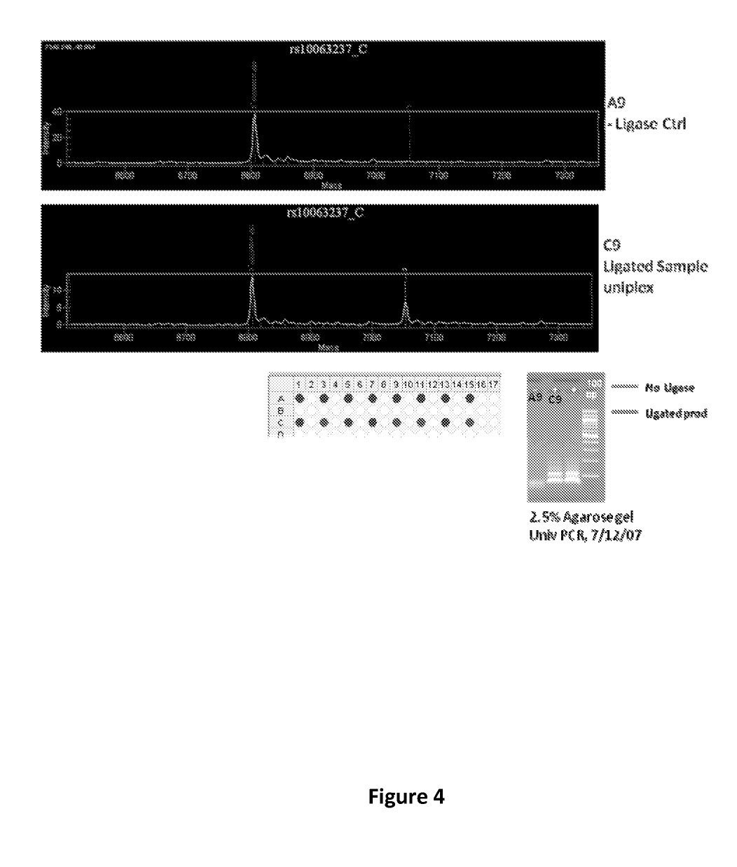

Results from Approach 1 can be seen in FIG. 4.

Approach 2:

2a) Extension and Ligation: The 20 ul reaction was carried out with 16-35 ng genomic DNA, 1×Amp ligase buffer(Epicentre), 200 uM dNTP, 10 nM biotinylated extension primer, 50 nM gene specific phospho oligo, 1U Stoffel fragment DNA polymerase and 4U Amp ligase (Epicentre). The thermo cycling conditions used: 5 minutes at 94° C. followed by 19 cycles of 30 second denaturation at 94° C.; 150 seconds annealing at 58.5° C., with a decrease in temperature by 0.2° C. at every cycle; 45 seconds extension at 72° C. The extension and ligation reaction was treated with 40 ug of proteinase K at 60° C. for 20 minutes.

2b) Bead Clean up: 15 ul of Dyna beads M-280 streptavidin beads were washed three times with 1×binding buffer (5 mM Tris-HCl pH 7.5, 1 M NaCl, 0.5 mM EDTA). During all washes, the beads were bound to the magnet and the supernatant then discarded. Two extension reactions were pooled and diluted to get a 1×binding buffer concentration and then mixed with the beads. The beads were incubated at room temperature for 20 minutes, with gentle agitation. The beads were then washed 3 times with 1×wash buffer (10 mM Tris, pH 81 mM EDTA) and 2 times with water. The beads were then treated with 0.1N NaOH at room temperature for 10 minutes. The beads were then washed 2 times with 1×wash buffer and 2 times with water. The beads were finally suspended in 15 ul water.

2c) Universal PCR: 2 ul beads were added to a 25 ul PCR reaction containing 1×PCR Gold buffer (Applied Biosystems), 250 uM dNTP, 2.5 mM MgCl₂, and 0.4 uM each of Tag4F and Tag3R primers, 1.25U AmpliTaq Gold DNA polymerase and 0.05% Tween 20. The thermo cycling conditions used were 12 minutes at 94° C. followed by 60 cycles of 30 second denaturation at 94° C.; 30 seconds annealing at 68° C.; 45 seconds extension at 72° C., with a final extension of 72° C. for 2 minutes.

The primers and Tag sequences used were:

(SEQ ID NO: 6)
Universal Tag 3R =
5′ GAGCTGCTGCACCATATTCCTGAAC-gene specific
sequence 3′,
(SEQ ID NO: 7)
Universal Tag4 (RC) F =
5′P-gene specific sequence-
GCTCTGAAGGCGGTGTATGACATGG 3′
(SEQ ID NO: 8)
Tag3R =
5′ GAGCTGCTGCACCATATTCCTGAAC 3′
(SEQ ID NO: 9)
Tag4F =
5′ CCATGTCATACACCGCCTTCAGAGC 3′

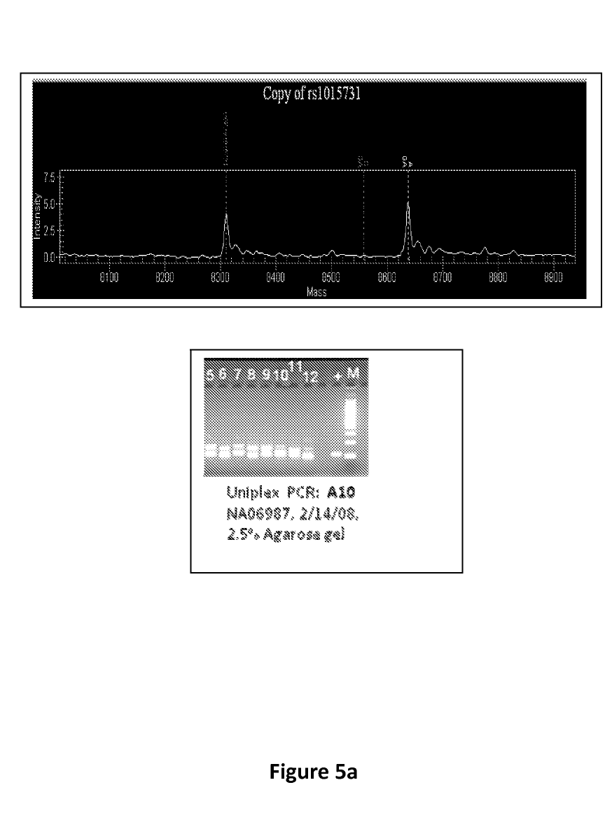

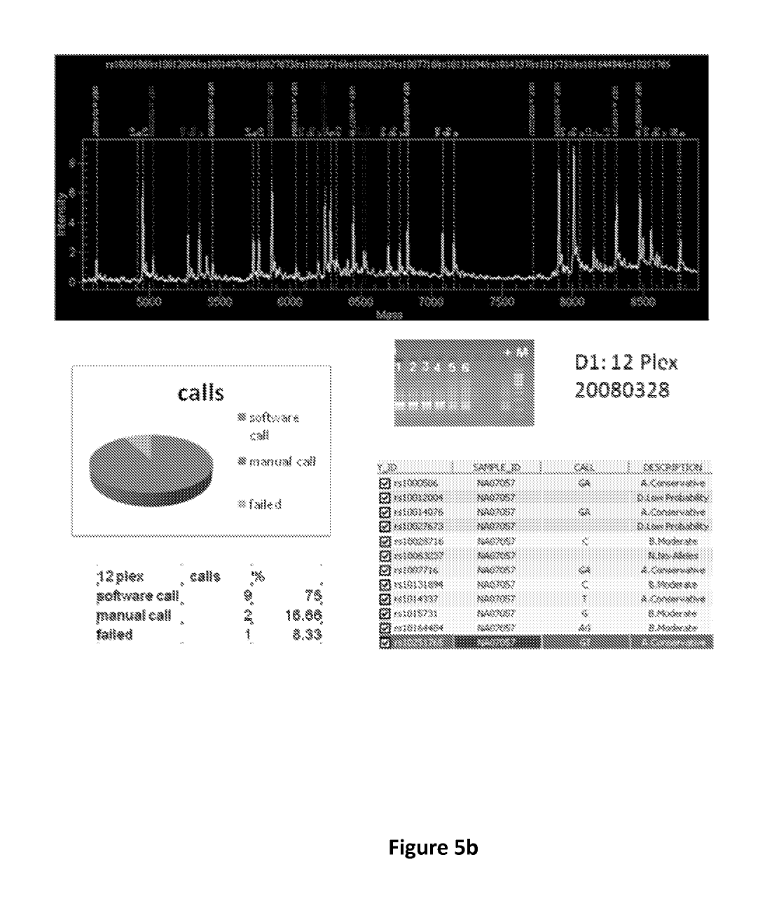

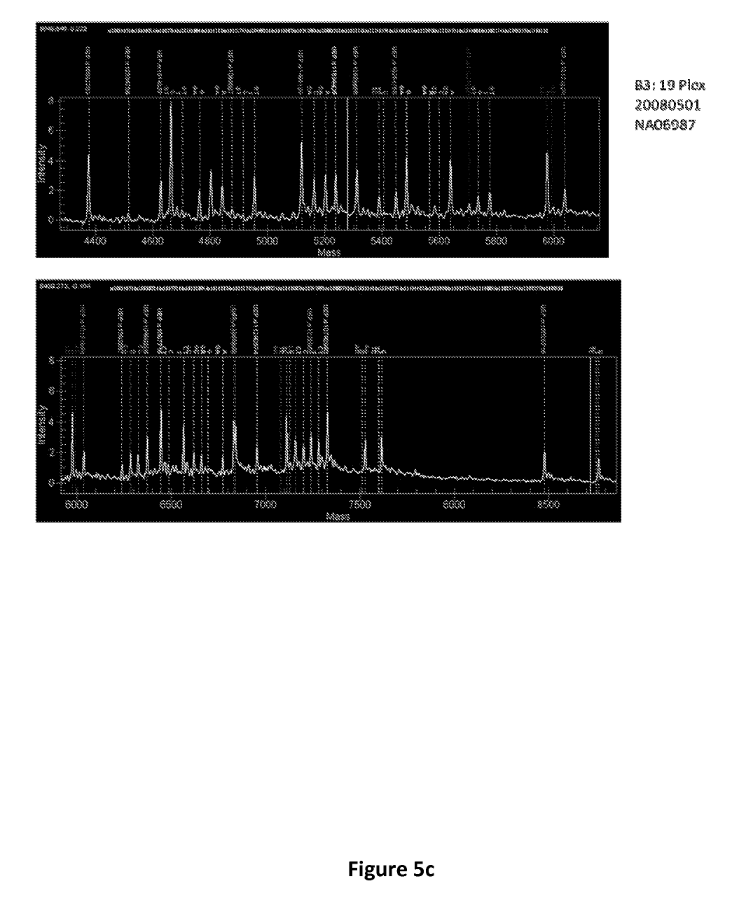

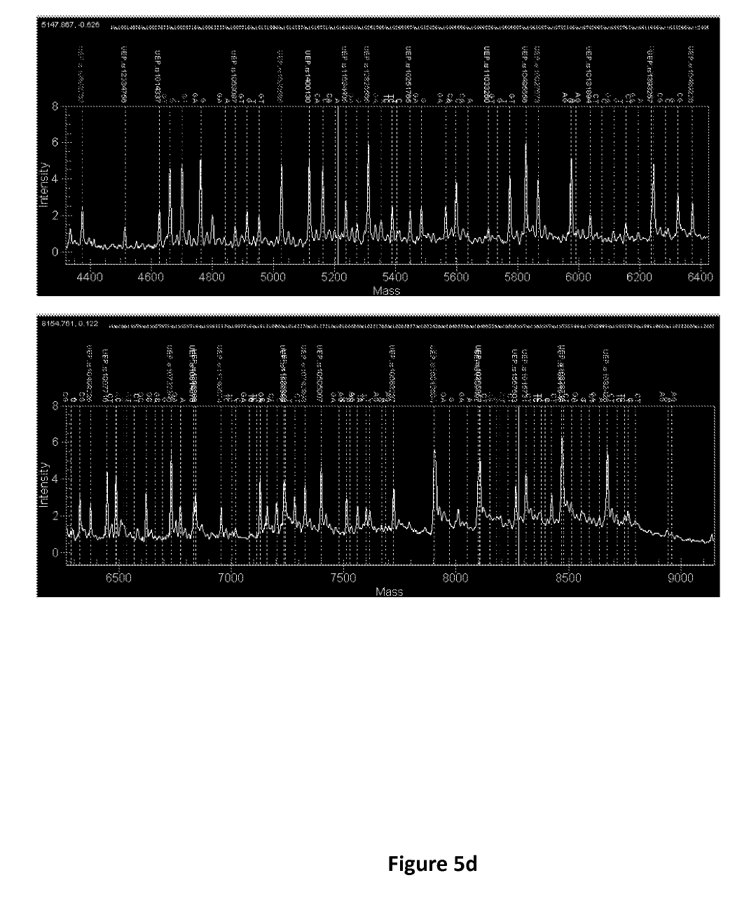

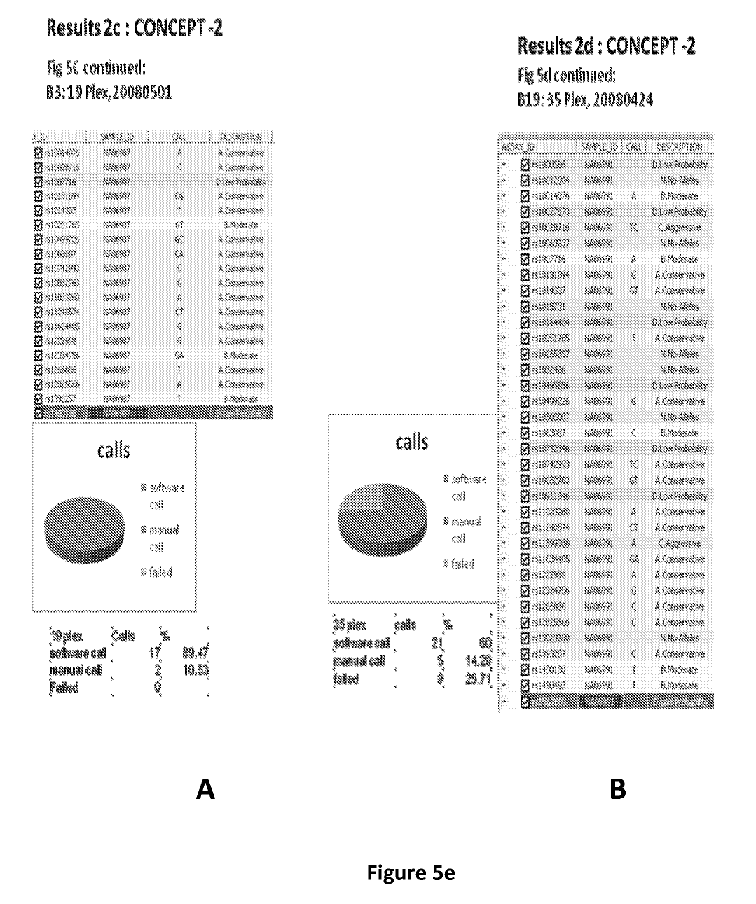

Approach 2 gene specific extend primers, phospho oligos and post-PCR reaction extension primers are listed in Tables 1, 2 and 3 respectively. For Table 1, the PCR tag region is underlined. In Approach 2, 5′-Biotinylated and PCR-tagged gene specific-primer is extended on genomic DNA by Stoffel DNA polymerase and simultaneously ligated to a downstream gene specific PCR-tagged phospho oligo bound on the same strand, by Amp Ligase (Epicentre). Results from Approach 2 are shown in FIGS. 5A-5.

TABLE 1
Extension primers used to extend genomic DNA in the extension ligation reaction (non-hybridizing
regions are underlined)

| | | SEQ |
|---|---|---|
| | | ID |
| Primer Name | 5′Biotin-primer seq | NO |
| 5′BiotinUF rs1000586 | 5′Biotin-GAGCTGCTGCACCATATTCCTGAACTCTCAAACTCCAGAGTGGCC | 10 |
| 5′BiotinUF rs10012004 | 5′Biotin-GAGCTGCTGCACCATATTCCTGAACAGCAGTGCTTCACACACTTTAG | 11 |
| 5′BiotinUF rs10014076 | 5′Biotin-GAGCTGCTGCACCATATTCCTGAACGTCCTGATTTCTCCTCCAGAG | 12 |
| 5′BiotinUF rs10027673 | 5′Biotin-GAGCTGCTGCACCATATTCCTGAACCCCTCTTGCATAAAATGTTGCAG | 13 |
| 5′BiotinUF rs10028716 | 5′Biotin-GAGCTGCTGCACCATATTCCTGAACCATGAAGAGAAATAGTTCTGAGGTTTCC | 14 |
| 5′BiotinNewUF | 5′Biotin-GAGCTGCTGCACCATATTCCTGAACCTGATAGTAATTGTACTGTGAGTGGC | 15 |
| rs10063237 | | |
| 5′BiotinUF rs1007716 | 5′Biotin-GAGCTGCTGCACCATATTCCTGAACCTAAAAACTTATAATTTTAATAGAGGGTGCATTGAAG | 16 |
| 5′BiotinUF rs10131894 | 5′Biotin-GAGCTGCTGCACCATATTCCTGAACACGTAAGCACACATCCCCAG | 17 |
| 5′BiotinUF rs1014337 | 5′Biotin-GAGCTGCTGCACCATATTCCTGAACGATTTCTATCCTCAAAAAGCTTATGGG | 18 |
| 5′BiotinUF rs1015731 | 5′Biotin-GAGCTGCTGCACCATATTCCTGAACGATGAATCATCTTACTCTTTAGTATGGTTGC | 19 |
| 5′BiotinUF rs10164484 | 5′Biotin-GAGCTGCTGCACCATATTCCTGAACCCTGCCCTTTAGACAGGAATC | 20 |
| 5′BiotinUF rs10251765 | 5′Biotin-GAGCTGCTGCACCATATTCCTGAACCATCTGCCTTGATCTCCCTTC | 21 |
| 5′BiotinUF rs10265857 | 5′Biotin-GAGCTGCTGCACCATATTCCTGAACCCTTCATGCTCTTCTTCCTGC | 22 |
| 5′BiotinUF rs1032426 | 5′Biotin-GAGCTGCTGCACCATATTCCTGAACGCTATTTTTATAATATTTATTATTTT | 23 |
| | AAATAATTCAAAATACAAAAGTAACAC | |
| 5′BiotinUF rs10495556 | 5′Biotin-GAGCTGCTGCACCATATTCCTGAACCTAGACATTGGGAATACATAGGAGTG | 24 |
| 5′BiotinUF rs10499226 | 5′Biotin-GAGCTGCTGCACCATATTCCTGAACAACTTGTACCCAGATGCAGTC | 25 |
| 5′BiotinUF rs10505007 | 5′Biotin-GAGCTGCTGCACCATATTCCTGAACCTTCTAAGGCTTCAGGGATGAC | 26 |
| 5′BiotinUF rs1063087 | 5′Biotin-GAGCTGCTGCACCATATTCCTGAACGTACTTGAAAAGAAGCCCGG | 27 |
| 5′BiotinUF rs10732346 | 5′Biotin-GAGCTGCTGCACCATATTCCTGAACGATCTCTCTACCACCATCAGGG | 28 |
| 5′BiotinNewUF | 5′Biotin-GAGCTGCTGCACCATATTCCTGAACAGGAGTCACTACATTCAGGGATG | 29 |
| rs10742993 | | |
| 5′BiotinUF rs10882763 | 5′Biotin-GAGCTGCTGCACCATATTCCTGAACGTGTCTCAGGTGAAAGTGACTC | 30 |
| 5′BiotinNewUF | 5′Biotin-GAGCTGCTGCACCATATTCCTGAACCTTCAGGATTATACTGGCAGTTGC | 31 |
| rs10911946 | | |
| 5′BioinUF rs11033260 | 5′Biotin-GAGCTGCTGCACCATATTCCTGAACGCTTTGAATGGTATCACCCTCAC | 32 |
| 5′BiotinUF rs11240574 | 5′Biotin-GAGCTGCTGCACCATATTCCTGAACAAACGCAGTCATCACTCTCC | 33 |
| 5′BiotinUF rs11599388 | 5′Biotin-GAGCTGCTGCACCATATTCCTGAACGGGAGCGGGAATCTTAAATCC | 34 |
| 5′BiotinUF rs11634405 | 5′Biotin-GAGCTGCTGCACCATATTCCTGAACGCAACAGGATTCGACTAAGGC | 35 |
| 5′BiotinUF rs1222958 | 5′Biotin-GAGCTGCTGCACCATATTCCTGAACCATGTATATAGTTTGGCTAGCAGTGAAAG | 36 |
| 5′BiotinUF rs12334756 | 5′Biotin-GAGCTGCTGCACCATATTCCTGAACGAATCCTACTCCTAAGGTGATGTTG | 37 |
| 5′BiotinUF rs1266886 | 5′Biotin-GAGCTGCTGCACCATATTCCTGAACCTTCATCAGCAAGCAACTACATTG | 38 |
| 5′BiotinNewUF | 5′Biotin-GAGCTGCTGCACCATATTCCTGAACGGGTCCAAAACTGCTCATGTC | 39 |
| rs12825566 | | |
| 5′BiotinUF13023380 | 5′Biotin-GAGCTGCTGCACCATATTCCTGAACTTTTTCCATGGCTTTTGGGC | 40 |
| 5′BiotinUF rs1393257 | 5′Biotin-GAGCTGCTGCACCATATTCCTGAACTGTACAGGCAGGTCTTAGAGATG | 41 |
| 5′BiotinUF rs1400130 | 5′Biotin-GAGCTGCTGCACCATATTCCTGAACGTAGCCAATTCCTTCAGTGCAG | 42 |
| 5′BiotinNewUF | 5′Biotin-GAGCTGCTGCACCATATTCCTGAACAGGGCTTGTTTCAGCTTGAG | 43 |
| rs1490492 | | |
| 5′BiotinUF rs1567603 | 5′Biotin-GAGCTGCTGCACCATATTCCTGAACCAAAAGTTTTGTTTAGGTGCCTTCC | 44 |

TABLE 2
Gene-specific phospho oligos used to ligate the extended strand in the extension ligation reaction
(non-hybridizing regions are underlined)

| | | SEQ |
|---|---|---|
| | | ID |
| Primer name | 5′P-Primer Sequence | NO: |
| 5′P rs1000586 | GGGGAGTGTAGGTTCTGGTACCCAGGCTCTGAAGGCGGTGTATGACATGG | 45 |
| 5′P rs10012004 | CATCACCTATATCATTATTTACTAAATTATTTTTTCTTCAAACTGACTTAGGCTCTGAA | 46 |
| | GGCGGTGTATGACATGG | |
| 5′P rs10014076 | CCCTTTTTTCCTAAAAGCCCCCAAACTTTTGGCTCTGAAGGCGGTGTATGACATGG | 47 |
| 5′P rs10027673 | CTTTTGTGAGCTGGCTTTTGCTCATCTCGCTCTGAAGGCGGTGTATGACATGG | 48 |
| 5′P rs10028716 | CCTATTTGAGTTTTGCTTTTTTGTTTTGGTCTCGGCTCTGAAGGCGGTGTATGACATGG | 49 |
| 5′P rs10063237long | GATTTAGACAGAGTCTTACTCTGTCACCAGGGCTCTGAAGGCGGTGTATGACATGG | 50 |
| 5′P rs1007716 | CTATACTCTTGCTCGTGGAGTTAATCTCAGAGGGCTCTGAAGGCGGTGTATGACATGG | 51 |
| 5′P rs10131894 | CTCAGAAGTGTGGAACAGCTGCCCGCTCTGAAGGCGGTGTATGACATGG | 52 |
| 5′P rs1014337 | CTTGGGACTTCAGGTAGACTTAGTTTGAACATCGCTCTGAAGGCGGTGTATGACATGG | 53 |
| 5′P rs1015731 | CCATCTACATTAGCTTACCAGGGCTGCGCTCTGAAGGCGGTGTATGACATGG | 54 |
| 5′P rs10164484 | CTCTCTAATGTTCCAGAGAAACCCCAGGGCTCTGAAGGCGGTGTATGACATGG | 55 |
| 5′P rs10251765 | CGTTTTCTTATGTGTCTGGCCTCATCCGCTCTGAAGGCGGTGTATGACATGG | 56 |
| 5′P rs10265857 | GGAGCGCTCCATGAAACACAACAGGCTCTGAAGGCGGTGTATGACATGG | 57 |
| 5′P rs1032426 | GTTGACAGTTGATTTTGTAATGCCTCCACGCTCTGAAGGCGGTGTATGACATGG | 58 |
| 5′P rs10495556 | CGATGTGATCCTGTGTCAAATAATGACGGGCTCTGAAGGCGGTGTATGACATGG | 59 |
| 5′P rs10499226 | CTGAAGGGAATGGCTGGTTTTTAATTTGTAGTGGCTCTGAAGGCGGTGTATGACATGG | 60 |
| 5′P rs10505007 | GAAGGTGGGATTACGCCTAACTTTAGGGCTCTGAAGGCGGTGTATGACATGG | 61 |
| 5′P rs1063087 | GACTTCATGGCTGGCAGAAAGCTCTGAAGGCGGTGTATGACATGG | 62 |
| 5′P rs10732346 | CTGCATTTCTACTGGTAACATGCGCCGCTCTGAAGGCGGTGTATGACATGG | 63 |
| 5′PNew rs10742993 | CTATTCAGGTGTCACTTTTATTATGATTATCTAAGGTCAGTGGCTCTGAAGGCGGTGTATGACATGG | 64 |
| 5′P rs10882763 | CAGGTCCAGTTCTTGAGTTTCATCCTTTCGCTCTGAAGGCGGTGTATGACATGG | 65 |
| 5′P rs10911946long | CCTCTCTGTTTTGTTGAGAAATCCACTCTTGGTCGCTCTGAAGGCGGTGTATGACATGG | 66 |
| 5′P rs11033260 | GCAAAATGGGTATGGTTTAGCCAGAAACATGGCTCTGAAGGCGGTGTATGACATGG | 67 |
| 5′P rs11240574 | GGTGATGGACCCACTGCCTGGCTCTGAAGGCGGTGTATGACATGG | 68 |
| 5′P rs11599388 | GTGACCTGACACTGGTGGGATGGCTCTGAAGGCGGTGTATGACATGG | 69 |
| 5′P rs11634405 | GCTTTGTGTGCAAATCACCTATTTTCCTGGCTCTGAAGGCGGTGTATGACATGG | 70 |
| 5′P rs1222958 | GGTGAGAGAATATGAAAGCAAAACAGCAACCGCTCTGAAGGCGGTGTATGACATGG | 71 |
| 5′P rs12334756 | GGGCTATGTAGACACTTCAAAGGTGTTCGCTCTGAAGGCGGTGTATGACATGG | 72 |
| 5′P rs1266886 | GTTTGCTCTAGCTCAATGGCCTCTTAAGGCTCTGAAGGCGGTGTATGACATGG | 73 |
| 5′PNew rs12825566 | CCAACACAGTCATCTGATCCCATCTCCGCTCTGAAGGCGGTGTATGACATGG | 74 |
| 5′P rs13023380 | GTAGGCAAGGCTGTTCTTTTTTGTGTTGGCTCTGAAGGCGGTGTATGACATGG | 75 |
| 5′P rs1393257 | CCATATGCAGTTTTTGTTTTCCCAGTGCGCTCTGAAGGCGGTGTATGACATGG | 76 |
| 5′P rs1400130 | CACCATAATAGTTTATCTGCTTCTACTAAAATTATTATTGGCGCTCTGAAGGCGGTGTATGACATGG | 77 |
| 5′PNew rs1490492 | CCTCAGAATGAAATCATGCTTTTCTGCTAATTTGTAGGCTCTGAAGGCGGTGTATGACATGG | 78 |
| 5′P rs1567603 | CCTTCAGACATACCTTGGGAAAATGTCAGGCTCTGAAGGCGGTGTATGACATGG | 79 |

TABLE 3
Standard post-PCR primers used in the post-PCR assay for the universal PCR readout

| | | | | | | EXT1_ | EXT1_ | EXT2_ | EXT2_ |
|---|---|---|---|---|---|---|---|---|---|
| | TERM | SNP_ID | UEP_DIR | UEP_MASS | UEP_SEQ 5′-3′ | CALL | MASS | CALL | MASS |
| L1 | goldPLEX | rs10882763 | F | 4374.9 | CCTTCTTCATCCCCC (SEQ ID NO: 80) | G | 4662.1 | T | 4701.9 |
| L2 | goldPLEX | rs12334756 | R | 4515 | GCCCATAAGCCAACA (SEQ ID NO: 81) | G | 4762.2 | A | 4842.1 |
| L3 | goldPLEX | rs1014337 | F | 4627 | GTCCCAAGGGAGAGC (SEQ ID | G | 4914.2 | T | 4954.1 |
| | | | | | NO: 82) | | | | |
| L4 | goldPLEX | rs1063087 | R | 4875.2 | GGTAAAGCCCCTCGAA (SEQ ID | C | 5162.4 | A | 5202.3 |
| | | | | | NO: 83) | | | | |
| L5 | goldPLEX | rs1000586 | R | 5027.3 | CTCCCCACCTGACCCTG (SEQ ID | G | 5274.5 | A | 5354.4 |
| | | | | | NO: 84) | | | | |
| L6 | goldPLEX | rs1400130 | R | 5118.3 | TTATGGTGTCTTTCCCC (SEQ ID | T | 5389.5 | C | 5405.5 |
| | | | | | NO: 85) | | | | |
| L7 | goldPLEX | rs11634405 | R | 5237.4 | CAAAGCAGGTGCACGAA (SEQ ID | G | 5484.6 | A | 5564.5 |
| | | | | | NO: 86) | | | | |
| L8 | goldPLEX | rs12825566 | R | 5311.5 | ACTTCCTCCCTTCTTACT (SEQ ID | C | 5598.7 | A | 5638.6 |
| | | | | | NO: 87) | | | | |
| L9 | goldPLEX | rs10251765 | F | 5448.5 | CCCTTTTGGCTTCCTGGG (SEQ ID | G | 5735.7 | T | 5775.6 |
| | | | | | NO: 88) | | | | |
| L10 | goldPLEX | rs11033260 | F | 5704.7 | CCCATTTTGCGCCATTTAT (SEQ ID | A | 5975.9 | G | 5991.9 |
| | | | | | NO: 89) | | | | |
| L11 | goldPLEX | rs10495556 | F | 5827.8 | GGATCACATCGTGTTAGAC (SEQ ID | C | 6075 | T | 6154.9 |
| | | | | | NO: 90) | | | | |
| L12 | goldPLEX | rs10027673 | R | 5867.8 | ggAAGACGCTTATCATGGT (SEQ ID | G | 6115 | A | 6194.9 |
| | | | | | NO: 91) | | | | |
| M1 | goldPLEX | rs10131894 | F | 6037.9 | ccctTGCATGCATGCGCACA (SEQ ID | C | 6285.1 | G | 6325.1 |
| | | | | | NO: 92) | | | | |
| M2 | goldPLEX | rs1393257 | F | 6239.1 | agGCAATAGAGGGAGTATCA (SEQ ID | C | 6486.3 | T | 6566.2 |
| | | | | | NO: 93) | | | | |
| M3 | goldPLEX | rs10164484 | F | 6246.1 | aaactTCTCCCTCAGCCTACC (SEQ ID | A | 6517.3 | G | 6533.3 |
| | | | | | NO: 94) | | | | |
| M4 | goldPLEX | rs10499226 | R | 6373.2 | CAGAAATACATTTGCCACTAT (SEQ ID | G | 6620.4 | C | 6660.4 |
| | | | | | NO: 95) | | | | |
| M5 | goldPLEX | rs1007716 | R | 6446.2 | gcGCTGTATCCTCAGAGAGTA (SEQ | G | 6693.4 | A | 6773.3 |
| | | | | | ID NO: 96) | | | | |
| M6 | goldPLEX | rs10732346 | R | 6731.4 | GGGAGAATGCATTTCTTTTTCC (SEQ | T | 7002.6 | C | 7018.6 |
| | | | | | ID NO: 97) | | | | |
| M7 | goldPLEX | rs10014076 | R | 6831.5 | GGATACTTCAAGAATAGTAGAG (SEQ | G | 7078.7 | A | 7158.6 |
| | | | | | ID NO: 98) | | | | |
| M8 | goldPLEX | rs1266886 | R | 6840.4 | cccacTCTATTCCCACGTCAGCC (SEQ | T | 7111.7 | C | 7127.7 |
| | | | | | ID NO: 99) | | | | |
| M9 | goldPLEX | rs11240574 | F | 6954.5 | tttaTTTTTCCATCACACGTATG (SEQ ID | C | 7201.7 | T | 7281.6 |
| | | | | | NO: 100) | | | | |
| M10 | goldPLEX | rs11599388 | R | 7233.7 | tttcTAAATCCCCACCCGGCGCAG | G | 7480.9 | A | 7560.8 |
| | | | | | (SEQ ID NO: 101) | | | | |
| M11 | goldPLEX | rs1222958 | F | 7240.7 | gCTCTCACCATTAACTATACAGCA | A | 7511.9 | G | 7527.9 |
| | | | | | (SEQ ID NO: 102) | | | | |
| M12 | goldPLEX | rs10742993 | R | 7327.8 | gttgACAGTTCTCCAAGTCCAGAT (SEQ | T | 7599 | C | 7615 |
| | | | | | ID NO: 103) | | | | |
| H1 | goldPLEX | rs10505007 | F | 7398.8 | ggattACAGATGCCTTCTTGGGTA (SEQ | A | 7670 | G | 7686 |
| | | | | | ID NO: 104) | | | | |
| H2 | goldPLEX | rs10063237 | R | 7722.1 | CAATCAAAGAATTATATGGCTAAGG | G | 7969.2 | A | 8049.2 |
| | | | | | (SEQ ID NO: 105) | | | | |
| H3 | goldPLEX | rs10012004 | F | 7902.1 | cccttTAACACCTATATGGGTTTTTG | C | 8149.3 | T | 8229.2 |
| | | | | | (SEQ ID NO: 106) | | | | |
| H4 | goldPLEX | rs13023380 | F | 7909.2 | gcagcACAGCCTTGCCTACAATGACA | A | 8180.4 | G | 8196.4 |
| | | | | | (SEQ ID NO: 107) | | | | |
| H5 | goldPLEX | rs1490492 | F | 8098.3 | gggCATTCTGAGGAAAATAATGTATG | C | 8345.5 | T | 8425.4 |
| | | | | | (SEQ ID NO: 108) | | | | |
| H6 | goldPLEX | rs10265857 | R | 8106.3 | ggacGAGAGGTCTGAGAGTTTCTGAT | T | 8377.5 | C | 8393.5 |
| | | | | | (SEQ ID NO: 109) | | | | |
| H7 | goldPLEX | rs1567603 | F | 8265.4 | acATAACTCTCAGATAATTAAAGTTGT | C | 8512.6 | T | 8592.5 |
| | | | | | (SEQ ID NO: 110) | | | | |
| H8 | goldPLEX | rs1015731 | R | 8310.5 | atgtTAACAGAAAGCACAATAAAAACA | G | 8557.7 | A | 8637.6 |
| | | | | | (SEQ ID NO: 111) | | | | |
| H9 | goldPLEX | rs10911946 | F | 8470.5 | gggagGAGAGGAACCATAAGATATTAG | C | 8717.7 | T | 8797.6 |
| | | | | | (SEQ ID NO: 112) | | | | |
| H10 | goldPLEX | rs10028716 | R | 8477.5 | cctggTTTTGTCTTCCCTATTTACTGAT | T | 8748.7 | C | 8764.7 |
| | | | | | (SEQ ID NO: 113) | | | | |
| H11 | goldPLEX | rs1032426 | F | 8672.7 | ggacAAAAGTTCTGAATTATTTGGTTTG | A | 8943.9 | G | 8959.9 |
| | | | | | (SEQ ID NO: 114) | | | | |

### Example 3

### Post-PCR Reaction after Examples 1 and 2

SAP/Post-PCR Reaction: 5 ul Univ PCR was dispensed in a 384 well plate and 2 ul SAP reaction containing 0.6U SAP (shrimp alkaline phosphatase) were added with incubation at 37° C. for 40 minutes and finally inactivation of the enzyme at 85° C. for 5 minutes. Extension reagents were added in 2 ul amounts containing 0.9 mM acyclic terminators and 1.353U post-PCR enzyme. The extension oligo mixture differed in concentration according to its mass: 0.5 uM of low mass: 4000-5870 daltons, 1.0 uM of medium mass: 6000-7350 daltons and 1.5 uM of high mass: 7400-8700 daltons were added in a final volume of 9 ul. The cycling conditions used for post-PCR reaction were 94° C./30 sec and 40 cycles of an 11 temperature cycle (94° C./5 secs and 5 internal cycles of (52° C./5 sec and 80° C./5sec) and final extension at 72° C./3 minutes.

MALDI-TOF MS: The extension reaction was diluted with 16 ul water and 6 mg CLEAN Resin (Sequenom) was added to desalt the reaction. It was rotated for 2 hours at room temperature. 15 nl of the post-PCR reaction were dispensed robotically onto silicon chips preloaded with matrix (SpectroCHIP, Sequenom). Mass spectra were acquired using a Mass ARRAY Compact Analyzer (MALDI-TOF mass spectrometer, Sequenom).

### Example 4

### Post-PCR Reaction to Increase Multiplexing and Flexibility in SNP Genotyping

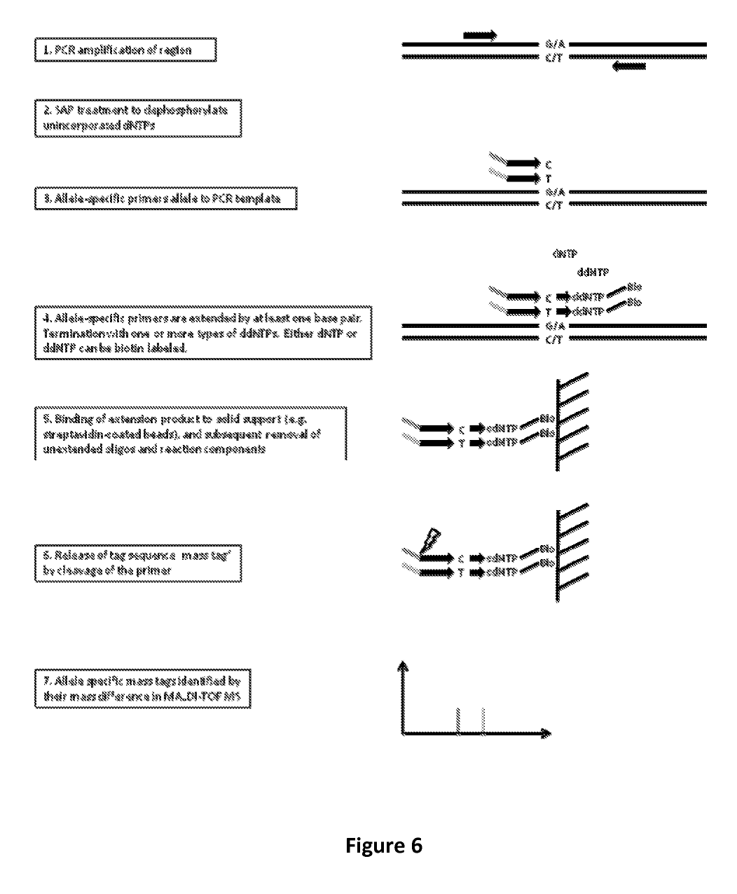

The presented process provides a concept for an alternative goldPLEX primer extension post-PCR format to increase multiplexing and flexibility of SNP genotyping. It utilizes allele specific extension primers, with two extension primers per SNP designed to hybridize on the SNP site. Each primer contains a gene and allele specific 3′ nucleotide for specific hybridization to the SNP site of interest and a varied defined 5′ nucleotide sequence which corresponds to a mass tag. The specificity of the assay is determined by the match of the 3′ end of the primer to the template, which will only be extended by DNA polymerase if corresponding to the specific SNP. An overview of the process is outlined in FIG. 6.

The extension primers are extended by dNTP incorporation and terminated by a ddNTP or alternatively terminated by ddNTP incorporation without dNTP extension. One or more dNTP and/or ddNTP used during the extension reaction are labeled with a moiety allowing immobilization to a solid support, such as biotin.

The extension product is subsequently immobilized on a solid support, such as streptavidin coated beads, where only extended/terminated products will bind. Unextended primers and unwanted reaction components do not bind and are washed away.

The 5′ nucleotide sequence or an alternative group which corresponds to a mass tag is cleaved from the extension product, leaving the 3′ section of the extension product bound to the solid support. The cleavage can be achieved with a variety of methods including enzymatic, chemical and physical treatments. The possibility outlined in this example utilizes Endonuclease V to cleave a deoxyinosine within the primer. The reaction cleaves the second phosphodiester bonds 3′ to deoxyinosine releasing an oligo nucleotide mass tag.

The 5′ nucleotide sequence (mass tag) is then transferred to a chip array and analyzed by mass spectrometry (e.g. MALDI-TOF MS). The presence of a mass signal matching the tag's mass indicates an allele specific primer was extended and therefore the presence of that specific allele.

### Example 5

### Endonuclease V Cleavage of Deoxyinosine

Prior to the extension reaction a 35plex PCR was carried out in a 5 μl reaction volume using the following reagents; 5 ng DNA, 1×PCR buffer, 500 μM each dNTP, 100 nM each PCR primer (as listed in Table 4), 3 mM MgCl₂, and 0.15 U Taq (Sequenom). Thermocycling was carried out using the following conditions: 7 minutes at 95° C.; followed by 45 cycles of 20 seconds at 95° C., 30 seconds at 56° C. and 1 minute at 72° C.; and concludes with 3 minutes at 72° C.

The PCR reaction was treated with SAP (shrimp alkaline phosphatase) to dephosphorylate unincorporated dNTPs. A 2 μl mixture containing 0.6 U SAP was added to the PCR product and then subjected to 40 minutes at 37° C. and 5 minutes at 85° C.

Extension reaction reagents were combined in a 3 μl volume, which was added to the SAP treated PCR product. The total extension reaction contained the following reagents; 1×goldPLEX buffer, 17 μM each biotin ddNTP, 0.8 μM each extension primer (listed in Table 5) and 1×post-goldPLEX enzyme.

Thermocycling was carried out using a 200 cycle program consisting of 2 minutes at 94° C.; followed by 40 cycles of 5 seconds at 94° C., followed by 5 cycles of 5 seconds at 52° C., and 5 seconds at 72° C.; and concludes with 3 minutes at 72° C. Extension primer sequences containing the mass tags and resulting masses of the cleaved products corresponding to specific alleles are listed in Table 5.

Solulink magnetic streptavidin beads were conditioned by washing three times with 50 mM Tris-HCl pH 7.5, 1M NaCl, 0.5 mM EDTA, pH 7.5. The extension reaction was then combined with 300 μg conditioned beads. Beads were incubated at room temperature for 30 minutes with gentle agitation and then pelleted using a magnetic rack. The supernatant was removed. Subsequently the beads were washed 3 times with 50 mM Tris-HCl, 1M NaCl, 0.5 mM EDTA, pH 7.5 and 3 times with water. For each wash step the beads were pelleted and the supernatant removed. The mass tags were cleaved from the extension product by addition of a solution containing 30 U Endonuclease V and 0.4×buffer 4(NEB) and incubation at 37° C. for 1 hour. After incubation the magnetic beads were pelleted using a magnetic rack and the supernatant containing the mass tag products was removed.

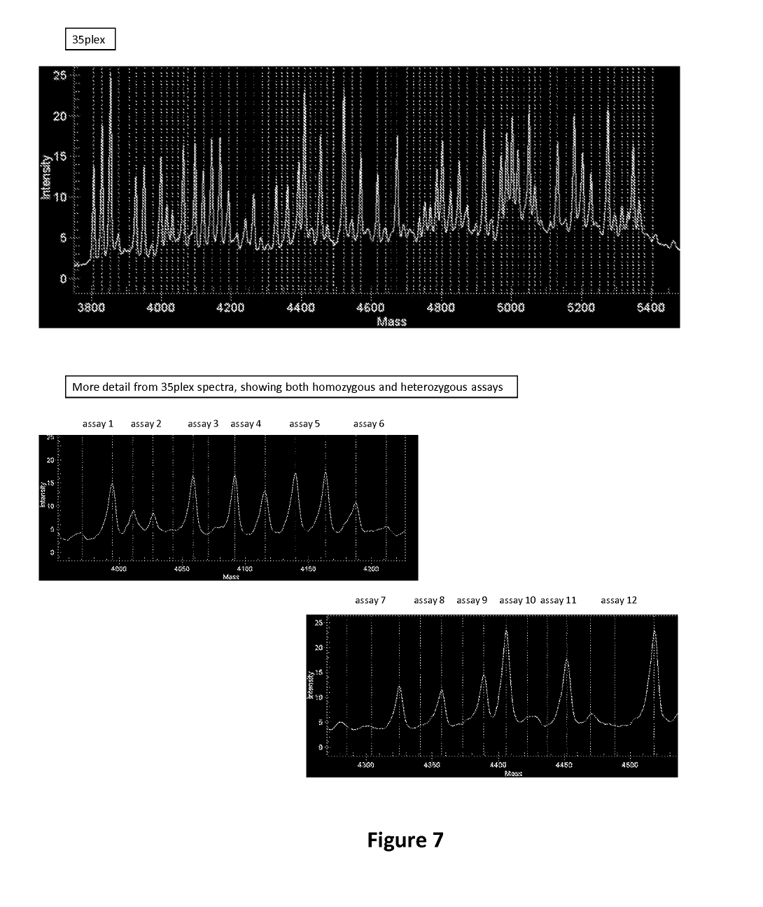

Desalting was achieved by the addition of 6 mg CLEAN Resin (Sequenom). 15 nl of the cleavage reactions were dispensed robotically onto silicon chips preloaded with matrix (SpectroCHIP, Sequenom). Mass spectra were acquired using a MassARRAY Compact Analyser (MALDI-TOF mass spectrometer (Sequenom). FIG. 7 shows MALDI-TOF MS spectra for 35plex genotyping using the post-PCR readout as presented herein.

TABLE 4
PCR primers used in this study

| SNP ID | Forward Primer | SEQ ID NO: | Reverse Primer | SEQ ID NO: |
|---|---|---|---|---|
| rs11155591 | ACGTTGGATGAAAGGCTGATCCAGGTCATC | 115 | ACGTTGGATGTTCTCTTCAAACCTCCCATC | 150 |
| rs12554258 | ACGTTGGATGTTGAGACACGGCACAGCGG | 116 | ACGTTGGATGTTTTCCTCTTCCTACCCCTC | 151 |
| rs12162441 | ACGTTGGATGAAGGTAGGCCTTTAGGAGAG | 117 | ACGTTGGATGTGGCAACACACGACTGTACT | 152 |
| rs11658800 | ACGTTGGATGATGCACAATCGTCCTACTCC | 118 | ACGTTGGATGTGCTTCCCAGGTCACTATTG | 153 |
| rs13194159 | ACGTTGGATGTGAGCCAGGGATATCCTAAC | 119 | ACGTTGGATGTCCATGAGTGCAGGACTACG | 154 |
| rs1007716 | ACGTTGGATGTAATAGAGGGTGCATTGAAG | 120 | ACGTTGGATGCTCCACGAGCAAGAGTATAG | 155 |
| rs11637827 | ACGTTGGATGAAAGAGAGAGAGATCCCTG | 121 | ACGTTGGATGATCCCATACGGCCAAGAAGA | 156 |
| rs13188128 | ACGTTGGATGCACTAATAAAGGCAGCCTGT | 122 | ACGTTGGATGATGAGTAACGCTTGGTGCTG | 157 |
| rs1545444 | ACGTTGGATGGGCTCTGATCCCTTTTTTTAG | 123 | ACGTTGGATGTGGTAGCCTCAAGAATGCTC | 158 |
| rs1544928 | ACGTTGGATGGCTTTTCCTCTTCTTTGGTAG | 124 | ACGTTGGATGGAATGTGTAAAACAAACCAG | 159 |
| rs11190684 | ACGTTGGATGTCTCAGTTCCAACTCATGCC | 125 | ACGTTGGATGTGAGCCATGTAGAGACTCAG | 160 |
| rs12147286 | ACGTTGGATGAGAATGTGCCAAAGAGCAG | 126 | ACGTTGGATGTCTGCATCCCTTAGGTTCAC | 161 |
| rs11256200 | ACGTTGGATGCCTTATTGGATTCTATGTCCC | 127 | ACGTTGGATGACCAAGCACTGTACTTTTC | 162 |
| rs1124181 | ACGTTGGATGACTTGGCGAGTCCCCATTTC | 128 | ACGTTGGATGTTAATATAGTCCCCAGCCAC | 163 |
| rs1392592 | ACGTTGGATGTCTTGTCTCTTACCTCTCAG | 129 | ACGTTGGATGCTGTGCTGACTGAGTAGATG | 164 |
| rs1507157 | ACGTTGGATGTGAGGATTAAAGGATCTGGG | 130 | ACGTTGGATGATCTTTGAAGGCTCCTCTGG | 165 |
| rs1569907 | ACGTTGGATGGAGGCTCCTCTACACAAAAG | 131 | ACGTTGGATGGCATGTCCCTATGAGATCAG | 166 |
| rs1339007 | ACGTTGGATGTTGCTCTAAGGTGGATGCTG | 132 | ACGTTGGATGTTAGGCACCCCAAGTTTCAG | 167 |
| rs1175500 | ACGTTGGATGGTTTACAACCTGTGGCAGAC | 133 | ACGTTGGATGTGTAGCATGTCAGCCATCAG | 168 |
| rs11797485 | ACGTTGGATGGAAAGTGACCCATCAAGCAG | 134 | ACGTTGGATGGTAGTTGCTTGTGGTTACCG | 169 |
| rs1475270 | ACGTTGGATGCTATGGGGAACTGAATAAGTG | 135 | ACGTTGGATGGAGCAATTCATTTGTCTCC | 170 |
| rs12631412 | ACGTTGGATGCAAACTATTGACTGGTCATGG | 136 | ACGTTGGATGTTTTGTTGTTTGGGCATTGG | 171 |
| rs1456076 | ACGTTGGATGGCAGAGGTTTGAGAAAAGAG | 137 | ACGTTGGATGGTTCCCATCCAGTAATGGAG | 172 |
| rs12958106 | ACGTTGGATGGTATATGCCTGTATGTGGTC | 138 | ACGTTGGATGCCAACAGTTTTTCTTTAAGGG | 173 |
| rs1436633 | ACGTTGGATGGAGGGAAAGACCTGCTTCTA | 139 | ACGTTGGATGAGAAGCTCCGAGAAAAGGTG | 174 |
| rs1587543 | ACGTTGGATGGAGAAGGCTTTCCAGAATTTG | 140 | ACGTTGGATGTATAGCCATTACTGGGCTTG | 175 |
| rs10027673 | ACGTTGGATGCAAAAGCCAGCTCACAAAAG | 141 | ACGTTGGATGCCCTCTTGCATAAAATGTTGC | 176 |
| rs12750459 | ACGTTGGATGTTTTGGGCCCCTCCATATTC | 142 | ACGTTGGATGCTCCATGCAAGGCTGTGGC | 177 |
| rs13144228 | ACGTTGGATGTGGATATGCTGAATTTGAGG | 143 | ACGTTGGATGCGTTATCAAGGACTTTGTGC | 178 |
| rs11131052 | ACGTTGGATGCTTTTGTCCATGTTTGGCAG | 144 | ACGTTGGATGGAGGTTATCTTATTGTAACGC | 179 |
| rs1495805 | ACGTTGGATGAGGACAGTTGTCGTGAGATG | 145 | ACGTTGGATGAGACTGTCCTTTCCCAGGAT | 180 |
| rs1664131 | ACGTTGGATGCTGAGGCTGGGTAACTTATC | 146 | ACGTTGGATGTCATCAGAAGCAGATGCTGG | 181 |
| rs1527448 | ACGTTGGATGGCCCTTGGCACATAGTACTG | 147 | ACGTTGGATGCCATACGTTCAAGGATTGGG | 182 |
| rs11062992 | ACGTTGGATGTTGGTTATAGAGCGTCCCTG | 148 | ACGTTGGATGAGGTGTGCAAGTGTCAGAAG | 183 |
| rs12518099 | ACGTTGGATGACCCCTTACTCCAATAAGTC | 149 | ACGTTGGATGGTATATCATGTCCAGTGAAG | 184 |

TABLE 5
Extension primers and mass tags released after cleavage*

| | | SEQ ID | | SEQ ID | |
|---|---|---|---|---|---|
| SNP ID | extension primer sequence | NO: | mass tag sequence | NO: | mass |
| rs11155591_a | CCACCGCCTCCICCTCCCATCTCCACCCTCTA | 185 | CCACCGCCTCCIC | 255 | 3802.49 |
| rs11155591_g | CCACCGCCTACICCTCCCATCTCCACCCTCTG | 186 | CCACCGCCTACIC | 256 | 3826.52 |
| rs12554258_c | CCACAGCCTACICTTCCTACCCCTCCAGCCGC | 187 | CCACAGCCTACIC | 257 | 3850.54 |
| rs12554258_t | CCACAGCATACICTTCCTACCCCTCCAGCCGT | 188 | CCACAGCATACIC | 258 | 3874.57 |
| rs12162441_c | CAACAGCACAAITTGCTATCCCCACAATTACC | 189 | CAACAGCACAAIT | 259 | 3922.62 |
| rs12162441_t | CAACAGAACAAITTGCTATCCCCACAATTACT | 190 | CAACAGAACAAIT | 260 | 3946.64 |
| rs11658800_c | CAAAAGAACAAITGAAACTGCAGACTCTTCCC | 191 | CAAAAGAACAAIT | 261 | 3970.67 |
| rs11658800_t | CAAAAGAAAAAITGAAACTGCAGACTCTTCCT | 192 | CAAAAGAAAAAIT | 262 | 3994.69 |
| rs13194159_c | AATAAGAAGAAICGTCTGATTGGCTTTAGTTC | 193 | AATAAGAAGAAIC | 263 | 4010.69 |
| rs13194159_t | GATAAGAAGAAICGTCTGATTGGCTTTAGTTT | 194 | GATAAGAAGAAIC | 264 | 4026.69 |
| rs1007716_c | AATAGCGAGAAIGCTGTATCCTCAGAGAGTAC | 195 | AATAGCGAGAAIG | 265 | 4042.69 |
| rs1007716_t | AATAGCGAGAGIGCTGTATCCTCAGAGAGTAT | 196 | AATAGCGAGAGIG | 266 | 4058.69 |
| rs11637827_a | CCACCCCCGCCCITTCTCCCACAGTAAACTTCCA | 197 | CCACCCCCGCCCIT | 267 | 4091.68 |
| rs11637827_g | CCACCACCGCCCITTCTCCCACAGTAAACTTCCG | 198 | CCACCACCGCCCIT | 268 | 4115.70 |
| rs13188128_c | CCACCGCACTACICTCTTCTGCTTCATATTTCAC | 199 | CCACCGCACTACIC | 269 | 4139.73 |
| rs13188128_g | CCACAGCACTACICTCTTCTGCTTCATATTTCAG | 200 | CCACAGCACTACIC | 270 | 4163.75 |
| rs1545444_a | CAACAGCACCACITTCATTATTTCACTCAAGCGA | 201 | CAACAGCACCACIT | 271 | 4187.78 |
| rs1545444_g | CAACAGCAACACITTCATTATTTCACTCAAGCGG | 202 | CAACAGCAACACIT | 272 | 4211.80 |
| rs1544928_a | CAACAGCTACAAIAAACAAACCAGAAAGTCACTA | 203 | CAACAGCTACAAIA | 273 | 4235.83 |
| rs1544928_g | CAACAGATACAAIAAACAAACCAGAAAGTCACTG | 204 | CAACAGATACAAIA | 274 | 4259.85 |
| rs11190684_c | CAAAAGATACAAIATGTAGAGACTCAGTCTCTTC | 205 | CAAAAGATACAAIA | 275 | 4283.88 |
| rs11190684_g | CAAAAGATAGAAIATGTAGAGACTCAGTCTCTTG | 206 | CAAAAGATAGAAIA | 276 | 4323.90 |
| rs12147286_c | CAAAAGAGAGAAITGCAAATTAGATTTGTCAGGC | 207 | CAAAAGAGAGAAIT | 277 | 4339.90 |
| rs12147286_t | CAGAAGAGAGAAITGCAAATTAGATTTGTCAGGT | 208 | CAGAAGAGAGAAIT | 278 | 4355.90 |
| rs11256200_a | CAGAAGAGAGAGITATGTCTTATTCTTCTTCACCA | 209 | CAGAAGAGAGAGIT | 279 | 4371.90 |
| rs11256200_g | CAGGAGAGAGAGITATGTCTTATTCTTCTTCACCG | 210 | CAGGAGAGAGAGIT | 280 | 4387.90 |
| rs1124181_c | CCACCCACCGCCCITAGTCCCCAGCCACTATAAAAC | 211 | CCACCCACCGCCCIT | 281 | 4404.89 |
| rs1124181_g | CCACCCGCCGCCCITAGTCCCCAGCCACTATAAAAG | 212 | CCACCCGCCGCCCIT | 282 | 4420.89 |
| rs1392592_c | CCACCCGCCGCTCITTCCCAAAGTTGAGGGACTTAC | 213 | CCACCCGCCGCTCIT | 283 | 4435.90 |
| rs1392592_t | CCACTCGCCGCTCITTCCCAAAGTTGAGGGACTTAT | 214 | CCACTCGCCGCTCIT | 284 | 4450.91 |
| rs1507157_c | CCACGCGCCCTACIAAGGCTCCTCTGGGGCACAAGC | 215 | CCACGCGCCCTACIA | 285 | 4468.94 |
| rs1507157_t | CAACGCGCACTACIAAGGCTCCTCTGGGGCACAAGT | 216 | CAACGCGCACTACIA | 286 | 4516.99 |
| rs1569907_a | CAACAAGCACTACIGGGTTTTGTTGTGCCAGTAGAA | 217 | CAACAAGCACTACIG | 287 | 4541.01 |
| rs1569907_g | CAACAAGCAATACIGGGTTTTGTTGTGCCAGTAGAG | 218 | CAACAAGCAATACIG | 288 | 4565.04 |
| rs1339007_c | CAAGAAGAAATAAICTGCCAATTAATCATCAACTCTC | 219 | CAAGAAGAAATAAIC | 289 | 4613.09 |
| rs1339007_t | AAAGAAGAAATAAICTGCCAATTAATCATCAACTCTT | 220 | AAAGAAGAAATAAIC | 290 | 4637.11 |
| rs1175500_a | GAAGAAGACATAAIATGTCAGCCATCAGCCTCTCACA | 221 | GAAGAAGACATAAIA | 291 | 4653.11 |
| rs1175500_g | GAAGAAGACATAGIATGTCAGCCATCAGCCTCTCACG | 222 | GAAGAAGACATAGIA | 292 | 4669.11 |
| rs11797485_c | GAAGAGGACGTAGIGCTCTTATATCTCATATGAACAC | 223 | GAAGAGGACGTAGIG | 293 | 4717.11 |
| rs11797485_g | GAGGAGGACGTAGIGCTCTTATATCTCATATGAACAG | 224 | GAGGAGGACGTAGIG | 294 | 4733.11 |
| rs1475270_c | CCACGCTCCTCTACIACTTTTCATGGTTATTCTCAGTC | 225 | CCACGCTCCTCTACIA | 295 | 4748.12 |
| rs1475270_t | CCGCGCTCCTCTACIACTTTTCATGGTTATTCTCAGTT | 226 | CCGCGCTCCTCTACIA | 296 | 4764.12 |
| rs12631412_c | CCACGCGCACCAACITGTTTTGTTTGTTTTGTTTTTTC | 227 | CCACGCGCACCAACIT | 297 | 4782.15 |
| rs12631412_t | CCACGCGCGCCAACITGTTTTGTTTGTTTTGTTTTTTT | 228 | CCACGCGCGCCAACIT | 298 | 4798.15 |
| rs1456076_c | CCACGCGAGTCAACICCATCCAGTAATGGAGTACAGTC | 229 | CCACGCGAGTCAACIC | 299 | 4822.17 |
| rs1456076_g | CCACGAGAGTCAACICCATCCAGTAATGGAGTACAGTG | 230 | CCACGAGAGTCAACIC | 300 | 4846.20 |
| rs12958106_a | CCACGAGAGTCAACIAGTTTTTCTTTAAGGGGAGTAGA | 231 | CCACGAGAGTCAACIA | 301 | 4870.22 |
| rs12958106_g | CAACGAGAGTAAACIAGTTTTTCTTTAAGGGGAGTAGG | 232 | CAACGAGAGTAAACIA | 302 | 4918.27 |
| rs1436633_c | CAAAGAGAATAAACIGGACAAAGATGAGTGCGTATATC | 233 | CAAAGAGAATAAACIG | 303 | 4942.30 |
| rs1436633_t | CAAAGAGAATAAAAIGGACAAAGATGAGTGCGTATATT | 234 | CAAAGAGAATAAAAIG | 304 | 4966.32 |
| rs1587543_a | CAAAGAGAATAGAAIGGCTTGGGGTCCCCATTAAAGCGA | 235 | CAAAGAGAATAGAAIG | 305 | 4982.32 |
| rs1587543_g | CAGAGAGAATAGAAIGGCTTGGGGTCCCCATTAAAGCGG | 236 | CAGAGAGAATAGAAIG | 306 | 4998.32 |
| rs10027673_c | AAGAGCGAGAGAGAITACTAAAGACGCTTATCATGGTC | 237 | AAGAGCGAGAGAGAIT | 307 | 5014.32 |
| rs10027673_t | AGGAGCGAGAGAGAITACTAAAGACGCTTATCATGGTT | 238 | AGGAGCGAGAGAGAIT | 308 | 5030.32 |
| rs12750459_c | CGGAGAGAGAGGAGITGCAAGGCTGTGGCTGGACAAGAC | 239 | CGGAGAGAGAGGAGIT | 309 | 5046.32 |
| rs12750459_t | CGGAGAGGGAGGAGITGCAAGGCTGTGGCTGGACAAGAT | 240 | CGGAGAGGGAGGAGIT | 310 | 5062.31 |
| rs13144228_c | CCCGCTCCGCCAGTCIATTCTATATTAGAACAACTCTCTTC | 241 | CCCGCTCCGCCAGTCIA | 311 | 5078.31 |
| rs13144228_t | CCACGCGCGCCAGTCIATTCTATATTAGAACAACTCTCTTT | 242 | CCACGCGCGCCAGTCIA | 312 | 5127.35 |
| rs11131052_c | CCACGCGCGACAGACITAACGCATATGCACATGCACACATC | 243 | CCACGCGCGACAGACIT | 313 | 5151.38 |
| rs11131052_t | CCACGCGAGACAGACITAACGCATATGCACATGCACACATT | 244 | CCACGCGAGACAGACIT | 314 | 5175.40 |
| rs1495805_c | CAACGCGAGACAGACITGTCCTTTCCCAGGATGCTCAAAGC | 245 | CAACGCGAGACAGACIT | 315 | 5199.43 |
| rs1495805_t | CAACGCGAGACAGAAITGTCCTTTCCCAGGATGCTCAAAGT | 246 | CAACGCGAGACAGAAIT | 316 | 5223.45 |
| rs1664131_g | CAACGAGAGACAGTAIAGCAGATGCTGGCCCCATGCTTCAG | 247 | CAACGAGAGACAGTAIA | 317 | 5247.48 |
| rs1664131_t | CAACGAGAGAAAGTAIAGCAGATGCTGGCCCCATGCTTCAT | 248 | CAACGAGAGAAAGTAIA | 318 | 5271.50 |
| rs1527448_c | CAAGGAGAGAAAGAAITAATAGTACAACAGCTATCAATTAC | 249 | CAAGGAGAGAAAGAAIT | 319 | 5311.53 |
| rs1527448_t | CAAGGAGAGAGAGAAITAATAGTACAACAGCTATCAATTAT | 250 | CAAGGAGAGAGAGAAIT | 320 | 5327.53 |
| rs11062992_a | CAAGGAGAGAGAGAGITGTGCAAGTGTCAGAAGATGAACAA | 251 | CAAGGAGAGAGAGAGIT | 321 | 5343.53 |
| rs11062992_g | CGAGGAGAGAGAGAGITGTGCAAGTGTCAGAAGATGAACAG | 252 | CGAGGAGAGAGAGAGIT | 322 | 5359.53 |
| rs12518099_c | CCACCTACCACCAGTCIGAAGAAATAAGAAACATTGAGACAC | 253 | CCACCTACCACCAGTCIG | 323 | 5375.52 |
| rs12518099_t | CCACATACCACCAGTCIGAAGAAATAAGAAACATTGAGACAT | 254 | CCACATACCACCAGTCIG | 324 | 5399.55 |

*SNP specific nucleotides are underlined, mass tags are underlined and “I” refers to deoxyinosine.

### Example 6

### RNAse A Cleavage of Ribonucleotide

Materials and Methods

Prior to the extension reaction a 2-plex PCR was carried out in a 5 μl reaction volume using the following reagents; 2 ng DNA, 1.25×HotStar Taq buffer, 500 μM each dNTP, 100 nM each PCR primer (as listed in Table 1), 3.5 mM MgCl₂, and 0.15 U HotStar Taq (Qiagen). Thermocycling was carried out using the following conditions: 15 minutes at 95° C.; followed by 45 cycles of 20 seconds at 95° C., 30 seconds at 56° C. and 1 minute at 72° C.; and concludes with 3 minutes at 72° C. The PCR reaction was treated with SAP (shrimp alkaline phosphatase) to dephosphorylate unincorporated dNTPs. A 2 μl mixture containing 0.3 U SAP was added to the PCR product and then subjected to 40 minutes at 37° C. and 5 minutes at 85° C.

TABLE 6
PCR primers used

| SNP ID | forward primer | reverse primer |
|---|---|---|
| rs1000586 | ACGTTGGATGTACCAGAACCTACACTCCCC | ACGTTGGATGTCTCAAACTCCAGAGTGGCC |
| | (SEQ ID NO: 325) | (SEQ ID NO: 327) |
| rs10131894 | ACGTTGGATGACGTAAGCACACATCCCCAG | ACGTTGGATGAGCTGTTCCACACTTCTGAG |
| | (SEQ ID NO: 326) | (SEQ ID NO: 328) |

Extension reaction reagents were combined in a 2 μl volume, which was added to the SAP treated PCR product. The extension reaction contained the following reagents; 21 μM each biotin ddNTP, 1 μM each extension primer including a ribonucleotide for subsequent RNase A cleavage (listed in Table 7) and 1.25 U Thermo Sequenase. Thermocycling was carried out using the following cycling conditions: 2 minutes at 94° C.; followed by 100 cycles of 5 seconds at 94° C., 5 seconds at 52° C., and 5 seconds at 72° C.; and concludes with 3 minutes at 72° C. Removal of unbound nucleotides was carried out using the QlAquick Nucleotide Removal Kit (Qiagen) as recommended by the manufacturer.

The eluted extension reaction was then combined with 30 μg prepared Dynabeads M-280 Streptavidin beads (Dynal) (washed three times with 5 mM Tris-HCl pH 7.5, 1M NaCl, 0.5 mM EDTA). Beads were incubated at room temperature for 15 minutes with gentle agitation and then pelleted using a magnetic rack. The supernatant was removed. Subsequently the beads were washed 6 times with 5 mM Tris-HCl pH 7.5, 1 M NaCl, 0.5 mM EDTA. For each wash step the beads were pelleted and the supernatant removed.

The mass tags were cleaved from the extension product by addition of RNase A and incubation at 37° C. for 1 hour. After incubation the magnetic beads were pelleted using a magnetic rack and the supernatant containing the mass tag products was removed. Desalting was achieved by the addition of 6 mg CLEAN Resin (Sequenom).

15 nl of the cleavage reactions were dispensed robotically onto silicon chips preloaded with matrix (SpectroCHIP, Sequenom). Mass spectra were acquired using a MassARRAY Compact Analyser (MALDI-TOF mass spectrometer, Sequenom).

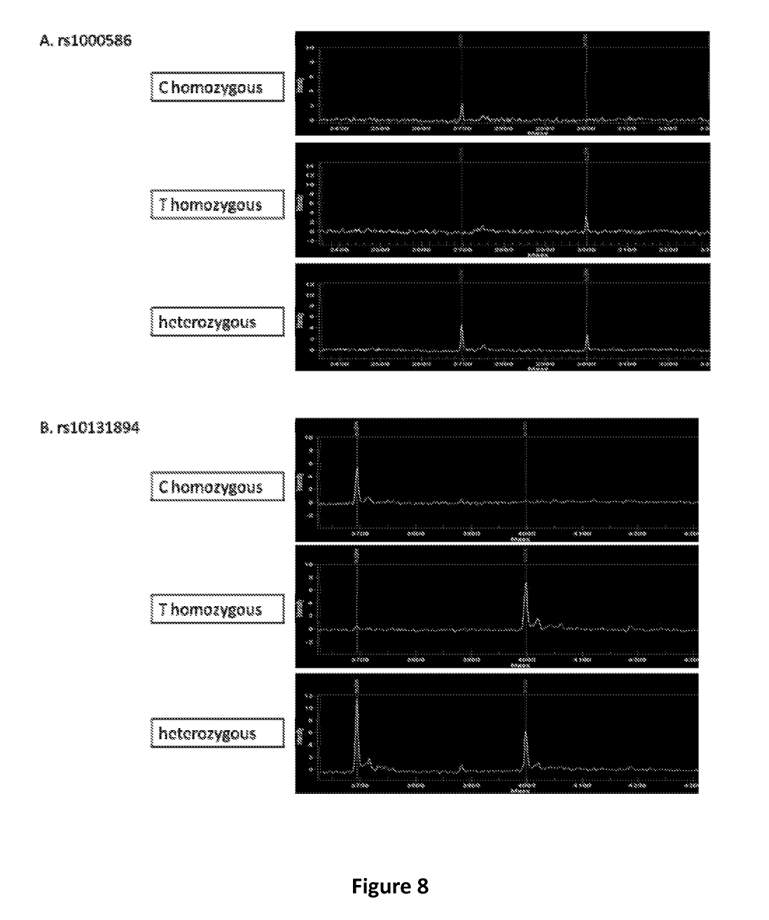

Extension primer sequences containing the mass tags and resulting masses of the cleaved products corresponding to specific alleles are listed in Table 7. Example spectra are shown in FIG. 8. For each of the two SNPs both homozygous as well as a heterozygous sample are displayed and show a clear distinction of the corresponding mass tags.

TABLE 7
Extension primers and mass tags released after cleavage

| assay name | extension primer sequence | mass tag sequence | mass |
|---|---|---|---|
| rs1000586_C | TTTCTCCCCACCTGACCCTGC (SEQ ID NO: 329) | TTTCTCCCC (SEQ ID | 2697.73 |
| | | NO: 333) | |
| rs1000586_T | TTTTCTCCCCACCTGACCCTGT (SEQ ID NO: 330) | TTTTCTCCCC (SEQ ID | 3001.93 |
| | | NO: 334) | |
| rs10131894_C | TTATTCCCAGGUGCATGCATGCGCACAC (SEQ ID | TTATTCCCAGGU | 3694.37 |
| | NO: 331) | (SEQ ID NO: 335) | |
| rs10131894_G | TTATTTCCCAGGUGCATGCATGCGCACAG (SEQ ID | TTATTTCCCAGGU | 3998.57 |
| | NO: 332) | (SEQ ID NO: 336) | |

In Table 7, ribonucleotides are highlighted in bold, SNP specific nucleotides are underlined and mass tags are underlined. In FIG. 8, MALDI-TOF MS spectra are shown for genotyping of rs1000586 and rs10131894.

### Example 7

### Mass Taq Design

Mass Tags were designed to be at least 16 Daltons apart to avoid any overlap with potential salt adducts, and so a double charge of any mass signal would not interfere with a mass tag signal. The calculation of the mass tags must take into account the deoxyinosine and the nucleotide 3′ to the deoxyinosine.

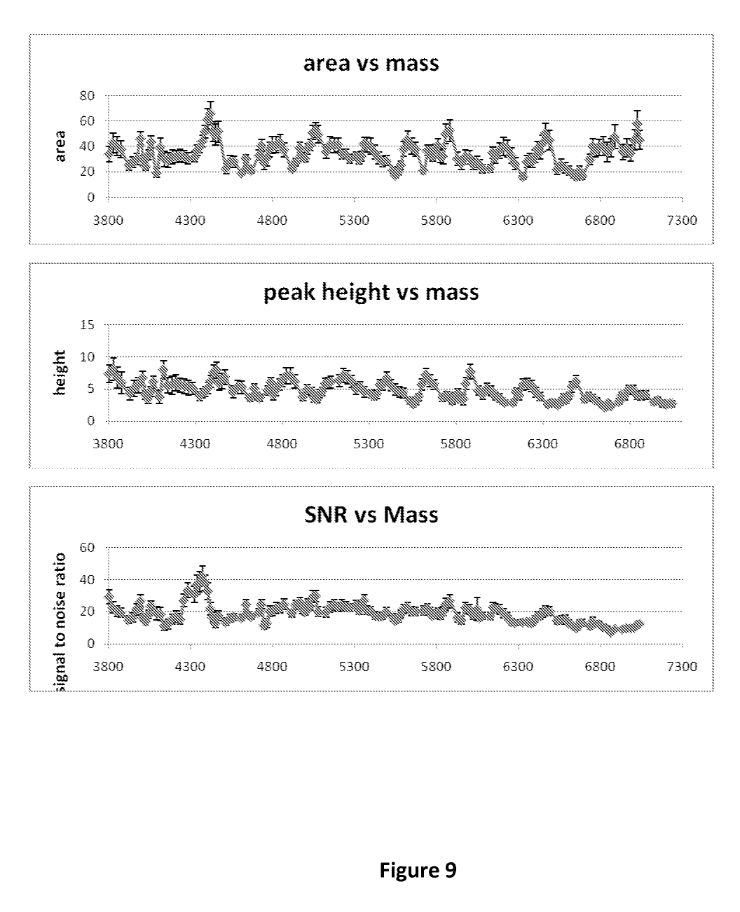

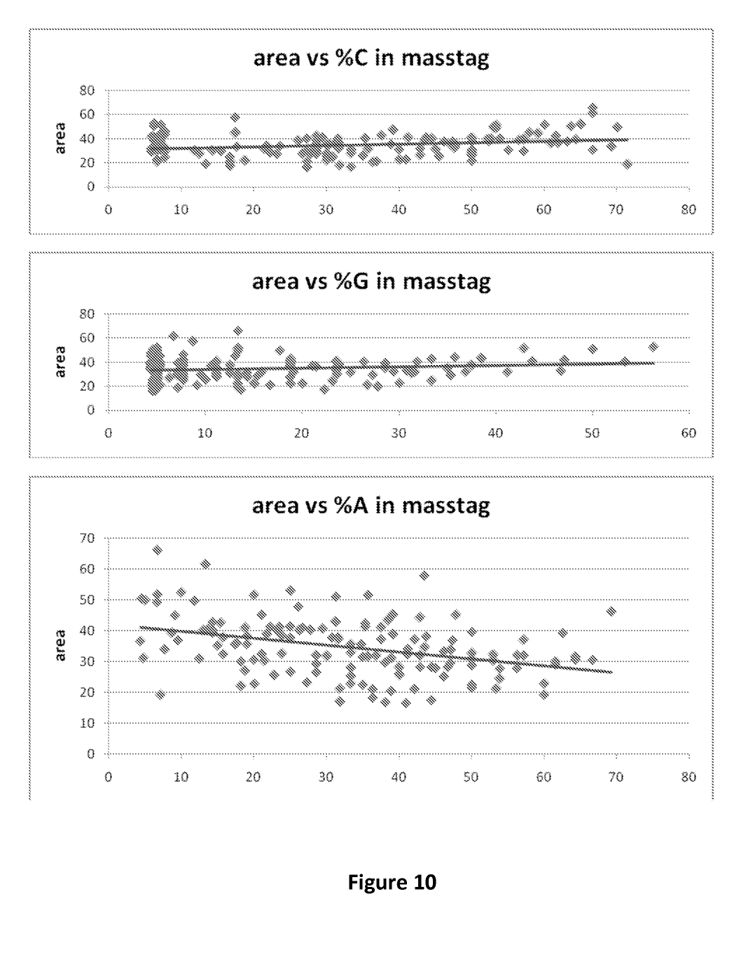

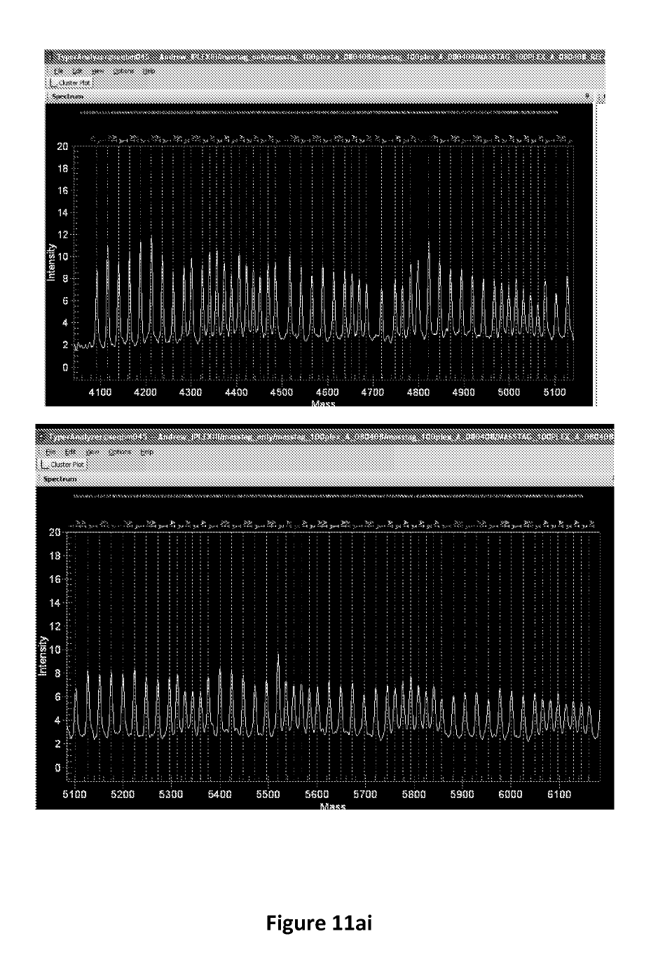

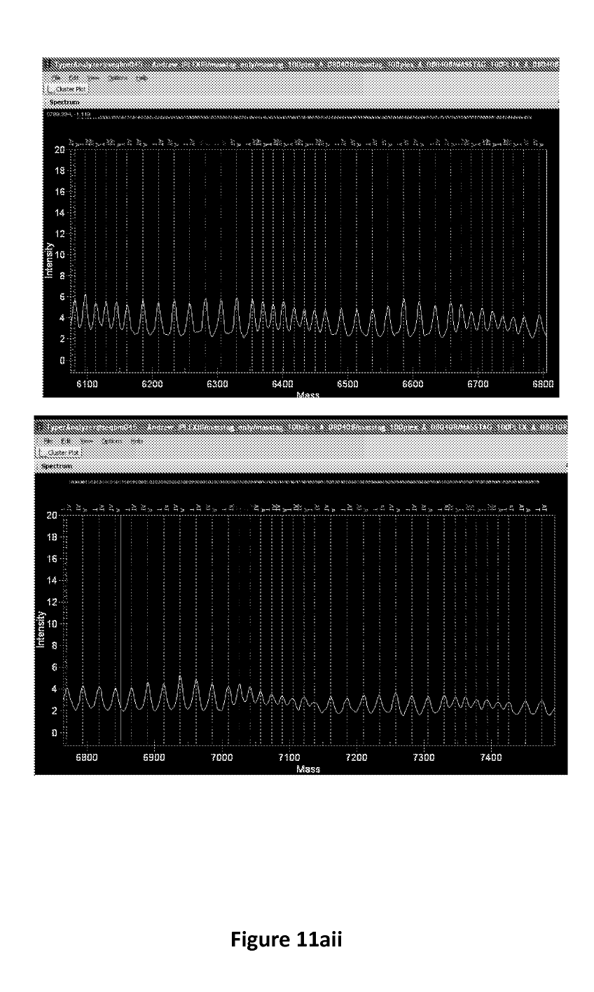

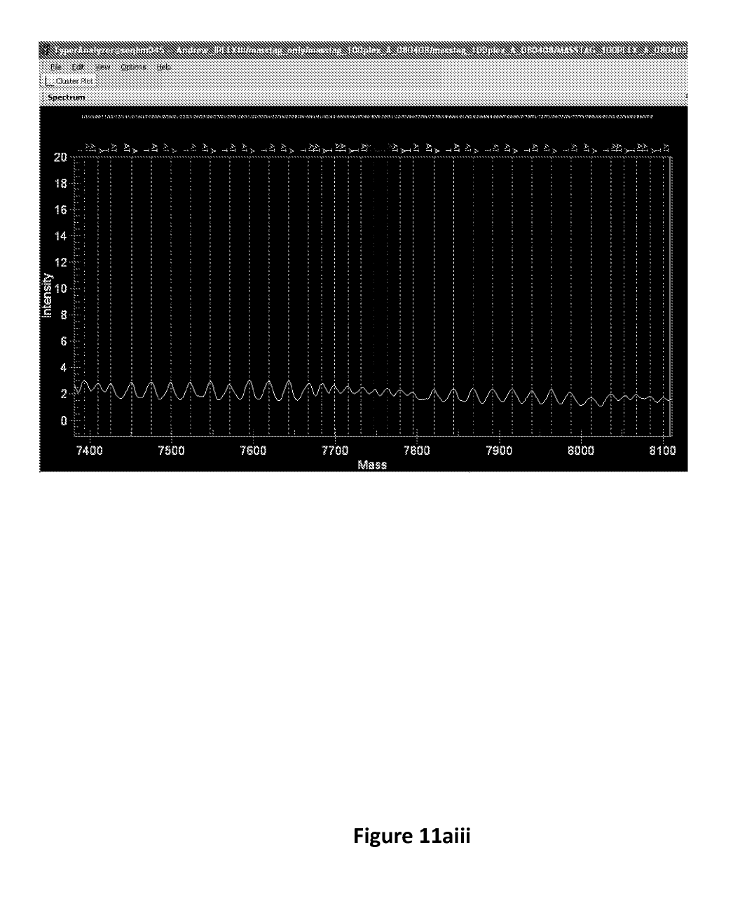

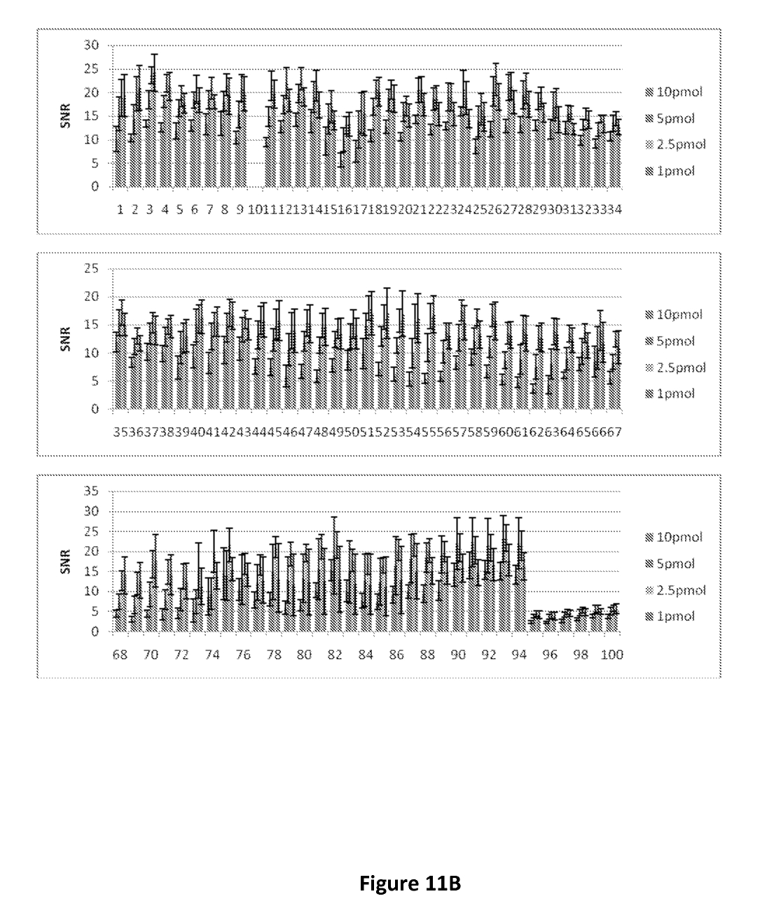

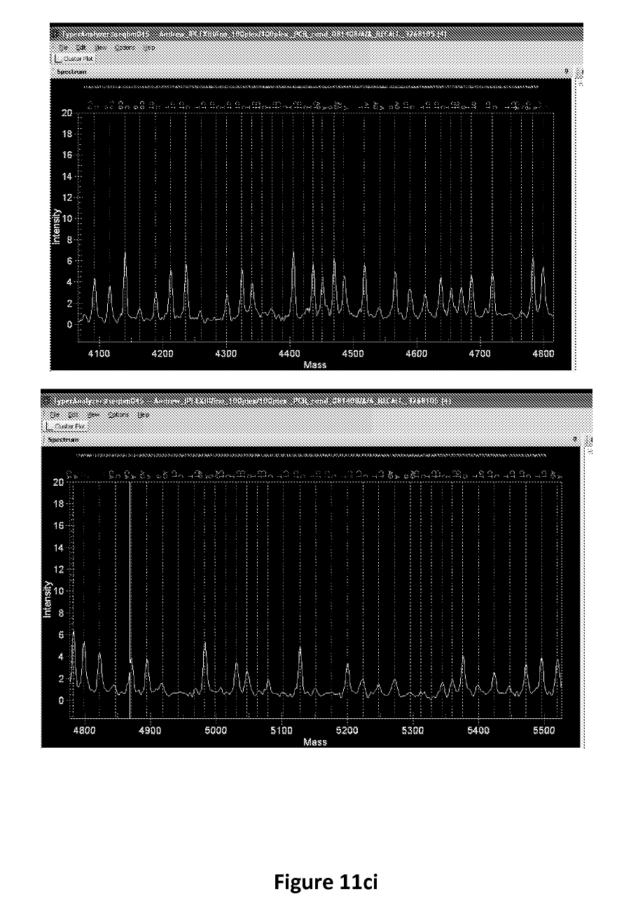

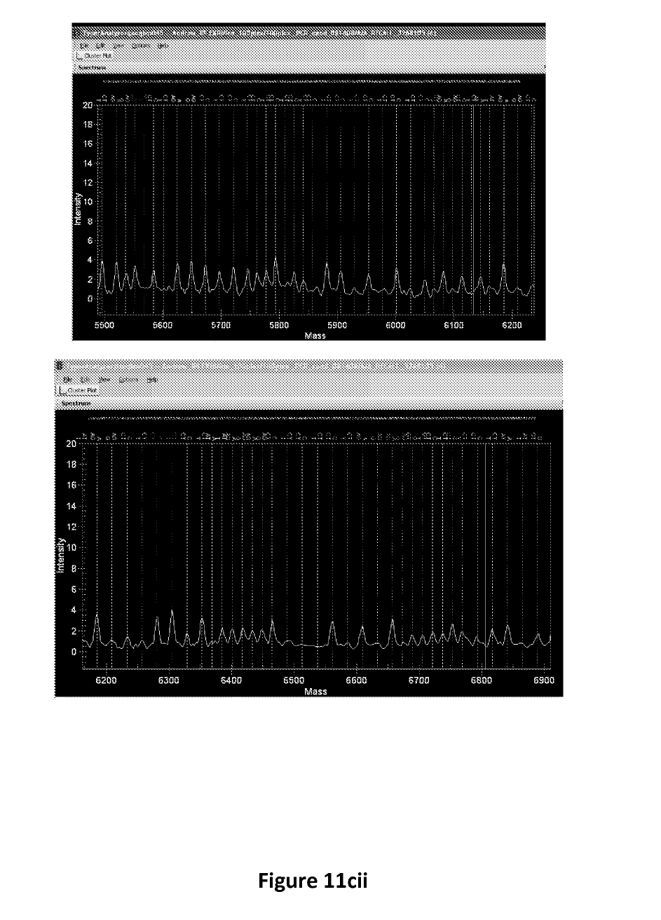

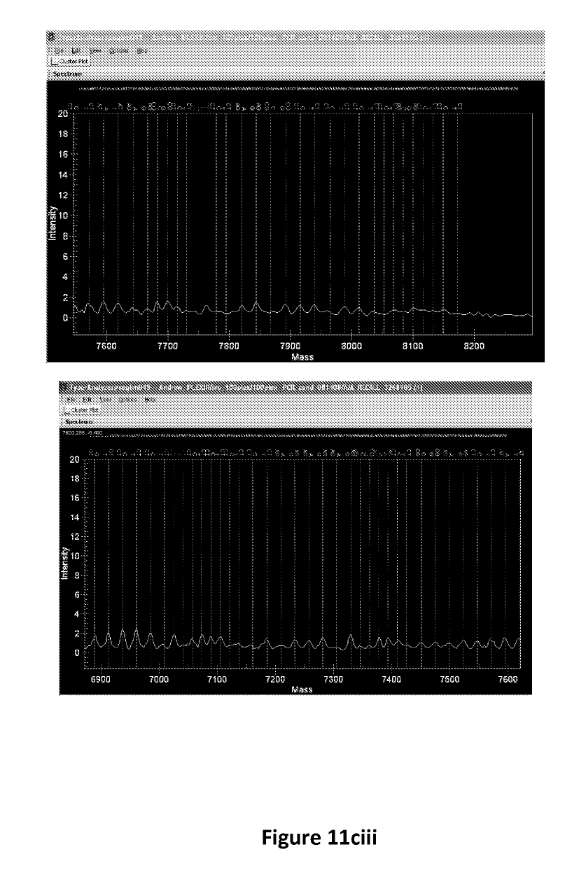

Nucleotide mass tags: MALDI-TOF flight behavior was examined for oligonucleotides which correspond to the mass tags used in a 70plex (FIGS. 9 and 10) and 100plex assay (FIG. 11A and B).

All oligonucleotides corresponding to a 70plex assay were called by the standard Sequenom Typer 3.4 software using the three parameters; area, peak height and signal-to-noise ratio at a comparable level (FIG. 9). Using oligonucleotides representing a 70plex assay, the area value of each peak correlates to the sequence composition of that oligo. The higher percentage of guanidine and cytosine nucleotides results in larger area values; whereas the percentage of adenosine corresponds with lower area values (FIG. 10). Using oligonucleotides representing a 100plex assay we examined the effects of oligonucleotide concentration (10, 5, 2.5 and 1 pmol final concentration per oligonucleotide) on signal-to-noise ratio (FIG. 11B). The lower oligonucleotide concentrations of 2.5 and 1 pmol gave consistently higher signal-to-noise ratio values than oligonucleotides concentrations of 10 and 5 pmol. This observation was confirmed by manual observation of the peaks seen in Typer 3.4. However, the four oligonucleotides concentrations gave comparable area values (data not shown).

### Example 8

### Extension Primer Design and dNTP/ddNTP Incorporation

Extension primers were designed using Sequenom's Assay Design software utilizing the following parameters SBE Mass Extend/goldPLEX extension, primer lengths between 20 and 35 bases (and corresponding mass window), and a minimum peak separation of 10 Daltons for analytes (the minimum possible) and 0 Daltons for mass extend primers.

Extension oligonucleotide and ddNTP role in extension reaction: To investigate the effects of extension oligonucleotide (with/without deoxyinosine nucleotide) and ddNTP composition (with/without biotin moiety) upon primer extension, we investigated extension rates of a 5plex (FIG. 12). Assays generally show the best extension rates using unmodified extension oligonucleotides and ddNTPs. Extension oligonucleotides containing a deoxyinosine showed no significant reduction in extension rate. However, when using a ddNTP including a biotin moiety a reduction in extension rate was seen in all assays, when using either type of extension oligonucleotide.

Biotinylated dNTP/ddNTP extension: To compare the effects of extending by a single biotinylated ddNTP or a biotinylated dNTP and terminated by an unmodified ddNTP, we compared extension rates in a 7plex and 5plex. The 7plex was extended by a biotinylated ddCTP or biotinylated dCTP and a ddATP, ddUTP, or ddGTP. The 5plex was extended by a biotinylated ddUTP or biotinylated dUTP and a ddATP, ddCTP, or ddGTP. The experiment also compared two concentrations of biotinylated dNTP or ddNTP, either 210 or 420 pmol.

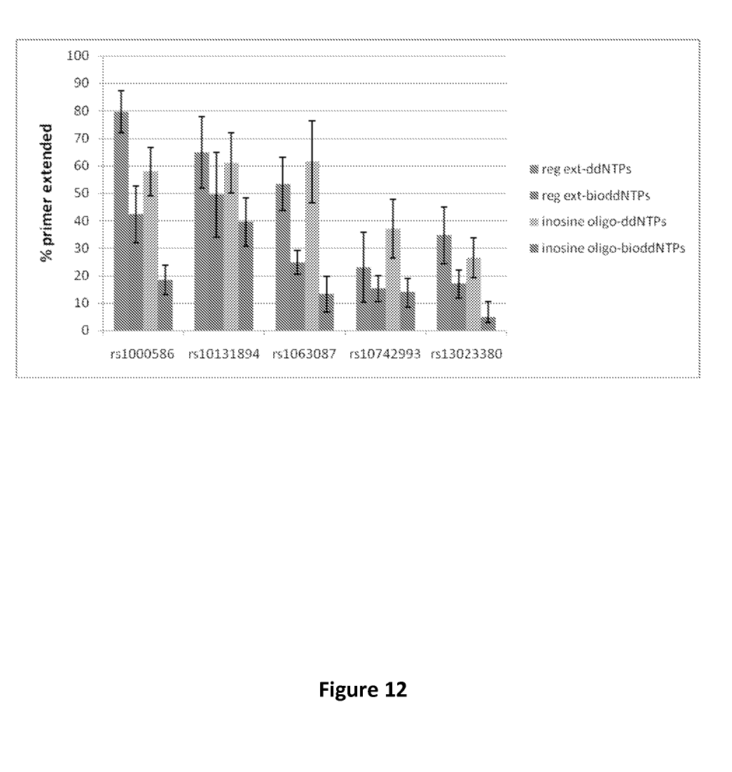

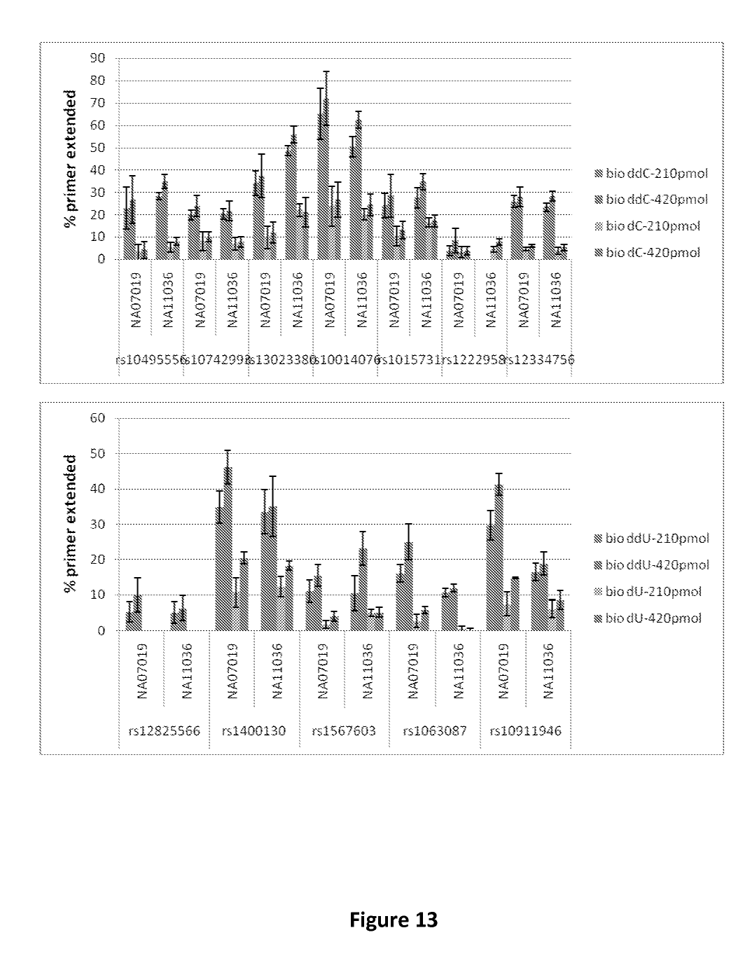

In both plexes, and in all individual assays extension rates when extended by a biotinylated dNTP and terminated by an unmodified ddNTP were significantly decreased when compared to extending by a single biotinylated ddNTPs (FIG. 13).

These results indicated that extension with a single biotinylated ddNTPs gives greater extension efficiency.

PCR Amplification

Prior to the extension reaction a PCR was carried out in a 5 μl reaction volume using the following reagents; 5 ng DNA, 1×PCR buffer, 500 μM each dNTP, 100 nM each PCR primer, 3 mM MgCl₂, and 0.15 U Taq (Sequenom).

Thermocycling was carried out using the following conditions: 7 minutes at 95° C.; followed by 45 cycles of 20 seconds at 95° C., 30 seconds at 56° C. and 1 minute at 72° C.; and concludes with 3 minutes at 72° C.

SAP Treatment

The PCR reaction was treated with SAP (shrimp alkaline phosphatase) to dephosphorylate unincorporated dNTPs. A 2 μl mixture containing 0.6 U SAP was added to the PCR product and then subjected to 40 minutes at 37° C. and 5 minutes at 85° C. in a Thermocycler.

Extension Reaction

Extension reaction reagents were combined in a 3 μl volume, which was added to the SAP treated PCR product. The total extension reaction contained the following reagents; 1×goldPLEX buffer, 0.2 μl of 250 μM stock each biotinylated ddNTP (50 pmol final), 0.8 μl of 2.5 μM solution each extension primer (2 pmol final) (IDT), and 0.05 μl goldPLEX enzyme (Sequenom).

Thermocycling was carried out using a 300 cycle program consisting of: 2 minutes at 94° C.; followed by 60 cycles of; 5 seconds at 94° C. followed by 5 cycles of 5 seconds at 52° C. and 5 seconds at 80° C.; and concludes with 3 minutes at 72° C.

Capture

For conditioning magnetic streptavidin beads were washed two times with 100 μl of 50 mM Tris-HCl, 1M NaCl, 0.5 mM EDTA, pH 7.5. The extension reaction was combined with 50 μg (5 μl) conditioned beads. Beads were incubated at room temperature for 1 hour with gentle agitation and then pelleted using a magnetic rack. The supernatant was removed. Subsequently the beads were washed 3 times with 100 μl of 50 mM Tris-HCl, 1 M NaCl, 0.5 mM EDTA, pH 7.5 and 3 times with 100 μl of water. For each wash step the beads were pelleted and the supernatant removed.

MALDI-TOF

Desalting was achieved by the addition of 6 mg CLEAN Resin (Sequenom). 15 nl of the cleavage reactions was dispensed robotically onto silicon chips preloaded with matrix (SpectroCHIP, Sequenom). Mass spectra were acquired using a MassARRAY Compact Analyser (MALDI-TOF mass spectrometer).

### Example 9

### Enzyme, Buffer, Oligonucleotide and Biotin ddNTP Titration

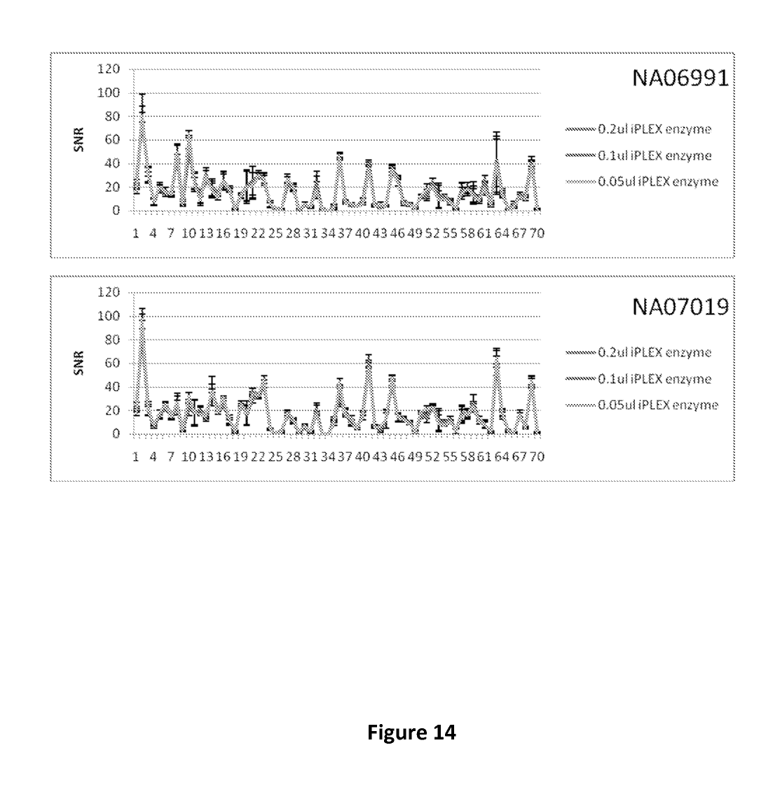

Enzyme Titration: The amount of post-PCR enzyme used in the extension reaction was examined. The standard PCR, extension, and immobilization/cleavage conditions (as outlined in the protocol in Example 8) were used except for the enzyme. The amount of enzyme used resulted in no difference in either manual calls or signal-to-noise ratio values for individual assays (FIG. 14).

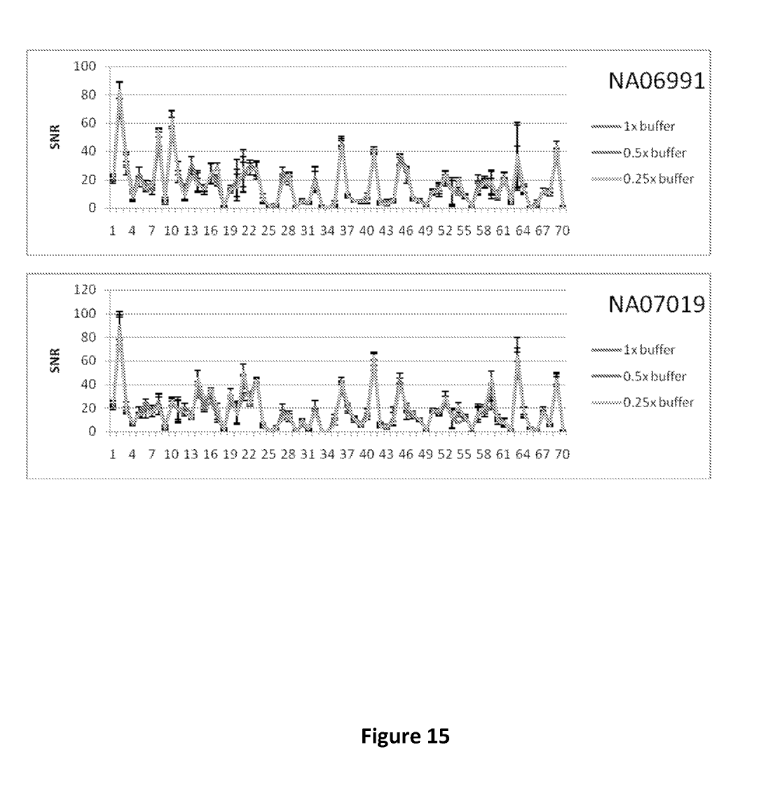

Buffer Titration: The amount of goldPLEX buffer used in the extension reaction was examined. The standard PCR, extension, and immobilization/cleavage conditions (as outlined in the protocol in example 8) were used except for adjusting the amount of buffer. The amount of buffer used resulted in no difference in either manual calls or signal-to-noise ratio values for individual assays (FIG. 15).

Oligonucleotide Titration: The amount of oligonucleotide used in the extension reaction was examined. The standard PCR, extension, and immobilization/cleavage conditions (as outlined in the protocol section) were used except for adjusting the amount of oligonucleotide.

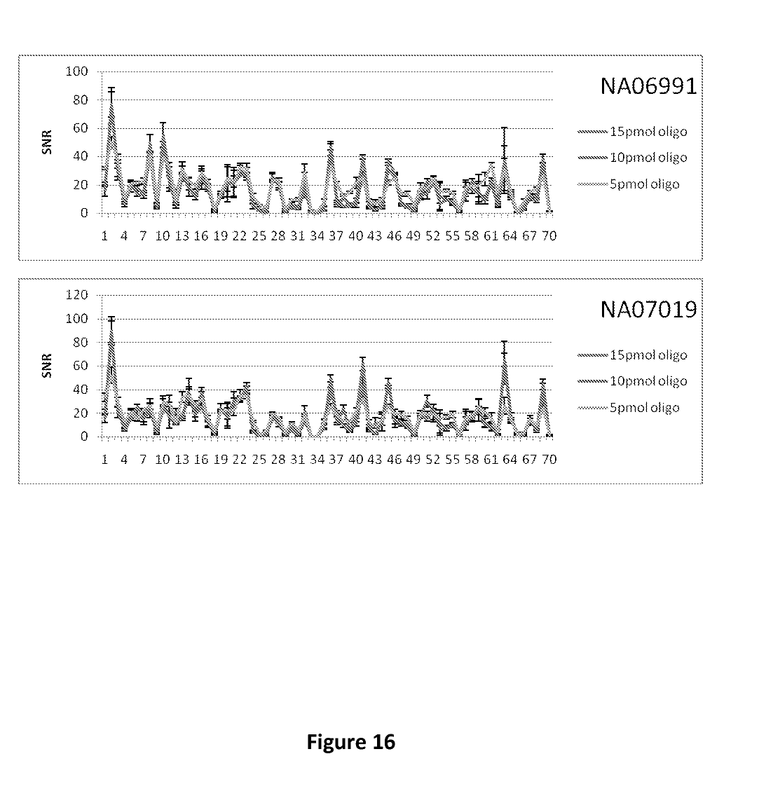

In the initial experiment (FIG. 16) final amounts of 15 pmol, 10 pmol and 5 pmol of each oligonucleotide were tested. The 10 and 15 pmol amounts gave similar results, but 5 pmol gave significantly more manual and software genotype calls. This can be seen by observing signal-to-noise ratio values (FIG. 9), where poorly performing assays showing an increased signal-to-noise ratio when using lower amounts of oligonucleotide.

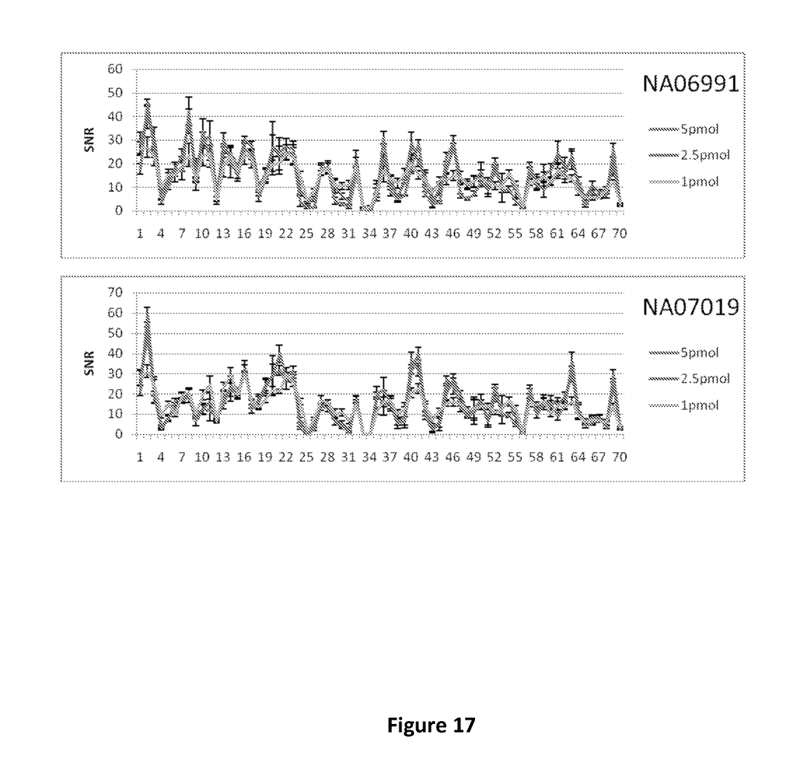

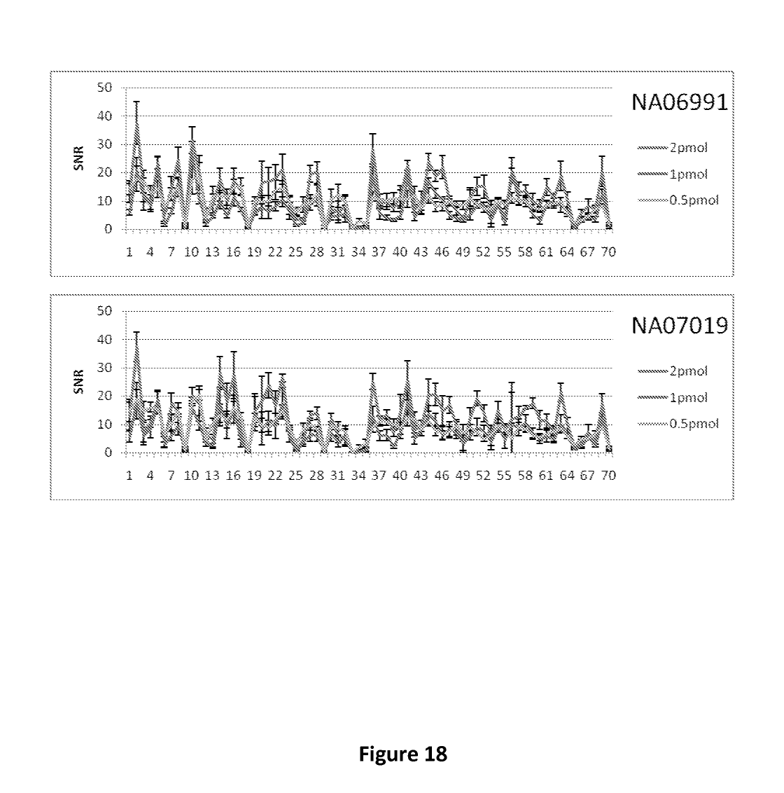

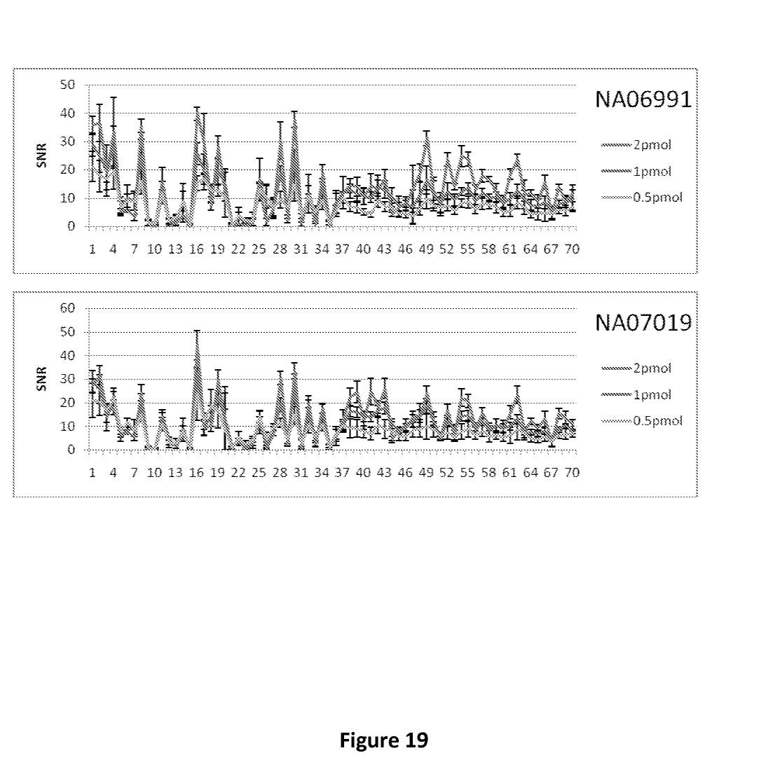

In follow-up experiments final amounts of 5 pmol, 2.5 pmol and 1 pmol of each oligonucleotide were tested (FIG. 17). The results for all three amounts gave similar results as assessed by signal-to-noise ratio and manual genotype calls. However, three individual assays, for which peaks were clearly seen when concentrations of 2.5 or 1 pmol were used, were difficult to call due to low intensity when a final concentration of 5 pmol was used. When using two 70plex assays comparing final amounts of 2 pmol, 1 pmol and 0.5 pmol of each oligonucleotide the same amount of manual calls were seen for all concentrations. However, greater signal-to-noise ratios were seen when more oligonucleotide was used (FIGS. 18 and 19).

These results show the optimal amount of each oligonucleotide to be 2 pmol when using a 70plex assay. However, similar results were seen with final amounts of each oligonucleotide ranging from 0.5 to 5 pmol.

Biotinylated ddNTP concentration: The amount of biotinylated ddNTP used in the extension reaction was examined. The standard PCR, extension, and immobilization/cleavage conditions (as outlined in the protocol in Example 8) were used except for adjusting the amount of biotinylated ddNTP.

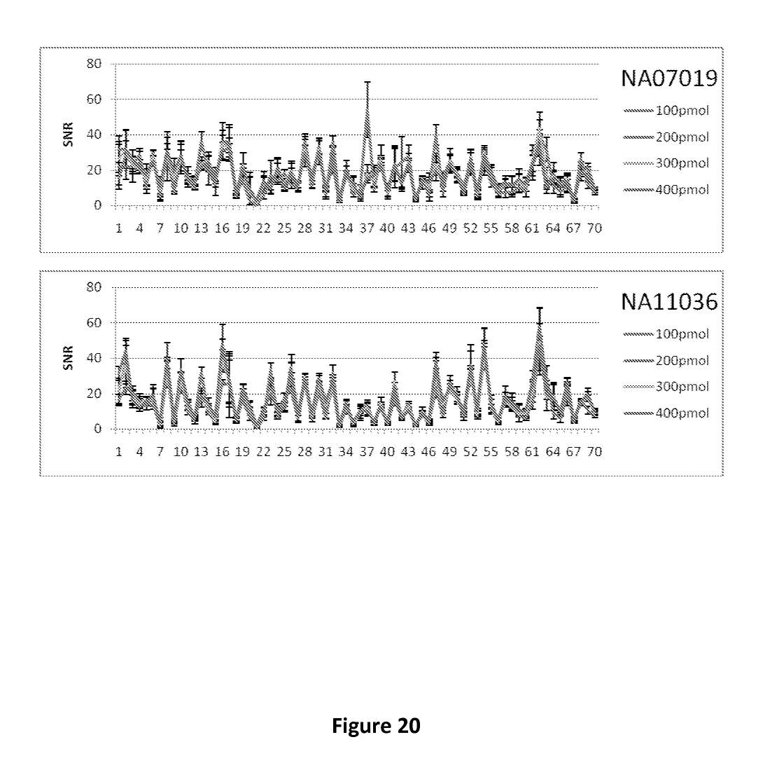

In the initial experiment final amounts of 100, 200, 300 and 400 pmol of each biotinylated ddNTP in each extension reaction were tested. Manual calls and signal-to-noise ratio (FIG. 20), show similar results were seen with all test amounts of biotinylated ddNTP.

To further investigate the amount of biotinylated ddNTP needed in each extension reaction, an experiment compared 50 and 100 pmol of each biotinylated ddNTP in an alternative 70plex assay. These assays again show no difference in manual calls or signal-to-noise ratio (FIG. 21). This indicates 50 pmol of each biotinylated ddNTP is sufficient to get an optimal extension reaction when using a 70plex assay.

### Example 10

### Capture and Cleavage Optimization

Immobilization and Oligonucleotide Cleavage: Binding capacity of magnetic streptavidin beads. Comparison of Solulink and Dynabeads MyOne C1 magnetic streptavidin beads to capture biotinylated oligonucleotide followed the capture protocol as described in Example 8. The experiment uses two oligonucleotides which correspond to extension products for the two possible alleles for an assay designed for SNP rs1000586. The oligonucleotides contain a deoxyinosine nucleotide and 3′ biotinylated nucleotide. The oligonucleotides are bound to the magnetic streptavidin in the presence of either water or varying quantities of biotinylated dNTPs, and are cleaved by treatment with endonuclease V.

Dynabeads MyOne C1 magnetic streptavidin beads show no reduction in area in the presence of 10 or 100 pmol biotinylated ddNTP. However, a large decrease in signal is seen with the addition of 500 pmol of biotinylated ddNTP.

Solulink magnetic beads show no reduction in signal in the presence of up to and including 500 pmol of biotinylated dNTP. This indicates that unincorporated biotinylated ddNTP from an extension reaction would not cause a decrease in final signal if it does not total greater than 500 pmol.

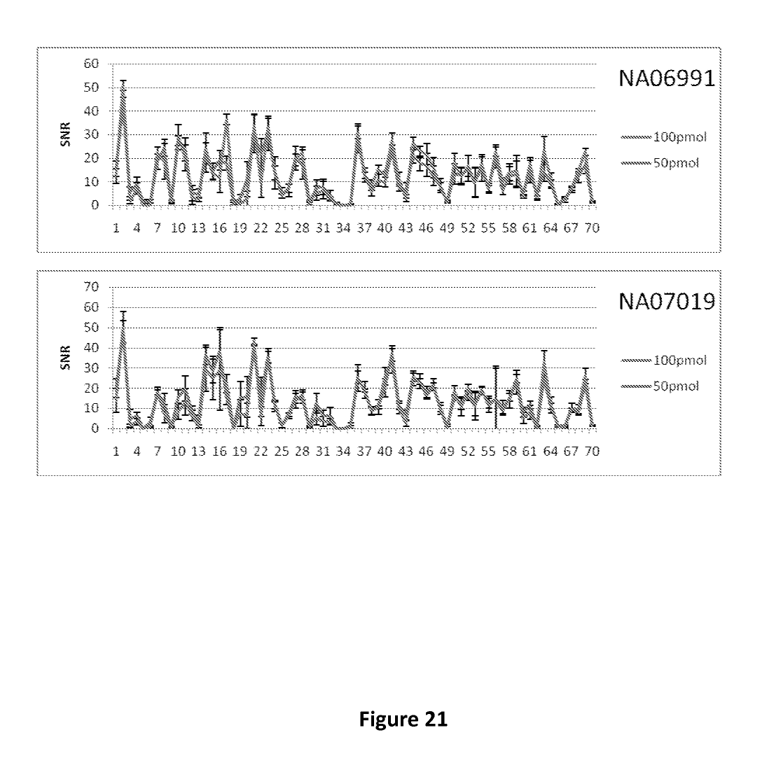

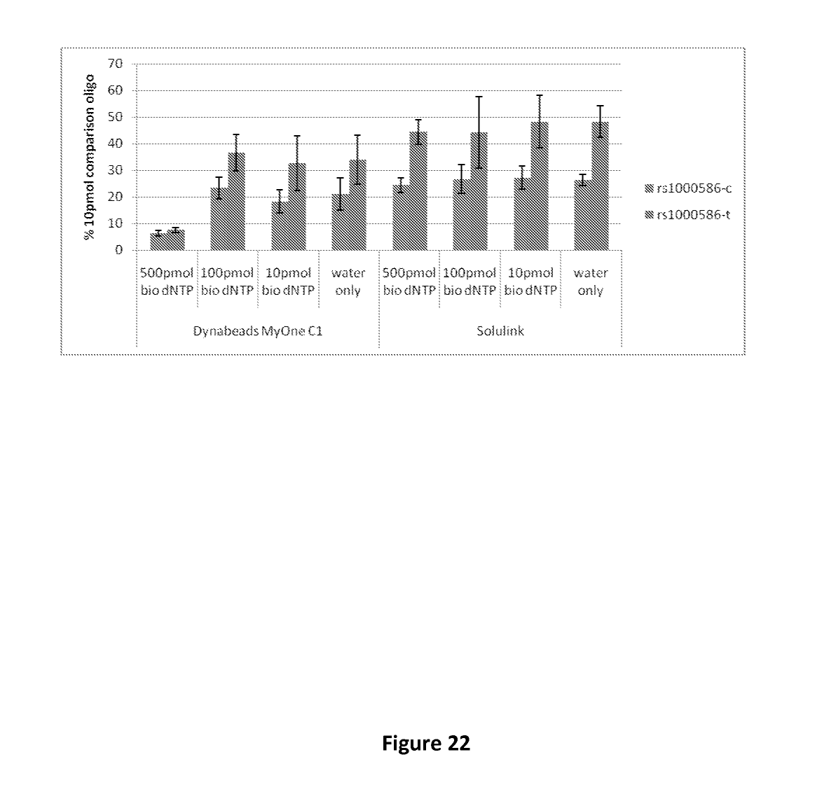

These results in combination with experiments not outlined in this report indicate Solulink beads have a greater tolerance to biotinylated small molecules inhibiting the binding of biotinylated extension product. This is probably due to the greater binding capacity of the beads, which is reported to be 2500 vs. 500 pmol biotin oligos/mg (FIG. 22).

Cleavage

The mass tags were cleaved from the extension product by addition of a solution containing 12 U Endonuclease V (NEB) and 10 mM Magnesium Acetate (Sigma) and incubation at 37° C. for 4 hours in a Thermomixer R (Eppendorf) shaking at 1500 rpm. After incubation the magnetic beads were pelleted using a magnetic rack and the supernatant was removed.

Effect of deoxyinosine position on cleavage properties: This experiment was designed to analyze the ability of endonuclease V to cleave an extension product containing a deoxyinosine nucleotide in different locations. Four oligonucleotides were designed to simulate an extension product (contained a 3′ biotin and a deoxyinosine nucleotide), which only differed in the location of the deoxyinosine nucleotide. The deoxyinosine was placed 10, 15, 20 and 25 base pairs from the 3′ nucleotide containing the biotin moiety.

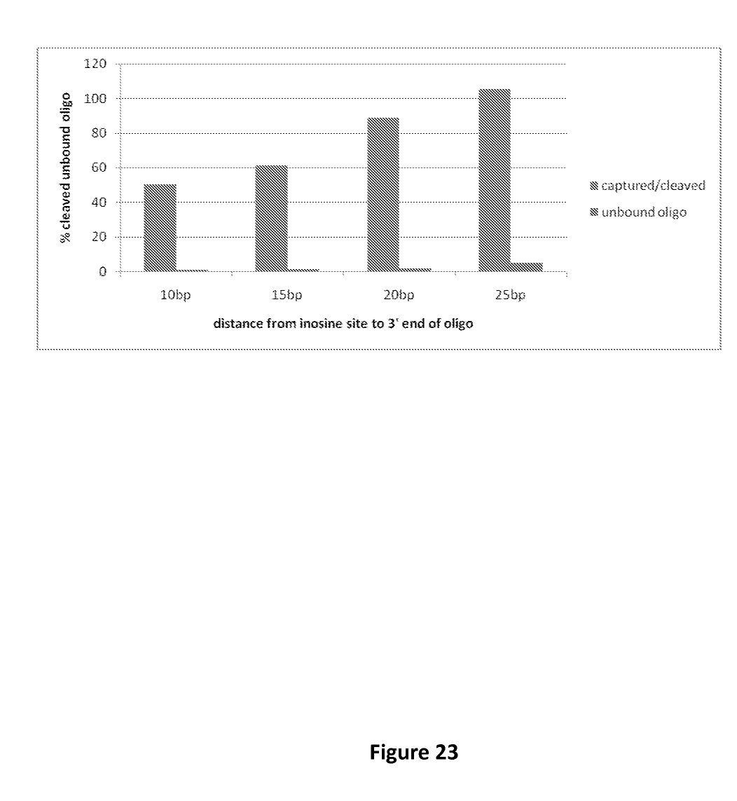

The mass tag signal seen after cleavage of the supernatant from the binding step (unbound oligo) indicates a similar quantity of oligonucleotide was bound onto the magnetic streptavidin beads for all oligonucleotides. However, after cleaving the oligonucleotides bound to the magnetic streptavidin beads a clear pattern is seen. The larger the distance of deoxyinosine to the 3′ end of the oligonucleotide the greater the signal and presumably the cleavage. These results led to design all extension oligonucleotides so the deoxyinosine is at least 20 nucleotides from the putative 3′ end of the extension product (FIG. 23).

Bead and Endonucleas V titration: The quantity of Solulink magnetic streptavidin beads to efficiently capture biotinylated extension products, and endonuclease V to cleave captured product to release mass tags was evaluated in a series of experiments using 70plex assays.

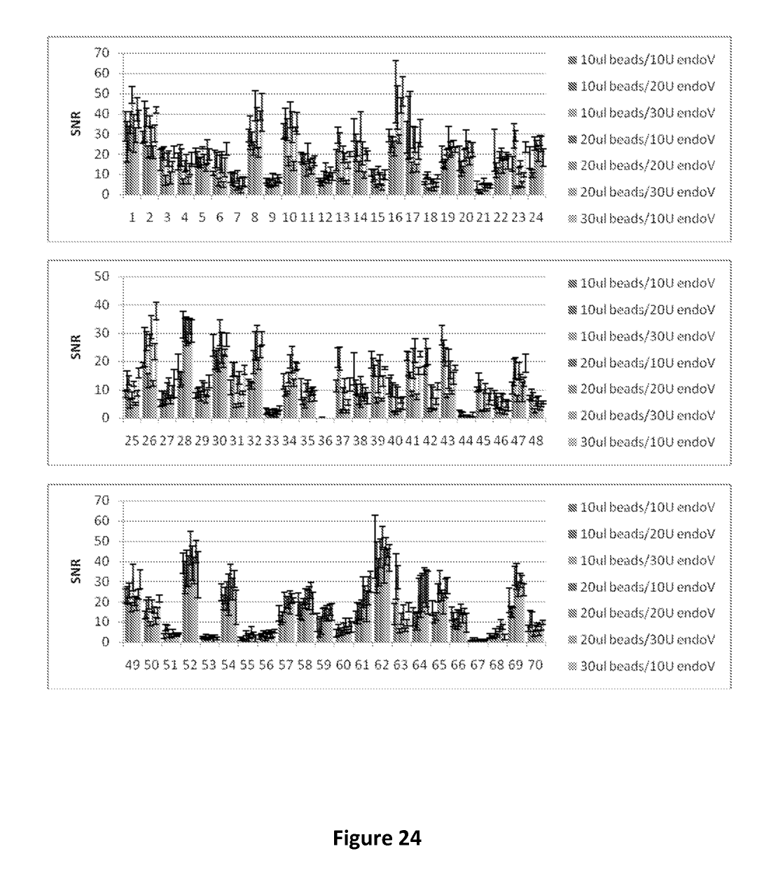

The initial experiment compared 10, 20 and 30 μl of Solulink magnetic streptavidin beads and 10, 20 and 30 units of endonuclease V. Signal-to-noise ratios show similar results with all combinations tested except when using 20 and 30 μl of magnetic beads in combination with 10 units of endonuclease V (FIG. 24). Identical results were seen when calling genotypes manually comparing 30 μl of beads and 30 U endonuclease V with 10 μl of beads and 10 U endonuclease V.

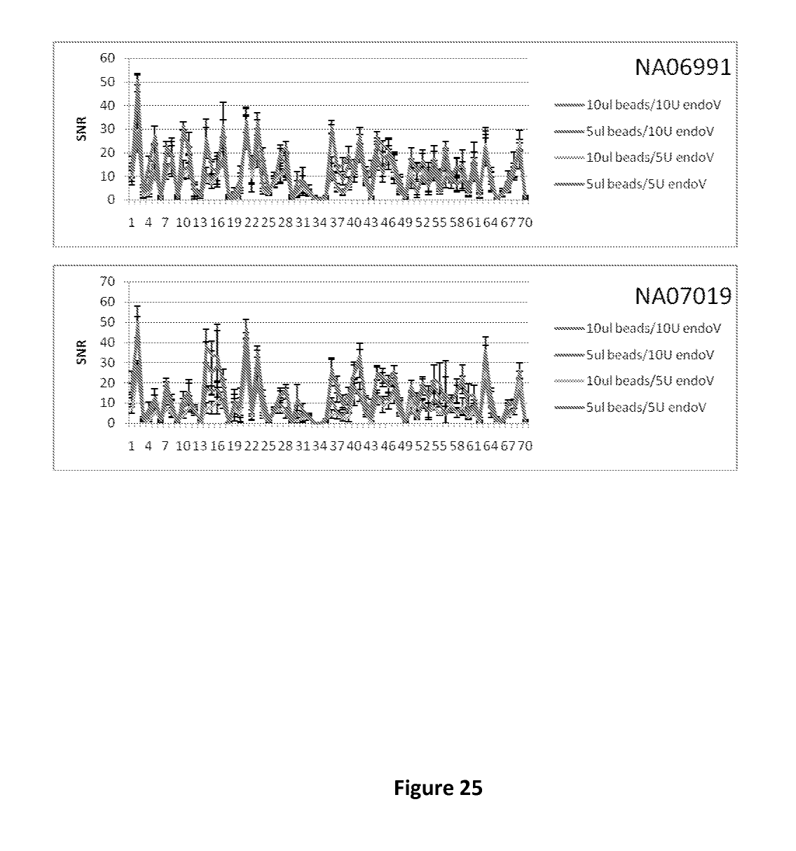

To follow up these results an experiment compared the following conditions; 10 μl beads/10 U endonuclease V; 5 μl beads/10 U endonuclease V, 10 μl beads/5 U endonuclease V, and 5 μl beads/5 U endonuclease V. When examining either manual genotype calls or signal-to-noise ratio similar results were seen when using either 10 or 5 μl of magnetic beads (FIG. 25). However, when using 5 U endonuclease V there was a significant reduction in both manual calls and signal-to-noise ratio when compared to 10 U endonuclease V.

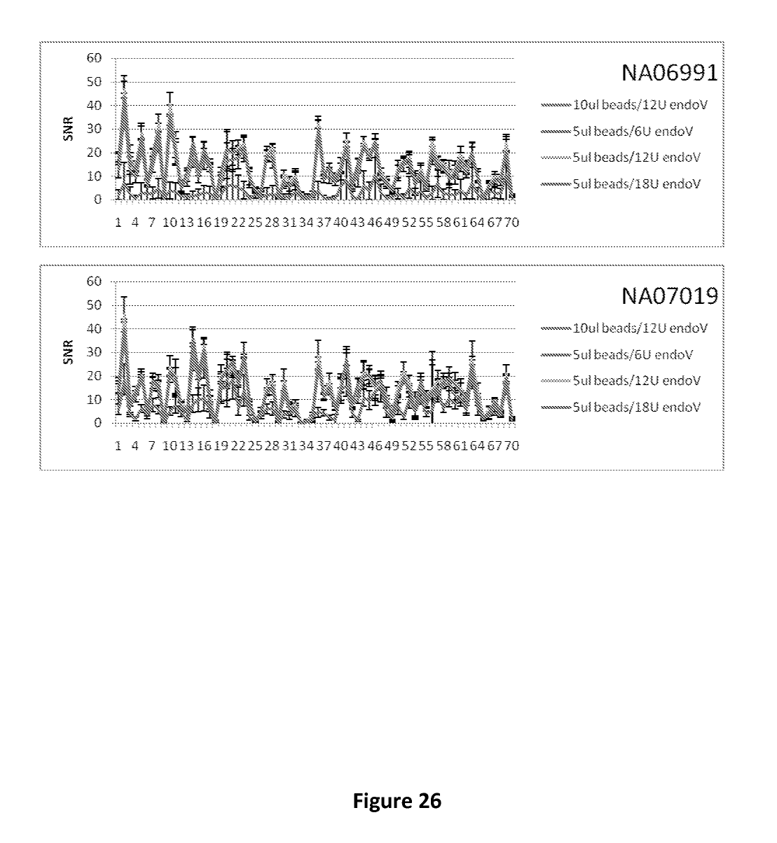

To confirm these results an additional experiment compared the following conditions; 10 μl beads/12 U endonuclease V; 5 μl beads/6 U endonuclease V, 5 μl beads/12 U endonuclease V, and 5 μl beads/18 U endonuclease V. When comparing both manual genotype calls and signal-to-noise ratios, similar results were seen when comparing 10 or 5 μl of Solulink magnetic beads (FIG. 26). When comparing different quantities of endonuclease V, similar results were seen with 12 and 18 U endonuclease V. However, when using 6 U of endonuclease V a reduction in signal was observed (FIG. 26).

### Example 11

### Alternative Oligonucleotide Cleavage Mechanism

Ribonucleotide: Initial experiments used extension oligonucleotides which included a ribonucleotide. After extension and subsequent capture on magnetic streptavidin beads the mass tags are released by RNase A cleavage of the ribonucleotide. The method is outlined in the following section. The assays were developed for the SNPs rs1000586 and rs10131894 in combination. The 2plex reaction worked well and the genotypes are clearly seen (FIG. 8). A challenge to overcome in the future is cleavage of the ribonucleotides-containing oligonucleotides due to freeze thawing.

Photocleavable: To explore an alternative to cleavage of deoxyinosine with endonuclease V oligonucleotides containing a photocleavable linker were tested (IDT). The linker contains a 10-atom spacer arm which can be cleaved with exposure to UV light in the 300-350 nm spectral range.

Methylphosphonate: As a further alternative to using cleavage of deoxyinosine with endonuclease V, oligonucleotides containing a methylphosphonate modification were examined. The oligonucleotides contain a modification of the phosphate backbone at a single position, where oxygen is substituted with a methyl group. This results in a neutrally charged backbone which can be cleaved by Sodium hydroxide (NaOH), or potassium hydroxide (KOH) and heat. A series of experiments showed that the oligonucleotides can be cleaved by addition of as little as 50 mM of NaOH or 200 mM KOH and heating at 70° C. for one hour.

dSpacer, Phosphorothioate/Phosphoramidite: Three alternative cleavage mechanisms that have not been explored in detail are the replacement of a nucleotide with a 1′,2′-Dideoxyribose (dSpacer) and the backbone modifications creating either a phosphorothioate or phosphoramidite. A phosphorothioate modification replaces a bridging oxygen with a sulphur. This enables the backbone to be cleaved with treatment with either 30/50 mM aqueous sliver nitrate solution (with/without dithiothreitol) or 50 mM iodine in aqueous acetone. A phosphoramidite modification replaces a bridging oxygen with a amide group. The resulting P—N bond can be cleaved with treatment with 80% CH₃COOH or during the MALDI-TOF procedure.

The entirety of each patent, patent application, publication and document referenced herein hereby is incorporated by reference. Citation of the above patents, patent applications, publications and documents is not an admission that any of the foregoing is pertinent prior art, nor does it constitute any admission as to the contents or date of these publications or documents.

Modifications may be made to the foregoing without departing from the basic aspects of the technology. Although the technology has been described in substantial detail with reference to one or more specific embodiments, those of ordinary skill in the art will recognize that changes may be made to the embodiments specifically disclosed in this application, yet these modifications and improvements are within the scope and spirit of the technology.

The technology illustratively described herein suitably may be practiced in the absence of any element(s) not specifically disclosed herein. Thus, for example, in each instance herein any of the terms “comprising,” “consisting essentially of,” and “consisting of” may be replaced with either of the other two terms. The terms and expressions which have been employed are used as terms of description and not of limitation, and use of such terms and expressions do not exclude any equivalents of the features shown and described or portions thereof, and various modifications are possible within the scope of the technology claimed. The term “a” or “an” can refer to one of or a plurality of the elements it modifies (e.g., “a reagent” can mean one or more reagents) unless it is contextually clear either one of the elements or more than one of the elements is described. The term “about” as used herein refers to a value within 10% of the underlying parameter (i.e., plus or minus 10%), and use of the term “about” at the beginning of a string of values modifies each of the values (i.e., “about 1, 2 and 3” is about 1, about 2 and about 3). For example, a weight of “about 100 grams” can include weights between 90 grams and 110 grams. Thus, it should be understood that although the present technology has been specifically disclosed by representative embodiments and optional features, modification and variation of the concepts herein disclosed may be resorted to by those skilled in the art, and such modifications and variations are considered within the scope of this technology.

Embodiments of the technology are set forth in the claims that follow.

1-51. (canceled)

52. A method for determining the presence or absence of a plurality of target nucleic acids in a composition, which comprises:
a. preparing amplicons of the target nucleic acids by amplifying the target nucleic acids, or portions thereof, under amplification conditions;
b. contacting the amplicons in solution with a set of oligonucleotides under hybridization conditions, wherein:
(i) each oligonucleotide in the set comprises a hybridization sequence capable of specifically hybridizing to one amplicon under the hybridization conditions when the amplicon is present in the solution,
(ii) each oligonucleotide in the set comprises a mass distinguishable tag located 5′ of the hybridization sequence,
(iii) the mass of the mass distinguishable tag of one oligonucleotide detectably differs from the masses of mass distinguishable tags of the other oligonucleotides in the set; and
(iv) each mass distinguishable tag specifically corresponds to a specific amplicon and thereby specifically corresponds to a specific target nucleic acid;
c. generating extended oligonucleotides that comprise a capture agent by extending oligonucleotides hybridized to the amplicons by one or more nucleotides, wherein one of the one of more nucleotides is a terminating nucleotide and one or more of the nucleotides added to the oligonucleotides comprises the capture agent;
d. contacting the extended oligonucleotides with a solid phase under conditions in which the capture agent interacts with the solid phase;
e. releasing the mass distinguishable tags from the extended oligonucleotides that have interacted with the solid phase; and
f. detecting the mass distinguishable tags released in (e) by mass spectrometry; whereby the presence or absence of each target nucleic acid is determined by the presence or absence of the corresponding mass distinguishable tag.

53. The method of claim 52, wherein the solution containing amplicons produced in (a) is treated with an agent that removes terminal phosphates from any nucleotides not incorporated into the amplicons.

54. The method of claim 53, wherein the terminal phosphate is removed by contacting the solution with a phosphatase.

55. The method of claim 54, wherein the phosphatase is alkaline phosphatase.

56. The method of claim 52, wherein the capture agent comprises biotin.

57. The method of claim 56, wherein the solid phase comprises avidin or streptavidin.

58. The method of claim 52, wherein the capture agent comprises avidin or streptavidin.

59. The method of claim 58, wherein the solid phase comprises biotin.

60. The method of claim 52, wherein the terminal nucleotides in the extended oligonucleotides comprise the capture agent.

61. The method of claim 52, wherein one or more non-terminal nucleotides in the extended oligonucleotides comprise the capture agent.

62. The method of claim 52, wherein the hybridization sequence is about 5 to about 200 nucleotides in length.

63. The method of claim 52, wherein the solid phase is a paramagnetic bead.

64. The method of claim 52, wherein the solid phase is a flat surface.

65. The method of claim 52, wherein the solid phase is a silicon chip.

66. The method of claim 52, wherein the mass spectrometry is matrix-assisted laser desorption ionization (MALDI) mass spectrometry.

67. The method of claim 52, wherein the mass spectrometry is electrospray (ES) mass spectrometry.

68. The method of claim 52, wherein the presence or absence of 1 to 50 or more target nucleic acids is detected.

69. The method of claim 52, wherein the mass distinguishable tag consists of nucleotides.

70. The method of claim 69, wherein the mass distinguishable tag is a nucleotide compomer.

71. The method claim 70, wherein the nucleotide compomer is about 5 nucleotides to about 100 nucleotides in length.

72. The method of claim 52, wherein the mass distinguishable tag is a peptide.

73. The method of claim 52, wherein the mass distinguishable tag comprises concatenated organic molecule units.

74. The method of claim 52, wherein the mass distinguishable tag is released by treatment with an endonuclease.

75. The method of claim 52, wherein the mass distinguishable tag is linked to the oligonucleotide by a photocleavable linkage and is released by treatment with light.

76. The method of claim 52, wherein the mass distinguishable tag is released by treatment with a ribonuclease.

77. The method of claim 52, wherein the mass distinguishable tag is linked to the oligonucleotide by inosine and is released by an agent that cleaves the inosine.

78. The method of claim 52, wherein the target nucleic acids are genomic DNA.

79. The method of claim 52, wherein one or more of the target nucleic acids are alleles of one or more single nucleotide polymorphisms.
